(19) United States
(12) Patent Application Publication
(10) Pub. No.: US 2026/0321753 A1
(43) Pub. Date: Oct. 15, 2026

(54) BATTERY PACK AND POWER TOOL COMMUNICATION SYSTEM

(71) Applicant: BLACK & DECKER INC., New Britain, CT (US)

(72) Inventors: Daniel Sven CHRISTNER, Baltimore, MD (US); Ashley Elizabeth BROWN MANNING, Cornelius, NC (US); Jason Kenneth LEH, Schrewsbury, PA (US); Philip Gordon GILDE, Baltimore, MD (US); Regina Garcia C. CUNANAN, Baltimore, MD (US); Shobhit GUPTA, Dublin, CA (US); Mitchell Benjamin BRINKMAN, College Grove, TN (US); Matthew J. VELDERMAN, Sparks, MD (US); Michael VARIPATIS, Fallston, MD (US); Eric LOELIGER, Ellicott City, MD (US)

(21) Appl. No.: 19/697,551

(22) Filed: Jun. 3, 2026

Related U.S. Application Data
(63) Continuation of application No. PCT/US2024/053075, filed on Oct. 25, 2024.
(60) Provisional application No. 63/605,849, filed on Dec. 4, 2023.

(51) Int. Cl. H01M 10/42; H01M 10/48; H01M 50/247; H01M 50/503

(52) U.S. Cl. CPC H01M 10/4257; H01M 50/247; H01M 50/503; H01M 2010/4271; H01M 2010/4278; H01M 10/486; H01M 2220/30

(57) ABSTRACT

The disclosure relates to a system of at least one power tool, at least one battery pack, and a backend server for interrelating data collected by the power tool and/or the battery pack. The system may encompass a collection of battery packs that are each configured to be interchanged between multiple power tools with varying levels of connectivity to the battery packs. Depending on the level of connectivity, the battery pack may be configured to collect a different level of data that can ultimately be compiled, correlated, and analyzed by a backend server. The disclosure further relates to methods and apparatuses for connecting and communicating with a communication module that is coupled to the power tool, and collecting power tool data from the communication module.

### CROSS-REFERENCE TO RELATED APPLICATIONS

This application is a continuation of Patent Cooperation Treaty Application No. PCT/US2024/053075, filed on Oct. 25, 2024, titled “Battery Pack and Power Tool Communication System”, which claims priority to and the benefit of U.S. Provisional Patent Application No. 63/605,849, filed on Dec. 4, 2023, titled “Battery Pack and Power Tool System”.

### INCORPORATION BY REFERENCE

The disclosures of each of Patent Cooperation Treaty Application No. PCT/US2024/053075, filed on Oct. 25, 2024, titled “Battery Pack and Power Tool Communication System”, and U.S. Provisional Patent Application No. 63/605,849, filed on Dec. 4, 2023, titled “Battery Pack and Power Tool System”, are incorporated by reference herein as if set forth in their entireties.

### BACKGROUND

At a construction site, many different types of power tools may be used at various times. Cordless power tools at the construction site may draw power from a rechargeable power source (such as a rechargeable battery pack) and provide flexibility for maneuvering around the construction site. Since not all power tools may be in use at the same time, a battery pack may be removed from one power tool and added to another depending on the need at the time. Similarly, it may be desirable to include a fleet of battery packs that are interchangeable and where each can be used in many different power tools at the construction site. Moreover, to better optimize the use of all of the power tools at a construction site, it may be desirable to monitor and record various data metrics of power tools and battery packs to determine how each is performing and how they are used. In addition, in certain situations, it may be beneficial to have wireless communications between a power tool or battery pack and one or more computing devices to facilitate this type of coordination.

Accordingly, it may be desirable to provide a system involving one or more power tools, one or more battery packs, and a backend server, where each battery pack can be interchangeable with multiple types of power tools and can collect relevant data from the power tool in order to optimize use and performance, coupled with each battery pack and at least some power tools being able to communicate data to the backend server for advanced processing. Specifically, it may be desirable for a battery pack to be able to connect with power tools having varying levels of connectivity, and still provide a maximal level of data collection depending on the level of connectivity. It may also be desirable for a power tool to be able to connect with different batteries of varying levels of connectivity and still provide a maximal level of data collection depending on this level of connectivity.

### BRIEF SUMMARY

Aspects of the present disclosure describe power tools, battery packs, and gateway devices that interconnect with one another. The power tools and battery packs may be configured to generate health and status data and may wirelessly transmit the data to a gateway present in the vicinity, say at a construction site.

In some embodiments, a power tool is disclosed. The power tool may include: a housing; a motor; a trigger; a microcontroller; a wireless communication module coupled to the microcontroller; and an attachment mechanism configured to couple a battery pack to the power tool. The wireless communication module is configured to: broadcast a first signal including first set of data periodically; and in response to receiving a request for an extended response, broadcast a second signal including a second set of data that is greater in size than the first set of data.

In some embodiments of the power tool, there is at least one temperature sensor configured to generate and transmit temperature data of the battery pack to the microcontroller. The first set of data comprises at least one of: an identification of the battery pack that it is coupled to; the temperature data of the battery pack; status data of the wireless communication module; a cumulative number of trigger pulls from the trigger; a total runtime; a time spent in a variable-speed mode; a status of a last shutdown of the power tool; a current mode of operation of the power tool; and a time spent in the current mode of operation. The power tool may further include at least one temperature sensor configured to generate and transmit temperature data of the microcontroller; and wherein the second set of data comprises at least one of the temperature data of the microcontroller; a variable-speed time indicating an amount of time the power tool is in a variable speed mode; pack voltage of the battery pack; a cumulative number of trigger pulls in a forward direction; and a cumulative number of trigger pulls in reverse direction. In some embodiments, the wireless communication module is further configured to: broadcast a third signal including third set of data periodically, the third signal alternatingly broadcast periodically with the first signal; and in response to receiving a request to establish a direct communication connection, transmit a fourth signal to initiate a two-way communication protocol with a gateway. In some embodiments, the wireless communication module is further configured to transmit a datalog of metrics recorded by the microcontroller of the power tool after the direct communication with the gateway is established and clear a memory containing the datalog after it has been transmitted.

In some embodiments a battery pack is disclosed. The battery pack may include: at least one capacitive cell configured to provide power to a power tool; a battery management controller; a wireless communication module coupled to the battery management controller; and an attachment mechanism configured to couple the battery pack to a power tool. The wireless communication module is configured to: broadcast a first signal including first set of data periodically; and in response to receiving a request for an extended response, broadcast a second signal including a second set of data that is greater in size than the first set of data. In an embodiment, the wireless communication module is integrated with the battery management controller as a part of a single controller core, a single package, or a single chip.

In some embodiments, the battery pack further includes at least one temperature sensor configured to generate and transmit temperature data of the battery pack to the battery management controller. The first set of data comprises at least one of: the temperature data of the battery pack; an identification of the power tool the battery pack is coupled to; status data of the wireless communication module; a data load indicator representing an amount of data stored in the battery pack; status data of the battery pack; a cumulative count of hot-pack events indicating one or more over-temperature conditions; a cumulative count of cold-pack events indicating one or more under-temperature conditions; a cumulative count of hot-pack charge events indicating one or more over-temperature events during charging; a cumulative count of cold-pack charge events indicating one or more under-temperature events during charging; a cumulative count of charge insertions; a cumulative count of under-voltage events; a cumulative count of over-voltage events; a cumulative count of over-voltage protection events indicating one or more shutdown events that required over-voltage protection; and a total time the battery pack tool is connected to the power tool. In some embodiments, the battery pack further includes at least one temperature sensor configured to generate and transmit temperature data of a FET to the battery management controller. The second set of data comprises at least one of: a cumulative count of charge insertions; a cumulative count of charge competitions; a cumulative count of under-voltage shutdown events; a fault reason association with each cell; a FET temperature and discharge information; a FET temperature; a cell imbalance information; a cumulative count of discharge cycles; a time spent in charge current; a time spent in discharge current; a data load indicator representing an amount of data stored in the battery pack; a state of life; a state of power; a state of health of the battery pack; a total coloumb count; a cell pressure; and a battery pack pressure. In some embodiments, the wireless communication module is further configured to: broadcast a third signal including third set of data periodically, the third signal alternatingly broadcast periodically with the first signal; and in response to receiving a request to establish a direct communication connection, transmit a fourth signal to initiate a two-way communication protocol with a gateway. In some embodiments, the wireless communication module is further configured to transmit a datalog of metrics recorded by the battery management controller of the battery pack after the direct communication with the gateway is established and clear a memory containing the datalog after it has been transmitted.

In some embodiments, a mobile construction site device is disclosed. It may include: a microcontroller; a wireless communication module coupled to the microcontroller; and an attachment mechanism configured to couple the mobile construction site device to another mobile construction site device. The mobile communication module is configured to: alternatingly broadcast a first advertisement signal indicating the mobile construction site device's scannable state and a second advertisement signal indicating the mobile construction site device's connectable state; in response to a scan request following the first advertisement signal, broadcast an extended scan signal comprising a set of cumulative data related to the mobile construction site device's operation or status; and in response to a connection request following the second advertisement signal, establish a communication link with an external device and transmit a datalog of the operation or status. In some embodiments, the datalog may include a timestamped list of data. In some embodiments, the extended scan signal is broadcast without interrupting the broadcast of the first and second advertisement signals. In some embodiments, when the communication link is established, the broadcast of the first and second advertisement signals are interrupted until the communication link is terminated.

In some embodiments, a power tool is disclosed. It includes: a motor controller; a first memory coupled to the motor controller; and a wireless communication module coupled to the motor controller and comprising: a wireless communication controller; and a second memory coupled to the wireless communication controller. During a first power tool operation occurring within a first time period, the motor controller is configured to write power tool operating data into the first memory. During a second power tool operation occurring within a second time period mutually exclusive to the first time period, the wireless communication controller is configured to write the power tool operational data into the second memory after the conclusion of the first power tool operation. In some embodiments, the first power tool operation comprises operating the power tool between a first trigger pull and a shutdown operation of the power tool. In some embodiments, the second power tool operation comprises conducting a shutdown operation of the power tool. In some embodiments, during the first time period, the wireless communication controller is powered by a battery pack and is further configured to write the power tool operational data to the second memory. In some embodiments, the wireless communication module further comprises a secondary battery and, during the second time period, the wireless communication controller is powered by the secondary battery to write the power tool operational data into the second memory.

In some embodiments, a battery pack is disclosed. It may include: a battery management controller; a first memory coupled to the battery management controller; a wireless communication controller coupled to the battery management controller; a second memory coupled to the wireless communication controller and the battery management controller; and an interface to couple the battery pack to a power tool. During a first power tool operation of the power tool occurring within a first time period, the battery management controller is configured to write battery pack operating data into the first memory. During a second power tool operation of the power tool occurring within a second time period mutually exclusive to the first time period, the wireless communication controller is configured to write the power tool operational data into the second memory after the conclusion of the first power tool operation. In some embodiments, the first power tool operation comprises operating the power tool between a first trigger pull and a shutdown operation of the power tool. In some embodiments, the second power tool operation comprises conducting a shutdown operation of the power tool.

In some embodiments, a battery pack is disclosed. It may include: at least one capacitive cell; a positive terminal and a negative terminal both coupled to the at least one capacitive cell; a data communication terminal configured to be coupled to a power tool; and a wireless communication controller coupled to the data communication terminal and configured to transmit data wirelessly to an external device. A tool ID of the power tool is received through the data communication terminal. The wireless communication controller is further configured to wirelessly transmit the tool ID and battery pack operational data associated with the power tool operation.

In some embodiments, a power tool is disclosed. It may include: a housing; a motor; a trigger; a microcontroller; a wireless communication module coupled to the microcontroller; and an attachment mechanism configured to couple a battery pack to the power tool. The microcontroller is configured to receive a battery pack ID of the battery pack when the battery pack is coupled to the power tool. The wireless communication module is configured to wirelessly transmit the battery pack ID along with power tool operational data to an external device.

In some embodiments, a gateway is disclosed. It may include: at least one processor; at least one memory; and a wireless transceiver coupled to the at least one processor. The wireless transceiver is configured to receive a connectable advertisement signal from a mobile construction site device. The at least one processor is operable to: compare a data load value in the connectable advertisement signal to a threshold, the data load value representing an amount of data stored in the mobile construction site device; and initiate a communication handshaking and authentication protocol with the mobile construction site device if the data load value is greater than the threshold, to receive a datalog of operational data about the mobile construction site device. In some embodiments, the datalog may include a timestamped list of data. In some embodiments, the threshold may be a predetermined value, or it may be a value that is dynamically set by the gateway based on other criteria such as its own availability and prioritization. In some embodiments, the processor is further operable to prioritize establishing a wireless connection with the mobile construction site device based on a value of the data load value or a strength of signal value of the mobile construction site device. In some embodiments, the processor is further operable to terminate a connection with the mobile construction site device after receipt of a signal indicating that there is no more data available to be transmitted to the gateway, or after a predetermined time after receiving a receipt of a last signal containing data in the timestamped datalog.

In some embodiments, a system is disclosed. The system may include: a wireless communication module of a mobile construction site device, comprising: a microcontroller; a memory coupled to the microcontroller; a wireless communication controller coupled to the microcontroller. The memory may store an encryption key or a value associated with the encryption key. The wireless communication controller may be configured to wirelessly transmit an advertisement signal that contains operational data of the mobile construction site device that is partially encrypted using the encryption key or the associated value and partially unencrypted, the operational data that is partially unencrypted comprising a unique ID of the mobile construction site device. The system may further include a remote server comprising: at least one processor; at least one memory; and a data communication module configured to receive the operational data from the mobile construction site device. The at least one processor may be operable to: identify the unique ID in the operational data; determine the encryption key or the associated value based on the identified unique ID; and decrypt the portion of the operational data that is encrypted using a decryption key associated with the determined encryption key. In some embodiments, the memory of the wireless communication module further stores a table of encryption keys and an associated value for each of the encryption keys, and the microcontroller is configured to embed one of the associated values of one of the encryption keys into the operational data; and the processor of the remote server is further operable to decrypt the operational data using the encryption key associated with the value. In some embodiments, the encryption key and/or the associated value is included in a header of the advertisement signal and the encrypted data is included in a body of the advertisement signal.

### BRIEF DESCRIPTION OF THE DRAWINGS

Features of the present disclosure may be illustrated by way of example and not limited in the following figure(s), in which like numerals indicate like elements, in which:

FIG. 1 shows a system including an example battery pack capable of attaching to multiple power tools, collecting a level of data metrics from the power tool based on one or more communication module attributes of the power tool, and sending the data to a backend server.

FIG. 2 shows the power tool 20 with full integrated wireless communication module functionality and the connection terminals to the battery pack 60.

FIG. 3 shows a motor control diagram 300 of power tool 10 that includes an integrated wireless communication module.

FIG. 4 shows a tool with wireless communication module 240 but no dedicated communication terminal.

FIG. 5 shows a partially exploded view of a power tool with an integrated wireless communication module 410.

FIG. 6 shows a cross section of the tool foot 610 of a power tool, such as power tool 10 or 20, that contains the wireless communication module 240 and terminal block 415.

FIG. 7 shows an exploded view of an integrated module for housing a wireless communication module and a terminal block.

FIG. 8 shows a view from the underside of the base member 715 of power tool 10.

FIG. 9 shows a perspective view of the base member 715.

FIGS. 10A, 10B, and 10C show varying block diagrams of the battery pack 60, according to some embodiments.

FIG. 11 shows an exploded view of the battery pack 60, according to some embodiments.

FIG. 12 shows an exploded view of the battery cells and circuitry, which are enclosed by the two-piece housing.

FIG. 13 shows a top-down view of the circuitry of the battery pack 60, according to some embodiments.

FIG. 14 shows a block diagram of an example gateway 80 (see FIG. 1) that is configured to interface with one or more power tools, such as power tool 10 or 20, according to some embodiments.

FIG. 15 provides an example methodology of a battery pack of the present disclosures for associating itself with a power tool and collecting various data metrics depending on a level of connectivity capable with the power tool, according to some aspects of the present disclosure.

FIGS. 16A and 16B show example flowcharts with extra detail for processes described in FIG. 15.

FIG. 17 provides a more detailed description of how a battery pack of the present disclosures successfully connects and collects data from various power tools that possess varying levels of connectivity.

FIGS. 18A, 18B, 18C, and 18D show example flowcharts with extra detail for processes described in FIG. 17.

FIGS. 19A, 19B, and 19C provide example message protocol diagrams between a peripheral device, such as a power tool, and a central device, such as a battery pack or a gateway that is connected to a backend server.

FIG. 20 provides an example process for how a backend server ingests the multiple streams of data.

FIGS. 21A, 21B, and 21C show example flowcharts with extra detail for processes described in FIG. 20.

FIG. 22 shows an example methodology of a battery pack or a power tool interacting with a gateway according to one or more communication protocols, according to some embodiments.

FIG. 23 shows an example methodology of a power tool implementing a multi-stage memory writing operation and power draw protocol, according to some embodiments.

FIG. 24 shows an example methodology of a gateway for controlling the influx of data from multiple mobile construction site devices, according to some embodiments.

FIG. 25 shows an example methodology of an encryption procedure for encrypting part of the data sent by a mobile construction site device, according to some embodiments.

FIG. 26 depicts an example display provided on a GUI showing a list of assets, according to some embodiments.

FIG. 27 depicts an example display provided on a GUI in response to the user's selection of an asset from the list of assets on the display of FIG. 26, according to some embodiments.

FIG. 28 depicts an exemplary graphical plot illustrating the runtime summary of a device or a set of assets, according to some embodiments.

FIG. 29 depicts an exemplary graph illustrating the runtime classifications of the devices within an asset family, according to some embodiments.

### DETAILED DESCRIPTION

The disclosure relates to a system of at least one power tool, at least one battery pack, and a backend server for interrelating data collected by the power tool and/or the battery pack. The system may encompass a collection of battery packs that are each configured to be interchanged between multiple power tools with varying levels of connectivity to the battery packs. Depending on the level of connectivity, the battery pack may be configured to collect a different level of data that can ultimately be compiled, correlated, and analyzed by a backend server. The disclosure further relates to methods and apparatuses for connecting and communicating with a communication module that is coupled to the power tool, and to collecting power tool data from the communication module. Power tool data is information that is collected by the battery pack about a power tool. The power tool data may include, without limitation, an identifier that identifies the power tool, location data, tool diagnostics data, enhanced tool data, and/or other types of data about the power tool. The battery pack may be communicably coupled and deliver power to different power tools of the same or different type. Thus, the battery pack is interchangeable and able to deliver power to and collect power tool data from a wide range of power tools. A backend server is configured to compile the received information from multiple battery packs and/or multiple power tools and link multiple streams of data to together.

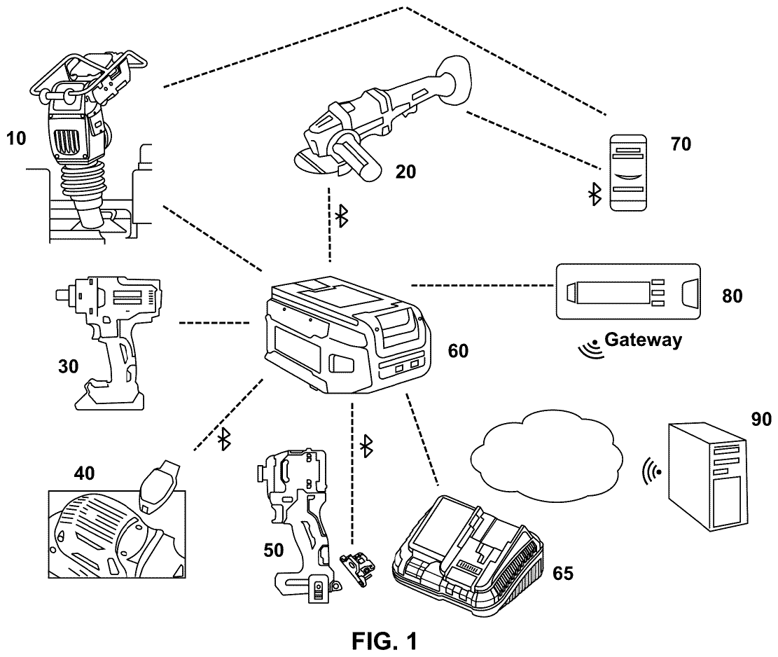

Referring to FIG. 1, shown is a system including an example battery pack 60 capable of attaching to multiple power tools 10, 20, 30, 40, and 50, and collecting a level of data metrics from the power tool based on one or more communication module attributes of the power tool, consistent with the present disclosures. FIG. 1 also shows some power tools, such as tools 10 and 20, that are configured to collect their own data and transmit that data independently of the battery pack 60. The system diagram of FIG. 1 further includes a charger 65 capable of providing a charging current to the battery pack 60, where the battery pack 60 is capable of collecting data metrics related to the charger and/or the charging parameters from the charger 65. The system diagram of FIG. 1 also includes a backend centralized server 90 that is connected to the cloud, and a gateway providing secure access to the backend server 90 through the cloud, in the form of either a gateway module 80 or mobile app 70 as two examples, that can receive data wirelessly from the battery pack 60 and at least some tools that are configured to independently communicate with the gateway. The gateway modules 70 and 80 may then route the data to the centralized server 90 via the cloud.

Tool 10 is depicted herein by way of example as a concrete tool such as a compacting tool or a rammer. An example of such a tool may be found in US Patent Publication No. 2023/0392326, which is incorporated herein by reference in its entirety. Another example of such a tool may be found in U.S. patent application Ser. No. 18/812,119, filed on Aug. 22, 2024, which is also incorporated herein by reference in its entirety. Tool 20 is depicted by way of example as a metalworking tool such as a grinder. Examples of such a tool may be found in U.S. Pat. No. 11,241,781, which is incorporated herein by reference in its entirety. It should be noted that tool 10 and/or tool 20 may be any other type of power tool or equipment, whether corded or battery powered, used in construction or DIY applications, including but not limited to, concrete tools (e.g., rammers, plate compactor, screed, concrete saw, concrete drill, etc.), woodworking tools (e.g., circular saw, reciprocating saw, table saw, miter saw, routers, etc.), metalworking tools (e.g., grinder, die grinder, cut-off tool, polisher, etc.), fastening tools (e.g., impact tools, drills, hammer drills, impact wrenches, ratchets, etc.), nailing tools (e.g., concrete nailers, roofing nailers, finishing nailers, etc.), work light products, lasers, etc. In many cases, the power tool includes an electric motor, such as a brushless direct-current (BLDC) motor, an example of which may be found in US Patent Publication No. 2024/0072599, which is incorporated herein by reference in its entirety. The motor may be controlled by a motor controller using an angular position sensor, or via a sensorless control scheme. An example of a sensorless control scheme may be found in U.S. Pat. No. 11,171,586, which is incorporated herein by reference in its entirety.

The amount of different types of power tool data that is collected by the battery pack 60 may vary depending on one or more communication module attributes (“CM attributes”). The varying amounts may be referred to herein as different levels of data metrics. A CM attribute describes the installation configuration and/or type of the communication module. An installation configuration refers to whether the communication module is integrated with the power tool or not. Thus, in some examples, the level of data metrics of the power tool data may vary depending on whether the communication module is integrated with the power tool.

For example, some power tools may not have an integrated communication module, while others do. Tools 40 and 50 of FIG. 1 are some examples of tools that have a communication module that is not integrated into the tool. A communication module is not integrated with a power tool when the power tool is manufactured separately from the communication module so that the manufactured power tool is completed without the communication module. In these examples, the communication module can be removably added to the power tool after the power tool is manufactured to enable a limited communication with the battery pack, such as data correlation and tool identification. Some examples include a power tool that is refurbished with a DEWALT wireless Tool Connect® Tag (DCE045) or DEWALT wireless Tool Connect® Chip (DCE042). As such, the battery pack may support backward compatibility for power tools without integrated communication modules.

On the other hand, a communication module is integrated with the power tool when the power tool is manufactured with the communication module such that the power tool is completed with an onboard communication module. Tools 10 and 20 are examples of tools with an integrated communication module as described herein. More particularly, the communication module is integrated with the power tool when the communication module is manufactured to share electrical (such as power source) or communication (such as a data bus) links with other components such as circuitry that controls, monitors, or powers the power tool. In these examples, at least some of the power tool data may be directly obtained from the circuitry of the power tool. In some of these examples, the communication module may participate in two-way communication with the other components of the power tool. In addition, embodiments include a power tool that has an integrated communication module with an ability to transmit a partial amount of data, such as tool 20, while other power tools have an integrated communication module with an ability to transmit the full or comprehensive level of data, such as tool 10. In some embodiments, the tools 10 and/or 20 may be configured to use their integrated communication module to transmit data to the battery pack 60. For example, the tool 10 may be an example of a rammer that has a data communication terminal with wired communication with the battery pack 60. In other cases, the tools 10 and/or 20 may be configured to use their integrated communication module to transmit data directly to the gateway, such as either app 70 or gateway module 80. For example, the tool 20 may be a grinder that includes wireless communication capability for transmitting data directly to the gateway.

The level of data metrics collected from a power tool by a battery pack of the present disclosure may depend on the CM attributes of the communication module present with the power tool. The battery pack may include functionality for identifying the power tool it is coupled to and then determining the CM attributes of the communication module present with the particular power tool. For example, older generation power tools may be refurbished with a wireless tag that the battery pack is configured to detect, such as tools 40 and 50. The communication module in this example would be the wireless tag, and a CM attribute in this example may be the associated circuitry with the wireless tag that allows the battery pack to detect identifying information associated with the wireless tag. With the battery pack detecting the wireless tag, the battery pack may then know that the tag can provide identifying information about the tool and cannot provide data metrics, and therefore any information obtained by the battery pack can be later correlated with the tool data, say at the backend server, using the identifying tag information. As another example, in new models of power tools that include an integrated communication module, such as tools 10 and/or 20, the battery pack may be able to collect a greater level of data metrics from the power tool due to the communication module having different CM attributes that the battery pack can detect. After a period of continuous data collection, the battery pack may then occasionally transmit the totality of its records to a centralized data repository and expunge the data from its local stores. As another example, an old power tool without any refurbished communication module, such as tool 30, may only provide usage data to the battery pack 60 based on power draws from the battery and so forth. In this way, a fleet of battery packs attached to multiple power tools may provide a comprehensive picture of the health and safety status, usage, and/or geographic location of the power tools used in the aggregate, say at a construction site. The battery pack 60 being capable of connecting to older and newer models, which may use communication modules with different CM attributes, allows for backwards compatibility and versatility to provide a single type of battery pack that is interchangeable with many or all power tools at a single location.

Still referring to FIG. 1, in some examples, the battery pack relays information related to the power tool in the following manner:

For a power tool that has no communication module, that is, neither an integrated nor non-integrated communication module, the battery pack 60 may be capable of collecting only a basic level of data metrics. Tool 30 is an example of such a tool that has no ability to communicate to the battery pack 60. The battery pack 60 will not have a communication module to connect to, and may detect no CM attributes as a result, or alternatively there would be only one CM attribute which is generated as “a completely unconnected tool.” The basic level of data metrics may include the battery pack 60 only being able to register tool usage information such as the number of trigger pulls/releases, runtime, etc. The term “register” means accessing the power tool data and locally storing the accessed data in a memory of the battery pack. In this case, accessing the tool usage data may include monitoring power delivery from the battery pack to the power tool to determine the tool usage information. For example, the battery pack may detect when power is drawn from itself and a time interval of the power draw in order to register a trigger pull and release. Because there is no communication module associated with this power tool, the battery pack may register this information with an unidentified tool.

For a conventional power tool that has an attached but non-integrated communication module, a centralized data system may have already registered the non-integrated communication module with that power tool. Examples of a tool with a non-integrated communication module are tools 40 and 50. For example, tool 40 may include a wireless tag, while tool 50 may include a chip, and the battery pack 60 may register the tag/chip's Bluetooth® MAC address with that power tool. The battery pack 60 coupled to that power tool will then read the tag/chip MAC address and associate the data with that power tool at the backend server. In the case of an integrated wireless module, it would also know the tool type and serial number of the tool itself. The level of power tool metrics that can be collected in this example may include certain types of tool usage information along with an identifier of the communication module. The battery pack 60 may register what data is available and store the various data metrics in association with the identifier of the communication module.

For a power tool that has an integrated wireless communications module, such as a Bluetooth Low Energy module (BLEM), with a first level of functionality, such as having only partial functionality, the battery pack will read the tool's MAC address and/or serial number and correlate the data with that tool. Tool 20 may be an example of a tool with an integrated wireless communication module with the first level of functionality. In addition to sending data to the battery pack 60, the tool's wireless communications module (e.g., BLEM) will also be able to separately send its own data to a centralized data system 90 via the gateway 80 and/or mobile app 70. The centralized data system 90 will gather data from the battery pack 60 and from the tool 20.

For a power tool that is fully compatible with data collection functionality, there is a new data terminal between the battery pack and the power tool. An example of this is tool 10. The power tool 10 may communicate its ID through the data terminal. From that point on, the battery pack 60 may associate its data with the power tool 10. Further, the power tool 10 will recognize that the battery pack 60 provides the full data collection functionality and will send its own additional data (such as trigger forward pulls, trigger reverse pulls, tool mode select, hot module shutdown, overspeed, underspeed, etc.) to the battery pack 60 via the battery terminal. The battery pack 60 may package and catalog that data with its own data while it was in use with the power tool 10. The cataloged data may be periodically transmitted to the centralized data system from the battery pack 60. The tool 10 may also be capable of directly transmitting data to the server 90 through a gateway, such as gateway 80 or mobile app 70.

In some examples, a power tool that has full data collection functionality has its own integrated wireless communications module, such as its own integrated BLEM. If it recognizes that the battery pack that it is connected to is an older type of battery pack, such as a conventional battery that is not a type of battery pack of the present disclosures, then it may transmit its data directly to the centralized data system via its own integrated wireless communications module without going through the battery pack.

In other cases, while the power tool may possess its own wireless communications module, the battery pack may be configured to collect a different set of data than what the power tool collects and may transmit a separate set of its own data to the gateway 80 or the app 70. In these situations, particular interactions between the power tool and the battery pack may occur that will be described more below.

In some embodiments, the battery pack 60 may be further configured to receive, collect, and store various data from the charger 65. This may be done via a dedicated data communication terminal provided in the terminal block connection between the charger and the battery pack 60; via the charging terminals of the battery pack 60; or via wireless communication between the charger 65 and the battery pack 60. Such data might relate to the charger performance or condition (e.g., charger temperature, total number of charges performed, error conditions, etc.) or it might include parameters and statistics related to the charge of the battery pack 60 (e.g., charge time, charger temperature during charging, fault condition during charging, etc.). Further, a unique ID associated with the charger may be transmitted from the charger to the battery pack 60 so the battery pack can correlate the charger data with the unique ID of the charger. In an example, the battery pack is configured to package battery pack operational data related to performance or condition of the battery pack with the charger data for a duration of a charging operation of the battery pack (i.e., for a charging period while the battery is being charged by the charger), and transmit the package to the external device

### Power Tool Examples

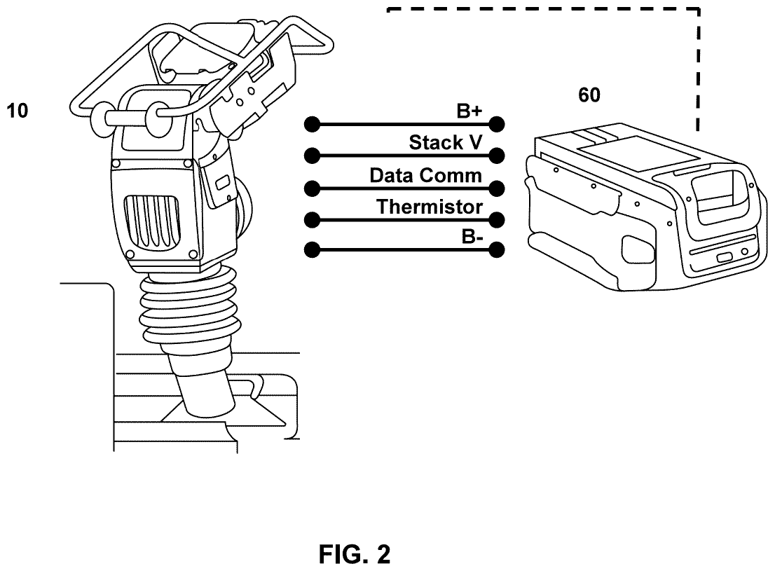

Referring to FIG. 2, shown is the power tool 10 with full integrated wireless communication module functionality and the connection terminals to the battery pack 60, according to some embodiments. In conventional connections from a battery pack to a power tool, the battery pack and the tool typically have four terminals, B+, B−, thermistor, and split stack voltage. The battery pack 60 includes a fifth terminal that, when coupled to a battery charger, provides a unique ID associated with the battery pack to the battery charger. This fifth terminal is conventionally maintained in a floating state when the battery pack is coupled to a power tool. Here, aspects of the present disclosure include providing a corresponding terminal on a terminal block of the power tool 10 and utilizing the fifth terminal of the battery pack as a “data comm” terminal between the battery pack and the power tool 10, thus providing a dedicated wired communication line between the battery pack 60 and the power tool 10 via the terminal block of the battery pack and the power tool.

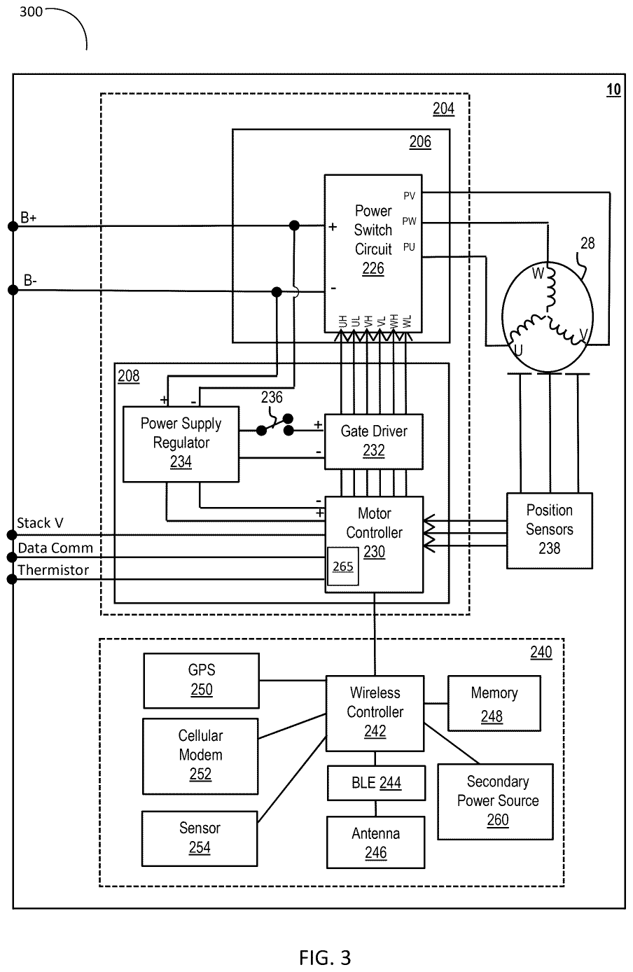

FIG. 3 shows a motor control diagram 300 of power tool 10 that includes an integrated wireless communication module, according to some embodiments. In some embodiments, power tool 10 includes a motor 28, which may be an electronically commutated brushless motor. Coupled to the motor is a series of position sensors 238 (e.g., Hall sensors) arranged to output signals corresponding to a rotational position of the motor 28. A motor control unit 204 is operable to control the motor commutation. The motor control unit 204 includes a power module 206 and a control module 208. Power module 206 includes a power switch circuit 226 provided between a power source (e.g., B+ and B− nodes of a battery pack) and the motor and configured as an inverter circuit for regulating the supply of power to the motor 28. The control module 208 includes a motor controller 230, which is a programmable processor configured to control the motor commutation drive to achieve a desired speed based on the position signals from the position sensors 238, a gate driver 232 that drives the gates of power switches in the power switch circuit 226 based on drive signals from the motor controller 230, and a power supply regulator 234 that supplies DC voltage at appropriate voltage levels to the motor controller 230 and the gate driver 232. The DC voltage is supplied by a battery pack that would be connected to the power tool 10 and therefore the motor controller 230 is activated when a battery pack is connected to and powering the power tool 10. Additionally, the motor controller 230 receives signals such as the stack voltage and thermistor signals from the battery pack and shuts down supply of power from the battery pack in the event of a fault condition (e.g., over-temperature or under-voltage condition) based on the signals. In an embodiment, the motor controller 230 additionally receives the data comm signal from the battery pack, by which it establishes a designated communication line with the battery pack to transmit and receive data. The motor control 230 is configured to record any and all of these signals it receives into a database stored in a local memory 265.

Further included in this diagram is the integrated wireless communication module 240, which is connected to the motor controller 230 and is configured to wirelessly communicate various power tool and operation data to and from the motor controller 230. In some embodiments, the wireless communication module 240 includes wireless controller 242, memory 248, and BLE unit 244 coupled to antenna 246 to transmit the wireless data. It may also have GPS 250 and cellular modem 252 capabilities. The cellular modem can allow for a SIM card to be connected to the tool and can communicate data from the tool to a cellular network. The sensor 254 could include multiple sensors, such as a location sensor, accelerometer, gyroscope, magnetometer, pressure sensor, and more, to generate data and be collected by the wireless communication module 240. A secondary power source 260 is present in the wireless communication module 240 and powers the wireless communication module 240 when the power tool 10 is idle. An example of the secondary power source 260 may be a coin cell (including a rechargeable or a non-rechargeable coin cell, and a serviceable or a non-serviceable coin cell), a capacitor, an accumulator, etc. When the power tool 10 is not idle and is actively in use, say upon a trigger pull of the power tool 10, the wireless communication module 240 is powered by the battery pack connected to the power tool 10. In some embodiments, the wireless communication module 240 may be configured to transmit the collected data to a gateway, such as gateway 80, or an app 70. In other cases, the wireless communication module 240 may transmit data to a battery that the power tool is connected to.

In some embodiments, the motor controller 230 remains powered by the battery pack for a short period of time, e.g., 20 seconds, after the last trigger is pulled by a user and, in a separate scenario, until a fault condition may occur. After this period, the motor controller 230 is configured to perform a shutdown procedure, which includes transmitting the saved data in the memory 265 to the wireless controller 242, which then writes the received data to the memory 248 of the wireless communication module 240. This write operation by the wireless controller 242 is powered by the battery pack. Thus, the wireless communication module 240 is powered by two different sources at different times. The battery pack, which may be designated as a primary power source, may power the wireless communication module 240 in the period between a last trigger pull in a sequence and before a shutdown procedure, while the secondary power source 265 may power the wireless communication module 240 at all other times, including when the power tool 10 is idle. In this way, the secondary power source is saved as much as possible, because the primary power source of the battery is available throughout the power tool 10 through the B+ line (see FIG. 3) only during the period of a trigger pull and before a shutdown procedure or fault condition occurs.

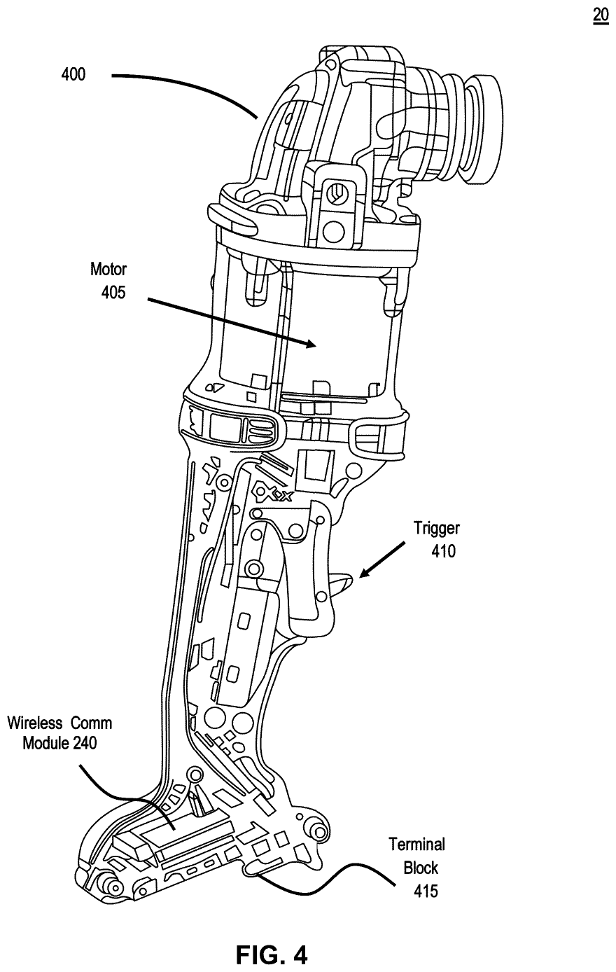

Referring to FIG. 4, illustration 400 shows an exemplary power tool 20 including a wireless communication module 240. Power tool 20 may include a similar system diagram to power tool 10 described above, but with no dedicated data communication terminal in the terminal block 415. Rather, all data communication from the power tool 20 is carried out via the wireless communication module 240. Featured are common pieces of the tool, such as motor 405 and trigger 410. The wireless communication module 240 is positioned at the foot of the tool and has a subset of the full functionality, consistent with what is described in relation to tool 20. The terminal block 415 is integrated into a foot of along an insertion axis of a battery pack (not shown), and the wireless communication module 240 is housed within the foot of the tool above the position of the battery pack. In an embodiment, the terminal block 415 is a physically separate block from the wireless communication module 240 at the bottom.

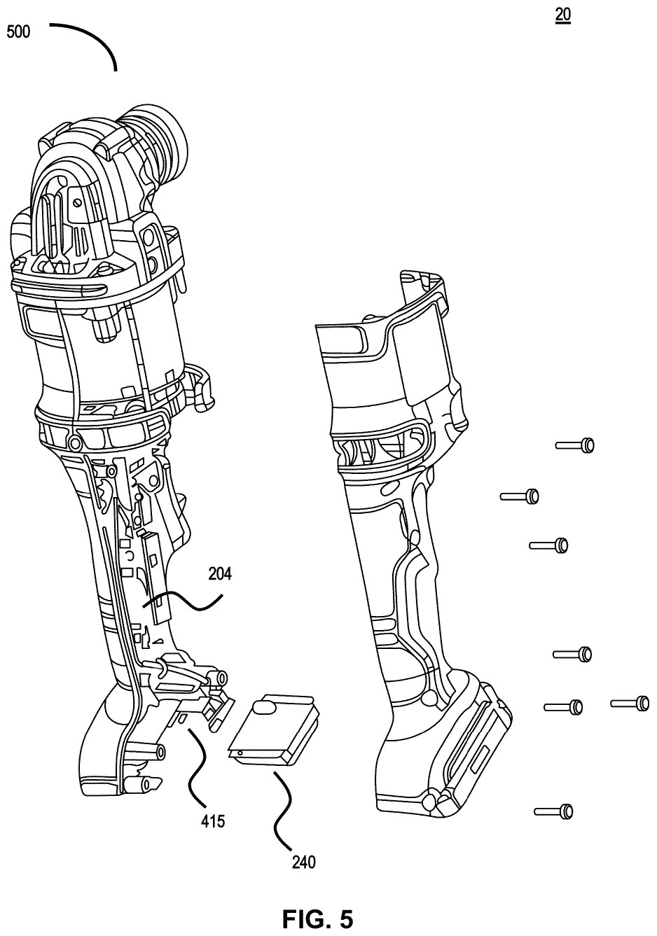

Referring to FIG. 5, illustration 500 shows a partially exploded view of the example power tool 20 with the integrated wireless communication module 240. As shown here and in FIG. 4, the wireless communication module 240 is housed within a compartment formed by one or more interior walls of the power tool housing within the foot of the power tool above the location of the battery pack (not shown). The clamshell arrangement forming the tool housing fully encapsulates the wireless communication module 240. The wireless communication module is electrically connected to the motor control unit 204 via one or more data communication wires extending from through the lower end of the tool handle. The terminal block 415 is similarly coupled to the motor control unit 204 via a series of wires (including the B+, B−, Stack Voltage, and Thermistor lines) that extend substantially along the data communication wires.

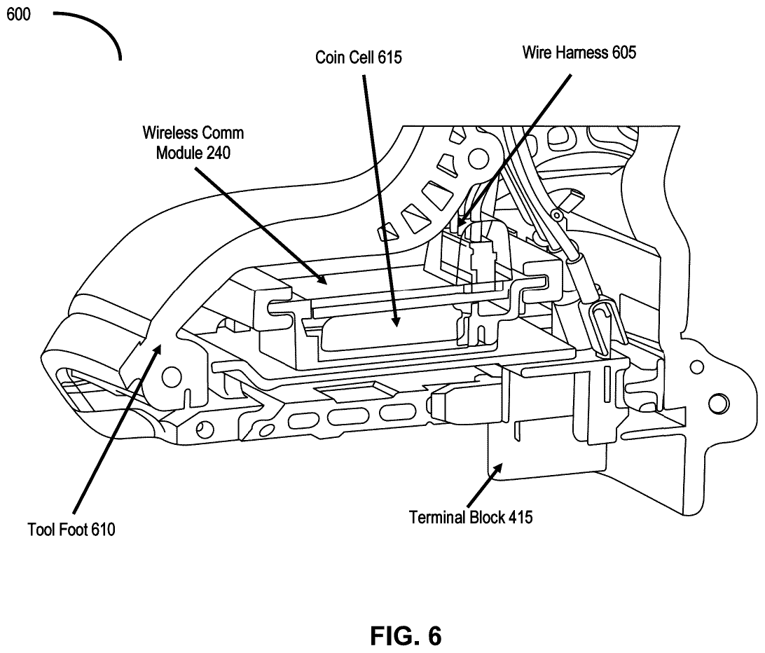

Referring to FIG. 6, shown in illustration 600 is a cross section of the tool foot 610 of power tool 20 that contains the wireless communication module 240 and terminal block 415. As shown here, wireless communication module 240 includes a printed circuit board that supports one or more antennas and electronics and control circuitry for wireless communication. In addition, it includes a backup power supply mounted on the circuit board. The backup power supply may be a coin cell 615 as shown in this example. Alternatively, the backup power supply may be a rechargeable battery cell, a capacitor, or any other known energy storage unit. The backup power supply may be utilized to power the wireless communication module 240 when a battery pack is not coupled to the terminal block. In an embodiment, a connector is further mounted to the circuit board for a coupling a wire harness 605 from the wireless communication module 240 to the motor control unit 204.

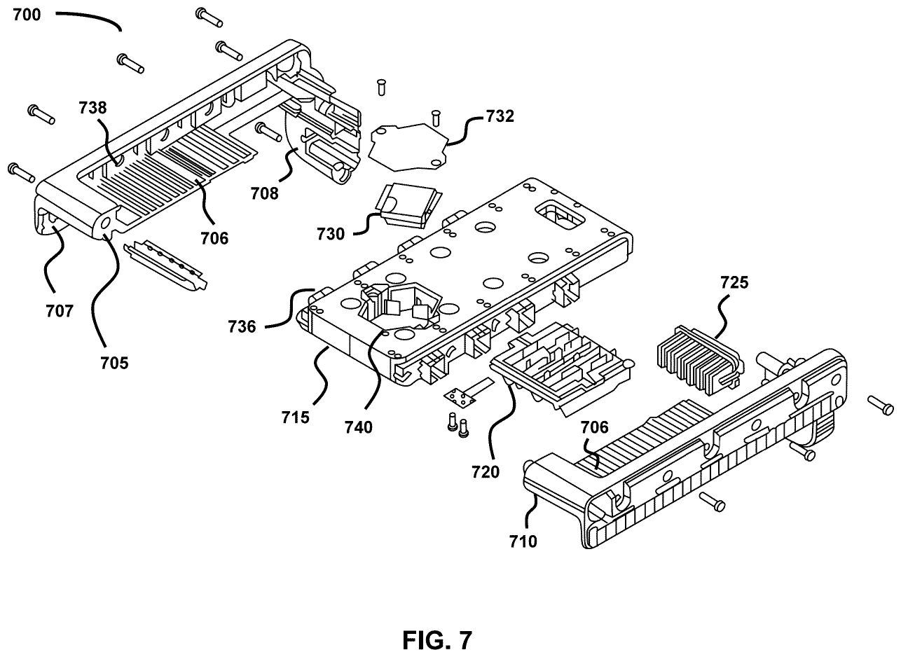

Referring to FIG. 7, illustration 700 shows an exploded view of a battery interface that houses a wireless communication module 730 and a terminal block 720, according to an alternative embodiment. This module may be present in some tools that possess the full data gathering functionality as described with tool 10. For example, this module may be located between the handles of the tool 10 and may couple to the battery pack 60. The wireless communication module 730 may include many of the features described above with reference to wireless communication module 240, including a backup power supply, a circuit board, an antenna, etc.

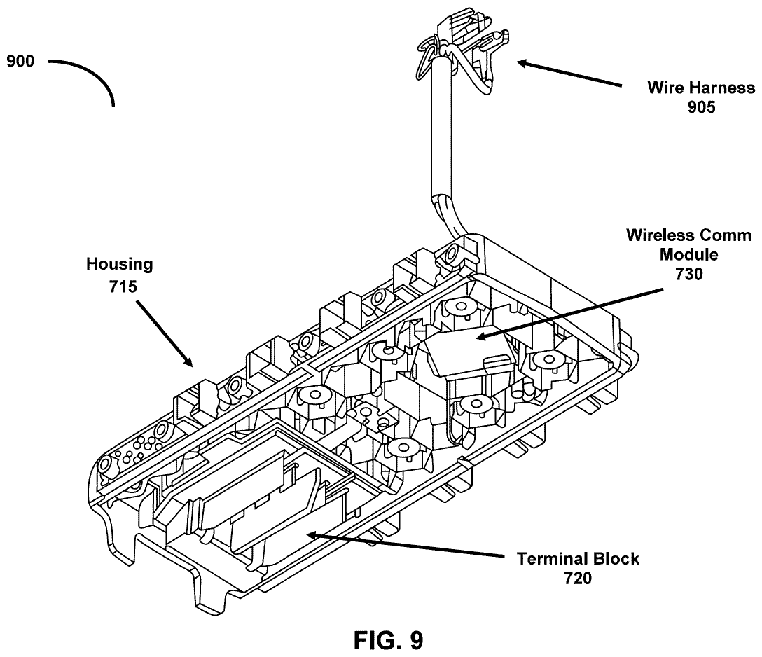

As shown here, the integrated module includes a base member 715 and outer casings 705 and 710 that combine together to enclose the integrated module. The base member 715 includes a substantially planar rectangular profile including a hexagonal pocket on its upper surface, a series of retention features along its side surface. The wireless communication module 730 may be positioned into the hexagonal hole of the base member 715 and covered via a cover 732 fastened to the upper surface of the base member 715. The wireless communication module 730 may be coupled to a motor controller of the tool 10 via a wire harness 905 (see FIG. 9, below). The outer casings 705 cooperatively form a low cover 706 below the base member 715 that substantially covers the lower surface of the base member, railings 707 for receiving a battery pack (not shown) below the planar cover, and a terminal block retention structure 708 at a distal end thereof. A terminal block 720 may be positioned under the base member 715 and secured via a terminal block holder 725 to the terminal block retention structure 708. The base member 715 may include a series of side projections, with side projection 736 being one example of them. The out casings 705 and 710 may include corresponding recesses, such as recess 738, that each engage with a respective side projection to firmly hold the base member 715 in place. The base member 714 may also include a cavity 740, in this case shaped like a hexagonal hole. The cavity 740 may be provided on a surface of the base member 715 opposite the terminal block 720 and may be located closer to a frontal end of the base member than its rear end. In addition, low cover 706 may include a cutout region in which the terminal block 720 is supported.

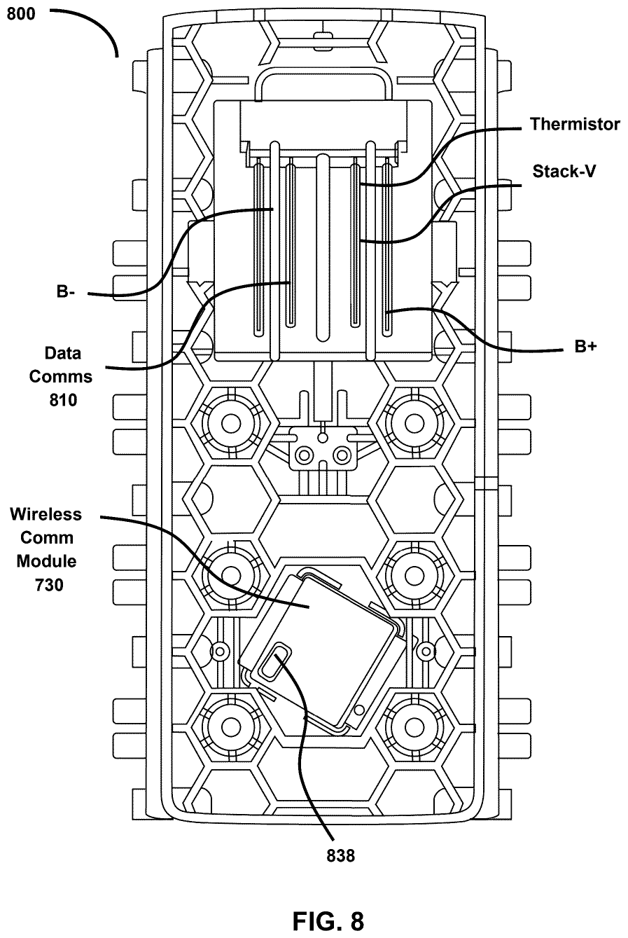

The terminal block 720 may be connected to the motor controller by a connection that is separate from the wire harness 905 that connects the wireless communication module 730 to the motor controller. In this way, in some embodiments, any data communication via a data comms terminal (see, e.g., data comms 810 in FIG. 8, below) may be handled by the motor controller, whether the data comes from the wireless communication module or is data derived from the terminal block 720. On the other hand, in some embodiments, it is possible for the wireless communication module 730 to be coupled to the data comms terminal via a connector that extends through the base member 715. In either case, with the wireless communication module integrated into the same housing as the terminal block, manufacturing next generation power tools will be simpler and more cost efficient.

Referring to FIG. 8, illustration 800 shows a view from the underside of the base member 715 of power tool 10. As shown here, the terminal block 720 includes, in addition to B−, B+, Thermistor, and Stack Voltage nodes, a data comms terminal 810. As discussed briefly above and in detail later in this disclosure, the data comms terminal 810 is used to provide a wired communication line between the power tool 10 and a battery pack. Here, the wireless communication module 730 is positioned within the base member 715 axially forward of the terminal block. As mentioned above, communications from the data comms terminal 810 may be handled by the motor controller. In other cases, the data comms terminal 810 may be coupled to the wireless communication module 730 (see FIG. 7) via a connector that extends through the base member 715 (see FIG. 7). In an embodiment, wireless communication module 730 includes a connector 838.

Referring to FIG. 9, illustration 900 shows a perspective view of the base member 715. As shown here, a wire harness 905 is coupled to the terminal block 720 and the connector 838 of the wireless communication module 730 via a series of wires (not shown) routed within the base member 715. The wire harness 905 is routed within the tool housing and coupled to the motor control unit 204 (FIG. 3). As mentioned above in FIG. 7, the wire harness 905 may provide a connection from the wireless communication module 730 to the motor controller.

### Battery Pack Examples

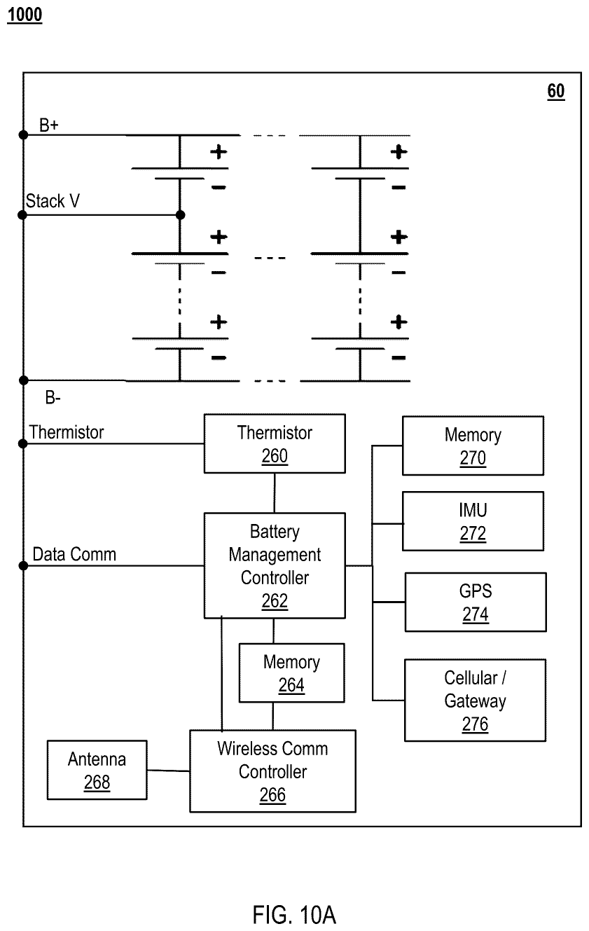

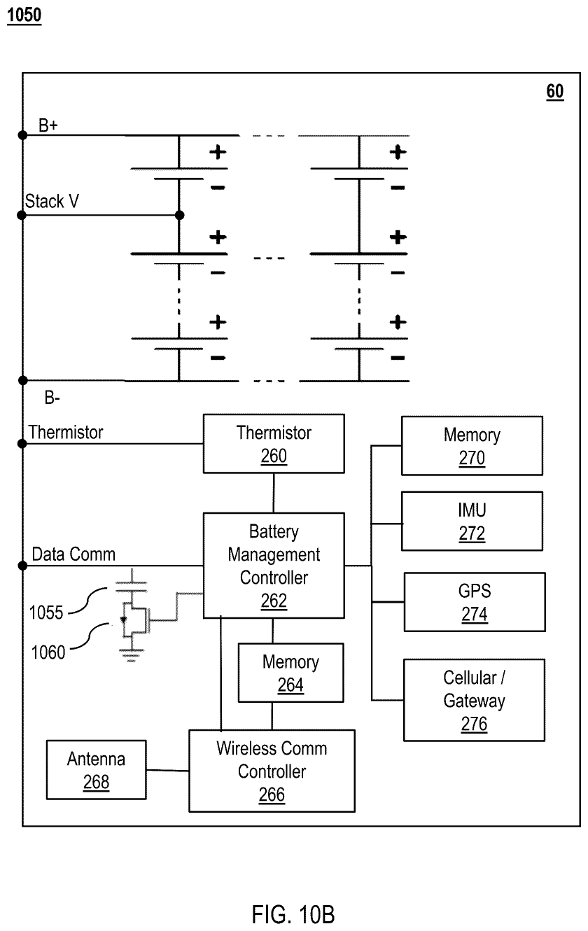

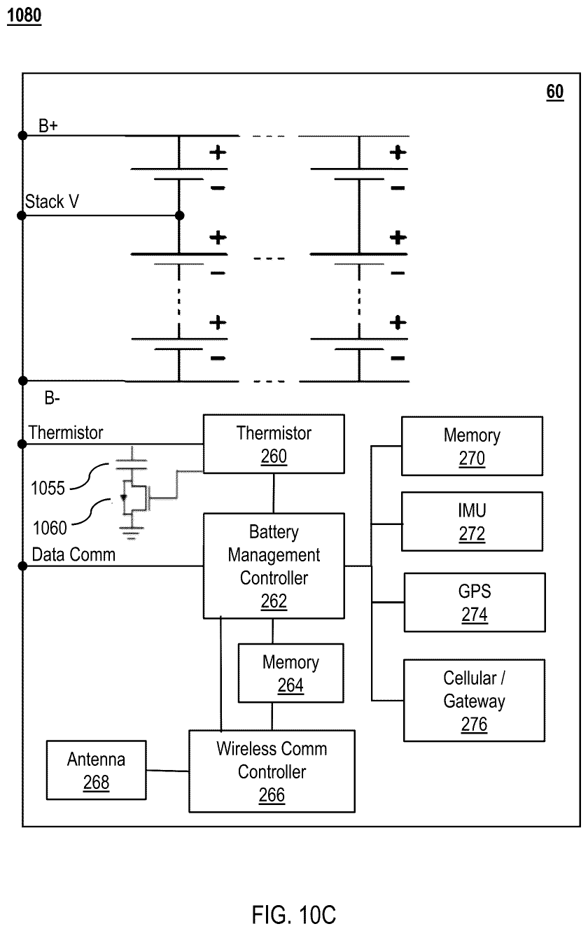

FIGS. 10A, 10B, and 10C show various examples of the configuration of a battery pack for receiving, storing, and transmitting data related to the health and status of the battery and in some cases also the power tool, in the format of block diagrams, according to some embodiments. In general, U.S. Pat. No. 11,569,765 describes battery pack capacity and cell configurations, and pack ID detection via the thermistor line that are consistent with these descriptions and is incorporated herein by reference for more example implementation details. FIG. 10A is a block diagram 1000 of the battery pack 60, according to some embodiments. In this example, the battery pack 60 is capable of receiving data from the power tool and storing the data in a memory 264 of the battery pack. As shown, the battery pack may include multiple battery cells in series and in parallel. The dashed lines running horizontally and vertically indicate that an arbitrary number of cells may be connected together in series and in parallel. The battery pack 60 may include a thermistor 260 coupled to the battery management controller 262. As mentioned above, the battery pack 60 may include a data comm line that is used for different functions depending on if the battery pack is connected to a charger or if the battery pack is connected to a power tool. When the battery pack 60 is connected to the power tool, the data comm terminal is used to determine whether data can be received from the power tool and stored in the battery pack. The battery pack 60 also may include a memory 264 and wireless communication controller 266, which is coupled to an antenna 268 for transmitting data wirelessly to a gateway or other hub that is in contact with the backend server.

In some embodiments, the battery pack 60 is configured to provide its pack ID to the charger when connected to the charger. The battery management controller 262 can also output a unique ID when it determines it is connected to a charger. It may do this by detecting that it receives power through the B+ B− terminals and then may output the ID through the data comm terminal.

Referring to FIG. 10B, which depicts a block diagram 1050 of the battery pack 60 according to an alternative and/or further embodiment, in some embodiments, the data comm terminal may be coupled to an electronic component that can be used to represent the unique ID of the battery pack 60. The electronic component is illustratively a capacitor coupled to a ground node. It should be understood, however, that a resistor coupled to a B+ node, or an R-C circuit including various arrangements of resistors and capacitors, may be alternatively utilized. The resistor or capacitor may possess a unique resistance or capacitance, respectively, such that the reading of the resistance or capacitance through the data comm terminal can be used to determine the unique ID of the battery pack. For example, a 5-Amp·Hour battery pack will have a different resistance or capacitance 1055 that can be registered through the data comm terminal than a different capacity battery pack. In some embodiments, the battery pack 60 may include a FET 1060 in series with the electronic component connected to ground (not shown). The gate of the FET 1060 may be controlled by the battery management controller 262, and the battery management controller 262 may be configured to turn on the FET 1060 when the battery pack intends to utilize the data comm terminal to communicate the unique ID of the battery pack. This might occur, for example, within a predetermined time (e.g., a few seconds) after the battery pack 60 is coupled to a power tool 10 or a charger 65. In that case, the battery management controller 262 may pause data communication on the data comm terminal and activate the FET 1060 to create a discharge path for the capacitor 1055. In an example, the tool 10 and/or the charger 65 may apply a voltage through the data comm terminal to the capacitor 1055, then monitor the time it takes for the capacitor to discharge. This time may be correlated to the unique ID of the battery pack.

FIG. 10C shows an example block diagram 1080 of the battery 60 according to another embodiment. Here, the capacitor 1055 and FET 1060 are coupled to the thermistor terminal of the battery pack 60 instead of the data comm terminal. In an example, while the thermistor terminal is coupled to a thermistor 260, it should be understood that various sensors in the battery pack 60 may be additionally or alternatively connected to the thermistor terminal.

Referring to FIGS. 10A-10C, in some embodiments, the battery pack 60 may have two memories that are configured to store operational data of the battery and/or the power tool it is attached to during different operational stages. Similar to the configuration of the power tool 10 in FIG. 3, the battery management controller 262 may include or at least be coupled to a first memory 270 that is used to store operational data during a live power tool operation. The battery management controller 262 may receive data from the data comm line, or in some cases may receive data from various sensors in the battery pack from the thermistor line (see FIG. 10C, below). The battery management controller 262 may then write the data to the first memory 270 while a user is operating the power tool it is connected to. Then, and similar to the analogous operations as described in FIG. 3, when the power tool completes its tool operation, say after a series of trigger pulls finishes and no further trigger pulls are initiated after a predetermined amount of time, the wireless communication module 266 may cause the data from first memory 270 to be written to a second memory 264 for access by the wireless communication controller 266. The second memory 264 may be a flash memory, for example. This may occur during a second operation of the power tool, say during a shutdown operation. In this way, the wireless communication controller 266 will have access to the latest operational data that has not yet been transmitted to a gateway.

In some embodiments, the battery pack 60 may additionally include an Inertial Measurement Unit (IMU) 272. The IMU 272 may include a gyroscope and/or an accelerometer. Using this information, the battery management controller 262 may measure and register information related to orientation, direction, acceleration, movement and rotation of the battery pack 60. In some examples, the IMU data may be processed by the battery management controller 262 to determine various conditions or events, including but not limited to, battery pack vibration (which may be associated with usage by a power tool), battery pack drop or free fall, a kickback of the associated power tool, etc. In an example, the battery management controller 262 may determine the type of power tool that is coupled to the battery pack by examining the vibration profile. In an example, the battery management controller 262 may determine a high current or high vibration condition by the power tool and shut off supply of current to the power tool accordingly.

In some embodiments, the battery pack 60 may additionally include a GPS unit 274, which may be utilized to provide location information of the battery pack 50. In an example, the GPS unit 274 may continuously provide positional information to the battery management controller 262. In an example, the GPS unit 274 may provide positional information to the battery management controller 262 only upon receipt of a ping signal from it.

In some embodiments, the battery pack 60 may also include a cellular modem and/or a gateway device 276. The gateway device 276 may include many of the details of the gateway 80, details of which are provided later in this disclosure. In this example, the gateway is integrally provided as a part of the battery pack 60, which enables the battery management controller 262 and/or the wireless communication controller 262 to communicate directly with the cloud without an intermediary external gateway device.

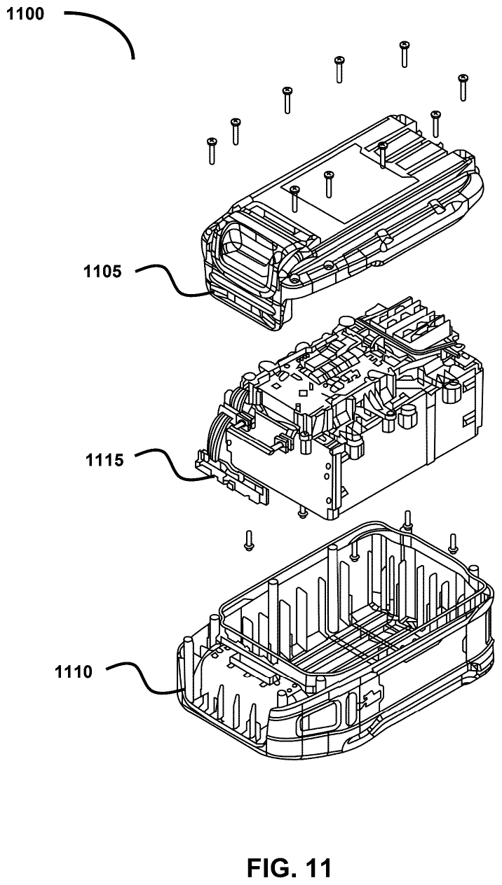

Referring to FIG. 11, illustration 1100 shows an exploded view of the battery pack 60, according to some embodiments. The battery pack 60 includes a two-piece housing, pieces 1105 and 1110, enclosing the battery cells and a State-of-Charge (SOC) board 1115 that includes LEDs and a button. These may be secured together via the screws as shown.

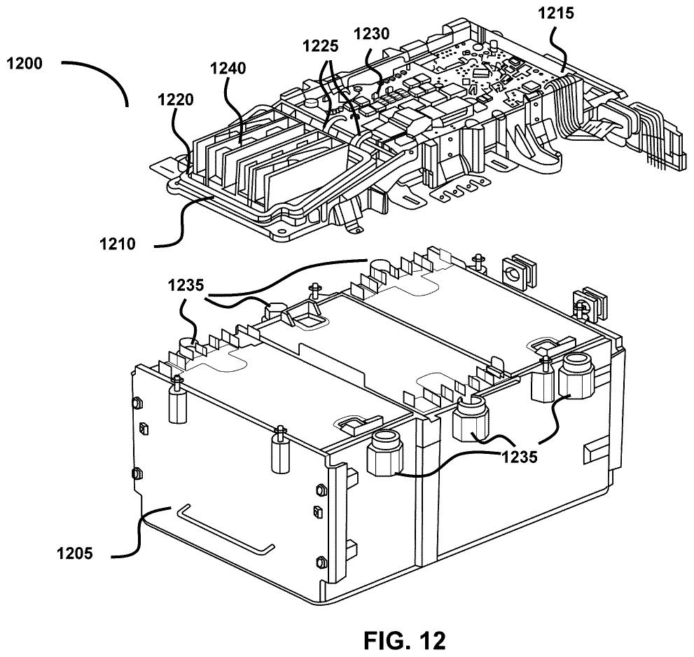

Referring to FIG. 12, illustration 1200 shows an exploded view of the battery cells and SOC board 1115, which are enclosed by the two-piece housing. It can be seen that battery pack 60 include an interior housing 1205 that holds the battery cells, and a mounting member 1210 mounted on top of the interior housing 1205 that is configured to support the battery pack terminal block and the circuitry on top of the battery cells. The battery cells may include any number of cells stacked in series and in parallel. The battery cells and circuitry shown here mirror the descriptions of FIGS. 10A and 10B.

The mounting member 1210 includes a first portion 1215 that supports a circuit board 1230. A second portion 1220 of the mounting member 1210 supports terminal blocks 1240. The first portion 1215 includes an enclosure formed by four walls and a base member (not shown) that solidifies around both surfaces of the circuit board 1230 and substantially all or most of its components. A series of wires, such as wires 1225, extend over a front wall of the first portion to connect the circuit board 1230 to the terminal block 1240. The mounting member 1210 is also fastened to the interior housing 1205 via a series of fasteners 1235, received through side openings, provided outside the walls of the first portion 1215.

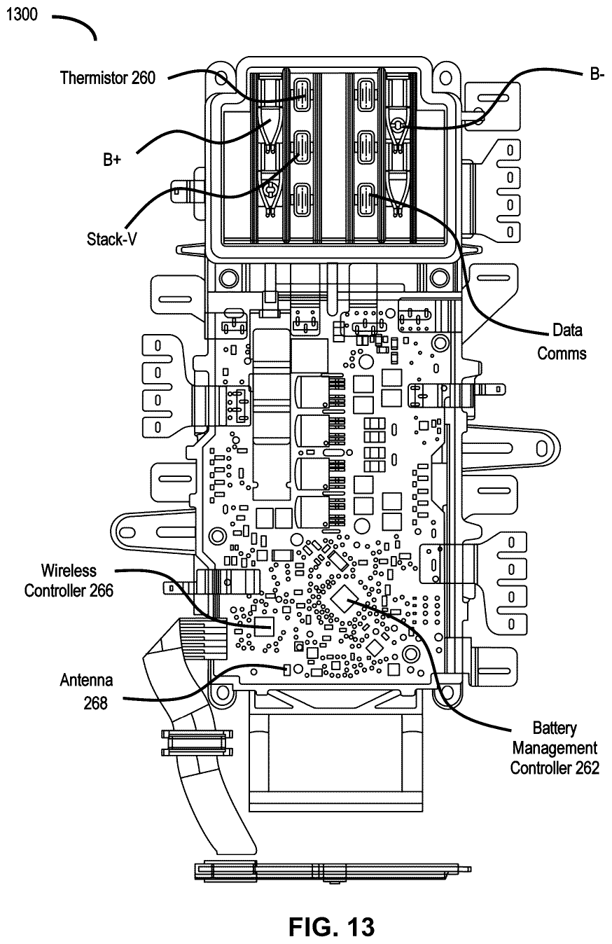

Referring to FIG. 13, illustration 1300 shows a top-down view of the mounting member including the terminal block and the circuitry of the battery pack 60, according to some embodiments. The mounting member includes a first portion that holds the battery terminal block. Of particular note are the positions of the B+, B− terminals, the Stack-V and thermistor 260 terminals, and the data comms terminal within the first portion. The mounting member further includes a second portion defined by a series of walls that receives a circuit board therein. The circuit board supports the electronic components and circuitry for controlling the operation of the battery pack and enabling wired and wireless data communication to and from the battery pack. Of particular note are the locations of the battery managements controller 262, wireless controller 266, and antenna 268. These are consistent with the descriptions in FIGS. 10A and 10B.

### Battery Pack Modes

In some cases, a battery pack of the present disclosure may be equipped with internal measurements for stack voltage (loaded & open), split stack voltage, stack current, and pack temperature; and potentially cell by cell voltage, over voltage faults, and under voltage faults. From these fundamental measurements, stored values in the recorded data section of the battery pack may be derived.

In some examples, a battery pack of the present disclosure may include a real time clock to provide timestamps for records of the primary and derived measurements. The clock will be synced upon the battery's commissioning with the centralized data system and may run indefinitely thereafter. The clock may also be re-synced later using a mobile application or gateway.

In some examples, the battery pack of the present disclosure may include a Bluetooth® radio (e.g., BLE controller 266 described above) and function both as a “Central” and “Peripheral” device. As a Central device, the battery pack may be able to observe wireless tag and chip devices secured to power tools 40 and 50 (FIG. 1). In this mode, the battery pack may also observe a Bluetooth® device and/or make a wireless connection to the Bluetooth® device of a power tool 20 (FIG. 1). In other words, as a Central device, the battery pack acts as a gateway for receiving operational or location data associated with a power tool from the power tool Bluetooth® device and/or tag or chip device secured to the power tool. As a Peripheral device, the battery pack may be able to connect to another Central device that provides connection to the centralized data system, such as a mobile phone or a specialized gateway. The battery pack may default to its Peripheral role until it is determined the battery pack is in use with a particular power tool.

In other embodiments, a battery pack and a power tool may each contain their own BLE modules that are configured to collect data from sensors in their respective devices and transmit this data to a centralized device at a construction site, such as a gateway 80 or an app 70 (see FIG. 1). In these cases, the power tool would not use its connected battery pack as a central device. Instead, both the power tool and the battery pack would be considered peripheral devices, and they would transmit their separate data directly to the gateway acting as the central device.

Techniques for Associating the Battery with a Power Tool

The battery pack of the present disclosure may be specially configured to be coupled to a range of power tools with different levels and capabilities of data connectivity. For example, some models of power tools may lack an integrated communication module, while other models of power tools have integrated communication modules. Still further, communication modules, whether integrated or not, may have different capabilities in collecting and transmitting power tool operational and/or positional data. Thus, different power tools will have different levels of connectivity with the battery pack. That is, the battery pack will be able to collect different power tool data depending on the type and integration of communication module that is coupled to the power tool. By way of example, with reference to FIG. 1, power tool 10 includes a dedicated data comm terminal and is able to communicate without a wireless link with the battery pack 60; power tool 20 includes a BLE module and is able to communicate wirelessly with the battery pack 60; power tool 30 includes no wireless module and is not capable of communicating with the battery pack 60; and power tools 40 and 50 are provided with tag and chip devices respectively that can provide data wirelessly to the battery pack 60. As another example, the battery pack may be capable of collecting data about its own functionality while connected to a power tool, and the power tool may be separately configured to generate and record data about its own functionality. In these cases, the battery pack and the power tool may be configured separately to transmit their own different sets of data directly to a gateway and/or app.

In the examples where the battery pack checks to determine the level of connectivity with the power tool, the battery pack may then change from an inactive state to an active state when it detects a discharge current reading above a baseline threshold current, indicating the battery is attached to a tool and in use. On detection, the battery may change to Central mode and will enter a scanning mode to read Bluetooth® advertising signals of nearby BLE devices or beaconing signals from tag or chip devices, which may occur at a periodic interval (such as 2 seconds). After a scanning period, the strongest signal strength value (RSSI) may be selected as belonging to the associated tool.

In various examples, RSSI allows the wireless communication controller 266 of the battery pack to measure the strength of the radio signal received from a nearly BLE device and assign a value in decibels per milliwatts (dBm) to the device accordingly. Based on this value, the wireless communication controller 266 may estimate the relative distance of the BLE devices and select the one that is closest as being the one belonging to a tool that is coupled to the battery pack. Alternatively, the wireless communication controller 266 may use Time-of-Flight (ToF), which measured the distance to the nearby BLE devices based on the time it takes for a signal to travel between the two devices. The wireless communication controller 266 may additionally and/or alternatively use channel sounding to identify the power tool BLE device. Sound channeling refers to a protocol that utilizes ToF and phase-based ranging behavior to more accurately estimate the distance between two BLE devices. In yet another and/or additional embodiment, the wireless communication controller 266 may utilize a Round-Time (RTT) protocol, which measures the time for a signal to be transmitted to a BLE device and for an associated response to be received from the BLE device and estimates the distance between the two devices accordingly. It should be noted that the methods and protocols described here can be referred to herein, individually or collectively, as “wireless range estimation.”

The association is now applied to the operational and performance data records since initial detection. If no wireless device within a predetermined distance is detected based on a wireless range threshold, the battery pack may detect that the tool includes no wireless capability. The wireless range threshold refers to a preset threshold above which the detected device is unlikely to be coupled to the battery pack. For example, if the wireless range estimation is made based on RSSI, the wireless range threshold may designate a preset value above which the strength of the signal is indicative of a distance of greater than, e.g., 30 cm between the two BLE devices. In that case, the battery pack associates the operational and performance data records with no power tool. If the detected wireless device is a BLE module, battery pack may detect a unique ID of the power tool included in the advertising signals and associates the operational and performance data records with the power tool ID. If the detected wireless device is a tag or chip device, the battery pack may detect a unique ID of the tag or chip device and associates the operational and performance data records with the tag or chip ID. On a predetermined frequency, the signal strength detection may be repeated to confirm or reassign the association. After a period of inactivity or when charging is detected, the battery may reenter the inactive state. In the inactive state, the battery pack of the present disclosure may perform beaconing on the periodic interval.

In some examples, the battery pack 60 may wirelessly receive tool operational data such as trigger pull and release data, or tool input current profiles, from the power tool. For example, the power tool controller may measure a current draw from the battery pack, and the tool wireless communication module may transmit the current measurement to the wireless communication controller 266 of the battery pack. Similarly, timestamped trigger pull and release events may be transmitted. In some embodiments, the battery management controller 262 may use the received tool data, alone or in combination with one of the aforementioned wireless range estimation techniques (i.e., RSSI, ToF, sound channeling, and RTT), to detect the tool that the battery pack 60 is coupled to. The battery management controller 262 may compare the received trigger pull and release events, or the current profile of the power tool, to a measure of current discharge from the battery cells of the battery pack. For example, if the trigger pull and release timing, or the power tool current measurements, substantially match or exhibits similar behavior or characteristics as the discharge profile of the battery pack, the battery management controller 262 can deduce that the power tool is coupled with the battery pack 60. This technique may be combined with the aforementioned wireless range estimation techniques to better detect the mounted power tool.

As previously noted, the battery pack 60 may be provided with an IMU device 270. In some embodiments, the battery management controller 262 may additionally use IMU data in combination with one of the aforementioned wireless range estimation techniques (i.e., RSSI, ToF, sound channeling, and RTT), and/or in combination with tool operational data, to detect the tool that the battery pack 60 is coupled to. In another example, the battery management controller 262 may detect movement of the battery pack 60 via the IMU device 270. If the distance to a first BLE device as measured by wireless range estimation remains steady while the battery pack is in motion, battery management controller 262 can determine that the first BLE device is associated with the tool that the battery pack 60 is coupled to. By contrast, if the distance to a second BLE device as measured by wireless range estimation changes as the battery pack is in motion, battery management controller 262 can determine that the second BLE device is not associated with the tool that the battery pack 60 is coupled to.

In a further and/or alternative example, the battery management controller 262 may measure a vibration profile or vibration level of the battery pack from the IMU data. The power tool controller may similarly measure a vibration profile or vibration level of the power tool from an IMU mounted within the power tool. The power tool wireless communication module may transmit the detected tool vibration profile and/or vibration level to the wireless communication controller 266 of the battery pack. If the battery management controller 262 determines that the power tool vibration profile and/or vibration level substantially matches, or exhibits similar behavior or characteristics as, the battery pack vibration profile and/or vibration level, it can deduce that the power tool is coupled with the battery pack 60.

In yet another example, the battery management controller 262 may wirelessly receive tool operational data such as trigger pull and release data, or tool input current profiles, from the power tool, and compared the tool operating data against its own vibration profile or vibration level as detected by the battery pack IMU device. For example, if the trigger pull and release timing, or the current profile of the power tool, substantially aligns with a vibration profile detected by the battery pack IM, the battery management controller 262 can detect that the power tool transmitting the data is the one that the battery pack 60 is coupled to.

### Types of Recorded Data

To collect data, in some examples, the battery pack may be configured to record its own operational and performance data on a “bucketized” basis of values derived from the fundamental measurement values. Specifically, the battery management controller 262 of the battery pack may be configured to store a cumulative count of one or more of data sets related to occurrences of events (e.g., events of battery temperature exceeding a threshold, events of discharge current exceeding a threshold, cumulative discharge runtime, etc.) and transmit the cumulative count periodically to a gateway. In an embodiment, the cumulative count may be reset upon transmission of the data. Table 1 below provides an example list of cumulative data that may be collected and stored by the battery pack on its own operational and performance relating to general battery operation, discharge characteristics, and charge characteristics.

TABLE 1

| | |
|---|---|
| General Data | Total Usage Time in Temperature Buckets: <4 C, <50 C, <75 C, >75 C |
| | Short Circuit Events |
| Discharge Data | Total Discharge Time in Current Buckets: <20 A, <40 A, <60 A, >60 A |
| | Total Discharge Runtime |
| | Triggers Pull Events Count (based on current draw from the battery) |
| | Inferred Interruptions in Current Draw Count |
| | Total Application Times in Buckets: <30 s, <60 s, <120 s, >120 s; |
| | Discharge Shutdown Faults Count |
| | Undervoltage Shutdowns Count (each cell); |
| | Hot Battery Pack Condition Events Count |
| | Cold Battery Pack Condition Events Count |
| | Battery Pack Overcurrent Shutdown Events Count |
| | FET Over-Temperature Events Count |
| Charge Data | Charge Shutdown Events Count |
| | 2nd Level Overvoltage Events Count |
| | Hot Battery Pack Condition Events Count |
| | Cold Battery Pack Condition Events Count |
| | Charging Overcurrent Shutdown Events Count |
| | Charge Cycles in State-of-Charge Buckets: <5%, <25%, <50%, <75% |
| | Charge Rate Times in Buckets ≤2 A, ≤4 A, ≤6 A, ≤8 A, ≤12 A, ≥12 A |
| | Charge Complete Count |
| | Incomplete Charge Cycles Count |
| | Cell Balancing Data |

In an embodiment, in addition to cumulative data, the battery management controller 262 may provide and transmit real time or static data related to the battery pack. This may include, for example, AC Impedance, DC Impedance, electrochemical impedance spectroscopy (EIS), State of Health, % of original capacity, lifetime charge delivery (coulomb count), and state of life, cell imbalance. Some of these require a stimulus to generate in addition to measuring a voltage or current threshold. These data may be obtained directly by measuring either the cell tap voltages, the internal battery thermistor or current measurement derived from the internal fuse.

In some examples, the time interval for any datalog involving measuring total time in a certain bucket may be set to a constant interval, such as 200 ms.

In an embodiment, for each parameter described above, the battery pack may keep a log of the occurrence of each event in addition to or instead of the cumulative count described above. For example, in addition to or instead of a total count of the total number of power tool operation events (e.g., trigger pull events as detected based on battery discharge current), the battery pack may store and wirelessly transmit a timestamped datalog of the power tool operation events. In another example, the battery pack may keep a full datalog of every battery pack fault condition. These datalogs may be periodically wirelessly transmitted to the remote server via a gateway.

In addition to battery pack operational and performance data, the battery pack is configured to receive power tool operational and performance data from the power tool and periodically transmit said data to the remote server via a gateway. For power tools 10, as discussed above, the data comms terminal may also be used to transmit tool-specific operational and performance data. This transmission may occur, for example, after every trigger release event, after every trigger pull event, at set periodic time intervals, etc. The transmission of data may continue even if the event of a subsequent trigger pull. Alternatively, if the transmission is interrupted by a trigger pull during these communications, the battery pack may handle the interruption (e.g. throw away data). The tool specific information may be adjusted according to the transmitted Product Type Index (PTI) product code. In an embodiment, the power tool may transmit to the battery pack a cumulative count of certain categories of power tool operational and performance data. The transmitted information may be limited to fields not captured by the battery itself. For example, since the battery pack is capable of detecting and track a count of trigger pull and trigger release events, in an embodiment, the data transmitted to the battery pack from the power tool may exclude the trigger pull and release events. Alternatively, all power tool data is transmitted to the battery pack and consolidated with battery pack data. For example, the power tool trigger pull and release events may be consolidated with the trigger pull and release events as detected by the battery pack into a single log. Like battery data discussed above, the tool data may be cumulative data (e.g., count or log of events since the last transmission), real time data, or static tool data. Table 2 below includes an example list of data sets transmitted to the battery pack from the power tool via the data comm terminal and recorded by the battery pack for later transmission to the remote server via a gateway:

TABLE 2

| | |
|---|---|
| Tool Data | Trigger Pull Events in Forward Count |
| | Trigger Pull Events in Reverse Count |
| | Trigger Release Events Count |
| | Tool Mode Selection Data |
| | Clutch Setting Data |
| | Hot Module Shutdown Events Count |
| | Gyro Shutdowns (e.g., Kickback Condition) Count |
| | Motor Overs-peed Events Count |
| | Motor Under-speed Events Count |
| | Current Overload Count |
| | Locked Rotor Condition Count |
| | E-clutch Count |

These data points may be measured by the motor control module either directly via sensors (e.g., trigger pulls, mode switch, gyro shutdowns), or indirectly/calculated via other sensors such as motor speed (e.g., via hall sensors).

In an embodiment, in addition to or instead of a cumulative and static data, the power tool may transmit a timestamped log of the operational and performance data. For example, in addition to or instead of a count of the total number of power tool operation events (e.g., trigger pull events) from the power tool, or it may receive a full timestamped datalog of the power tool trigger pull events from the power tool. The battery pack may calculate the cumulative count of the event (e.g., trigger pull events) based on the received datalog and transmit that information to the remote server.

As noted, the data described above is transmitted from the tool 10 to the battery pack 60 via the data comms terminal. It should be noted, however, that for a tool (e.g., tool 20) that does not include a dedicated data comms terminal, similar data (or at least a subset of the data types listed above) may be transmitted to the battery pack 60 wirelessly.

In some embodiments, the battery pack may receive charger data from the charger 65, either wireless or via battery terminal. This data may include, but is not limited to, number of battery pack insertions, charge fault information, number of complete charges, total charging time, total time spent balancing battery cells, etc. This information may be further packaged with other data transmitted from the battery pack 60.

In some examples, the battery pack may also associate each type of data described above with the one or more of the following associations:

In a further embodiment, the battery pack may keep and transmit a cumulative historical record all discharge and charge values including:

The current software version with a time stamp of when it was last updated (such as record tool software version and a timestamp for when it was last updated);

The timestamp of when the battery was last enabled and disabled (such as enable and disable status, total number of times enabled or disabled, and a timestamp for the last enable or disable event); and

A record associated to one or more tools kept on a periodic basis of both time and utilization with the battery in its active state. For example, a record is created every 15 minutes of use. It may also be advantageous to do a record based on certain state of charge (SOC) thresholds or Watt-hours consumed for improved resolution of the data. Each bucketized record may include a timestamp from the RTC as well as the serial number and PTI code of the associated asset.

### Data Categorization and Prioritization

In some embodiments, the power tool 10 and/or power tool 20 may be configured to categorize the data in accordance with priority, importance, or safety, and transmit certain categories of data to the battery pack while transmitting certain categories of data directly to the gateway 70 or 80 for direct transmission to the backend centralized server 90. For example, referring to FIGS. 1 and 3, the wireless controller 252 power tool 10 and/or 20 may opt to send data relating to shutdown events, kickback events, gyro shutdown event, overcurrent events, or any other safety and/or user protection event, wirelessly to the backend centralized server 90, without involvement by the battery pack 60. Other data types, such as those related to runtime, trigger engagement, etc. may be transmitted from the motor controller 230 to the battery pack 60, either via a data comms terminal or via the wireless controller 242. In another example, the power tool 10 and/or 20 may opt to send the aforementioned safety and/or user protection data to both the battery pack 60 and the backend centralized server 90, while other types of data are only transmitted through the battery pack 60.

In some embodiments, the battery pack 60 may be configured to categorize the data received from the power tool 10 and/or power tool 20 in accordance to priority, important, or safety. Referring to FIG. 10A, the raw data received from the power tool may be stored in the memory 264. Upon or receipt, the battery management controller 262 may analyze the raw data to identify a safety event associated with the power tool 10 and/or power tool 20. This safety event may be, for example, a tool shutdown due to an overcurrent condition, a kickback, an over-temperature condition, etc. Based on the detection of the safety event associated with the power tool, the battery management controller 262 may prioritize the offload of the data received from the power tool 10 and/or power tool 20. This may be done by moving the data associated with the present power tool in the memory 264 offload queue. Alternatively, this may be done by moving the data related to the safety event up in the memory 264 offload queue.

The battery pack 50 may similarly categorize the data offload, which may include the power tool data and/or the battery pack data, in accordance with detection of safety and/or user protection events based on the battery pack sensors such as the thermistor 260 or the IMU 272. For example, if the battery management controller 262 detects a kickback event (i.e., where the IMU data indicates a sudden rotation of the battery pack), a battery pack fall (i.e., where the battery pack accelerates along a single axis), or similar safety events, it can prioritize transmission of its own data and/or the data most recently received from the associated power tool.

In an embodiment, the battery management controller 262 may set a flag in the battery pack connectable advertisement signal, which will be described later, so a nearby gateway device knows that important data is available for offloading. In this manner, the datalog associated with the power tool or battery safety event, including for example a timestamped datalog including the exact time of the safety event and associated operational parameters, is transmitted from the battery pack to the cloud as quickly as possible, which allows the backend server 90 to generate a prompt for a site manager indicative of the safety event.

In an embodiment, the battery management controller 262 may be configured to offload certain types of data such as data related to safety and/or user protection events only during a tool operation, i.e., during the time battery cells are being discharged, or for as long as a vibration is detected via the IM, or within a set time after the completion of the tool operation. In an example, the battery management controller 262 may be configured to transmit all other data during an idle mode of the battery pack. This ensures that safety related data is transmitted as quickly as possible, while other data transmission is deprioritized for later transmission.

### Gateway Examples

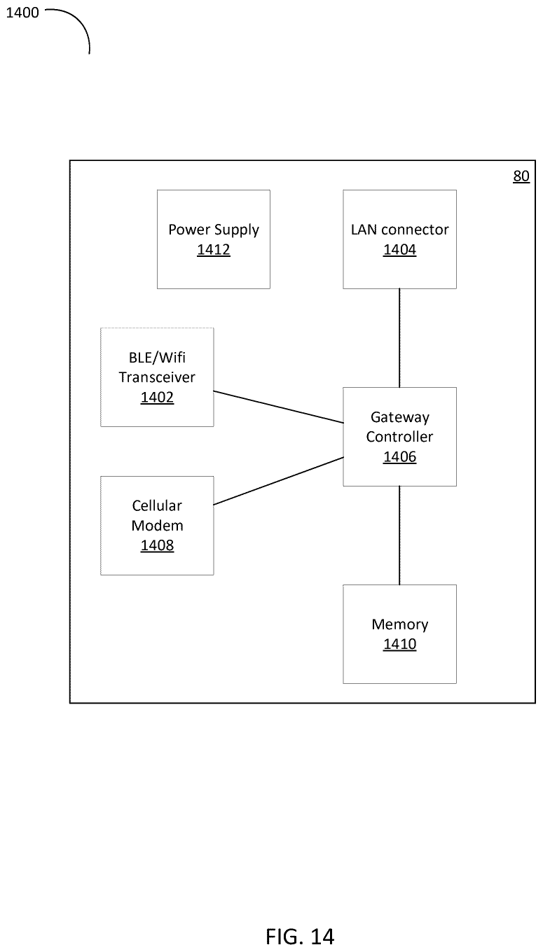

Referring to FIG. 14, illustration 1400 provides a block diagram of an example gateway 80 (see FIG. 1) that is configured to interface with one or more power tools, such as power tool 10 or 20. The gateway may provide wired or wireless connection to a power tool and provide a communication link between the power tool and a backend server. The gateway may allow a power tool to offload its data that may be processed by the backend server. Once the data is offloaded, the power tool may then be able to clear its memory to keep collecting more data thereafter.

In illustration 1400, the gateway 80 may include a gateway controller 1406. The controller may include the circuitry and processing for controlling the operations in the other components described herein. The gateway controller 1406 may be coupled to multiple connection ports for receiving and transmitting data, such as a BLE/Wifi transceiver 1402, a LAN connector 1404, and a cellular modem 1408. The BLE/wifi transceiver 1402 may be configured to receive Bluetooth® and/or wifi signals from power tools capable of sending such signals. The LAN connector 1404 may provide a wired data connection to the gateway, such as to a charging station to a power tool that is also capable of transferring data from the power tool while it is charging. The LAN connector may also provide a wired connection to a cloud network and ultimately to a backend server. The cellular modem 1408 may provide cellular transmission capabilities, in some cases to a power tool with such capabilities and also in other cases to a backend server. A power supply 1412 is present in the gateway 80 to provide power to all of the components as needed.

In a construction site, gateway 80 devices may be placed in various locations to detect advertisement signals broadcasted by various powered devices such as power tools and battery packs. A mobile phone including an appropriate mobile app may similarly act as a gateway and be configured to detect advertisement signals broadcasted by various powered devices. In this disclosure, it should be understood that in this disclosure, a gateway device or a gateway may include a physical gateway device or a mobile app configured as a gateway.

In some embodiments, the gateway 80 may be configured to scan only advertisement signals that belong to a specific power tool and/or battery pack manufacturer. For example, the gateway 80 may be configured to scan advertisement signals only from DeWalt® branded products and transmit the data from only those advertisement signals to the back-end remote server. This may be done by filtering the advertisement signals where the COMPANY ID field matches a pre-set ID that matches the manufacturer. Alternatively, the gateway 80 may review a manufacturer-specific list of services included in the advertisement signal to make this determination. List of services, as will be described later, is a field included in the advertisement signals and may include manufacturer-specific services. The gateway 80 may compare the list of services to a pre-set list of services associated with the manufacturer, and transmit the data from only those advertisement signals with matching list of services to the back-end remote server.

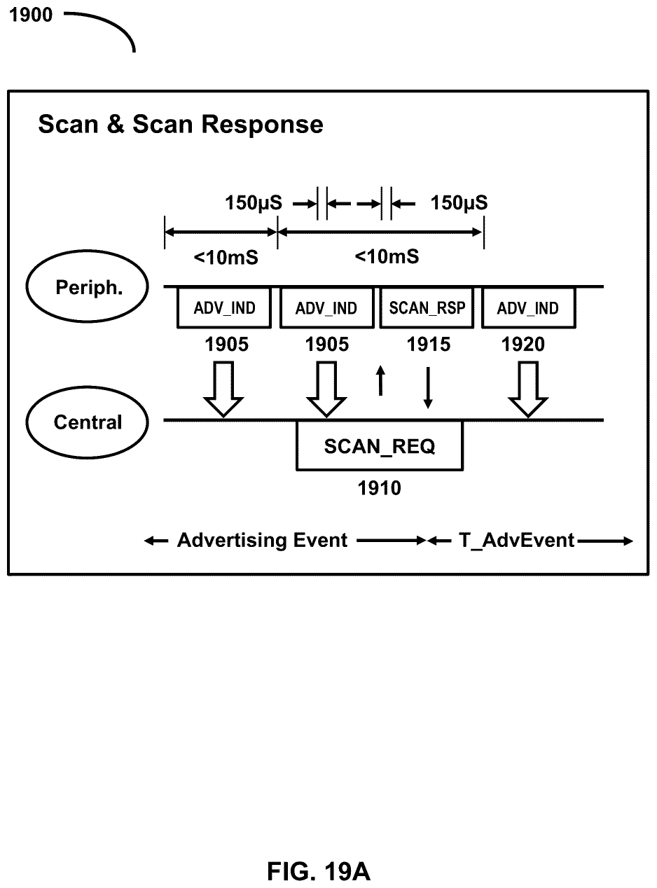

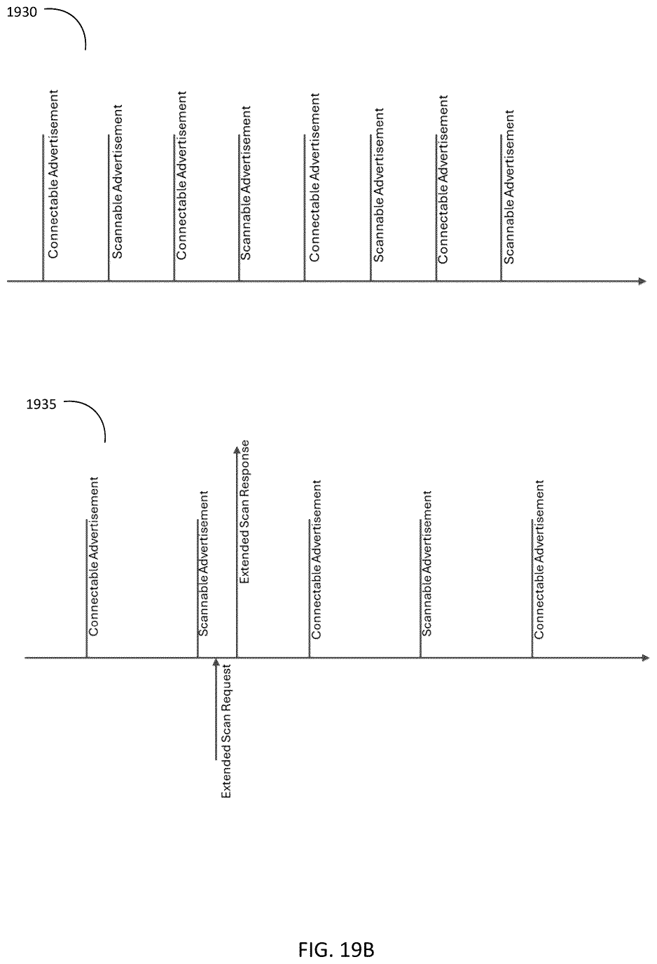

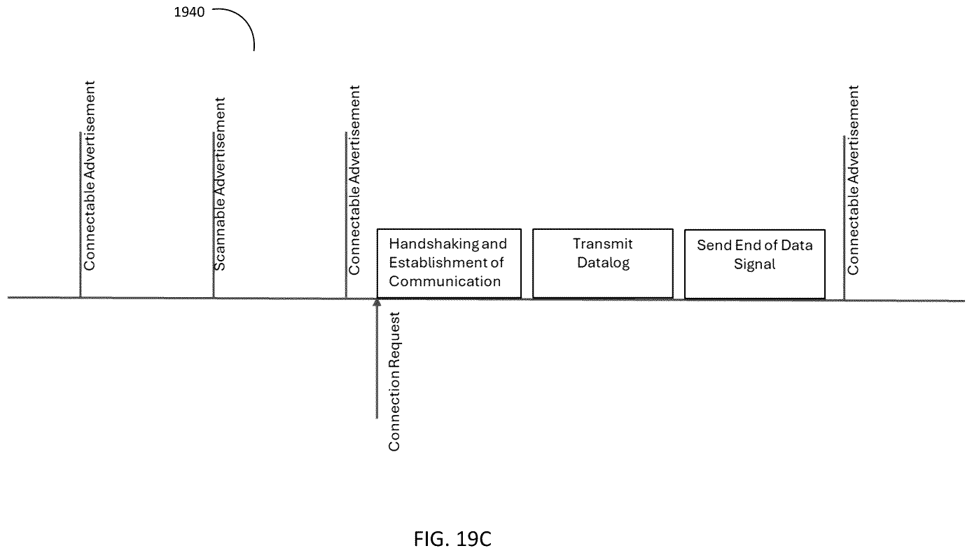

As will be discussed with respect to FIGS. 19A-19C, the BLEM of a power tool and/or battery pack may receive an extended scan request and/or a two-way connection request from a gateway. Described in this section are some algorithmic details about how a gateway may decide when and whether to transmit the extended scan request and/or the two-way connection request with a BLEM of either a power tool or battery pack, according to some embodiments.

As will be discussed more in FIGS. 19A-19C, the advertising signal can be “connectable advertising,” meaning it is ready to make a two-way connection, or “extended advertising,” meaning that it is utilizing the Extended Scan Response to broadcast more data as described above. When the advertising signal is a connectable advertising signal, one of the datapoints in the advertising signal is a Data Load signal, which is the amount of datalog that it has available for offloading. For example, the Data Load signal is it set to 0 if there is little datalog for offloading, to 1 is the datalog is at 25% of its max, to 2 if the datalog is at 50% of its max, and to 3 if the datalog is set to 75% of its max. In some embodiments, the Data Load signal is a set of bits located in the “BLE Status Information” field found in each of the example data formats of Tables 3 through 6, below.

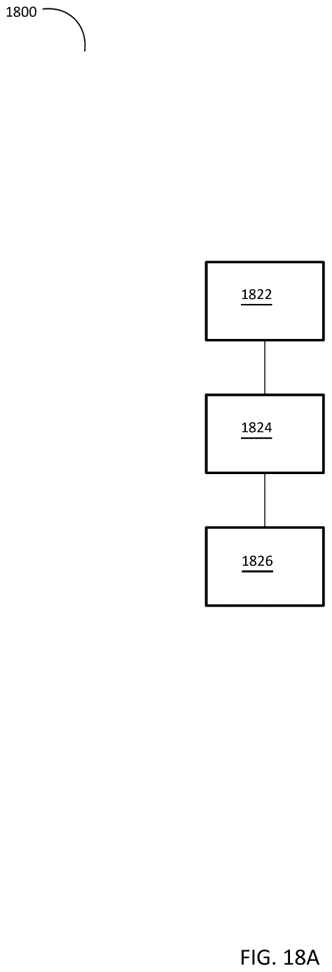

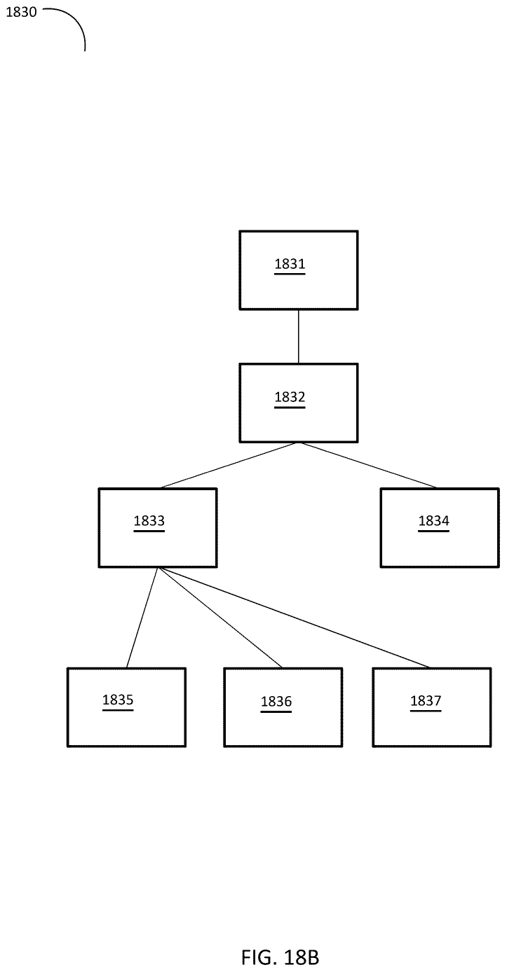

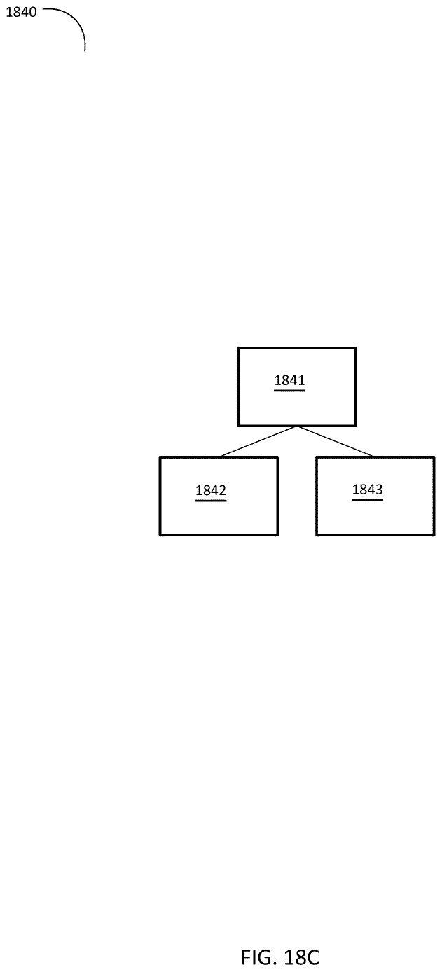

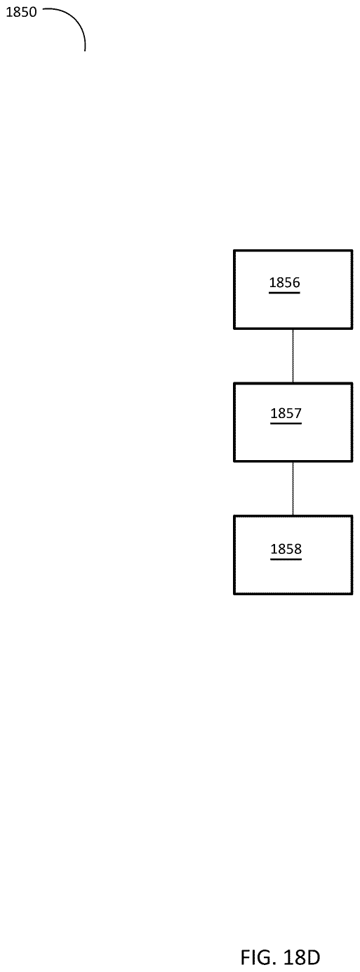

The two-way communication link with the BLEM is initiated by the central (gateway) device. When the BLEM is within the range of the central device and the central device receives the connectable advertising signal, it examines the value of the Data Load signal. In some embodiments, if this Data Load signal is set to 0 or 1, it does not make a two-way connection to the BLEM. However, if the Data Load signal is set to 2 or 3, it sends a connection request to the BLEM to initiate a handshaking and authentication protocol and establish a two-way connection with the BLEM. The BLEM then proceeds to offload all the timestamped datalog to the central device, as described above. As mentioned above, once data transmission is complete, the gateway detects that no more data is being transmitted. If no data is transmitted within a predetermined amount of time, or if the BLEM communicates a signal indicating that it has no more data to send, the gateway terminates the communication link. This is consistent with the descriptions related to FIG. 18C, below.

In other examples, the gateway may decide to establish the two-way connection with the BLEM using the Data Load signal and additional data. A combination of the Data Load signal and how pressing a need there may be to offload the data from the device may be determined by the gateway. For example, the gateway may also monitor the signal strength of the connection with the device. If the signal strength is low or weak, the gateway may not initiate a datalog transfer unless the Data Load signal indicates a nearly full memory of the device. On the other hand, if the signal strength is high or strong, the gateway may initiate the datalog transfer even if Data Load signal is 0 or 1, to take advantage of the signal strength in the anticipation that the device may not have a strong signal strength to the gateway later on. As another example, for multiple devices within range of a gateway that have equal values of their Data Load signal, the gateway may prioritize offloading the datalogs of those devices with strong signal strength indicators. This tactic may be used by the gateway to prioritize devices that have stronger chances of not losing signal while performing the datalog offloading process.

### Data Storage Management

In some examples, the wireless module may be configured to offload the collected data to a centralized data system via the gateway 70 or 80. For example, a battery pack may go 2 weeks without transmission of the data. Assuming 100% operation over a 10-hour workday, a 6 day work week, and record interval of 15 minutes, this would lead to approximately 500 records of all bucketized values. Any critical events may be logged immediately instead of waiting for the period update. The battery pack may include enough memory to hold 1000 records of all bucketized values, in some examples. In other examples the pack may only hold 500 records, which may lead to deletion of records and the generation of new records to indicate the data loss. The battery pack or power tool may offload its data to the gateway in accordance with the descriptions of FIG. 14, for example. The gateway may then transmit the data to the centralized data system for future processing.

Upon success of transmission of the collected data to a recording device such as a mobile app or gateway connected to the centralized data system, the tool specific records may be expunged, retaining the cumulative pack discharge and charge history and the last recorded tool dataset. In some examples, a timestamp may be generated of the expunging event.

If the number of records exceeds memory size, in some examples, that data be thrown away on a first in-first out basis, with the exception that the very last record always be preserved as a marker of the starting state of the datalog, thereby capturing the gap in the data record and for matching to the dataset stored in the centralized database. Additionally, a new record indicating the amount of data that has been thrown away, the range of dates, and the tools that are associated with the deletion, may be used to generate a new record to indicate what data has been expunged.

### Battery Pack Advertising and Communications

A battery pack of the present disclosures may perform various advertising of itself and communications in order to connect to a Central device such as a gateway. In some examples, the battery pack may use BLE 5. For example, the communications may utilize the long-range methods provided in the BLE 5 standard by using the Coded PHY Layer (Coded S2 or S8) for the radio.

On request from a BLE Control device, the battery pack may enter a communication mode where the entirety of the datalog is transmitted to the Central device. Upon successful transmission, the battery pack may expunge its record, retaining the cumulative pack discharge and charge history and the last recorded tool dataset.

When the battery pack is operating as a Peripheral, it may beacon a primary advertising payload on an interval of 2 seconds. This primary advertising payload may have summary usage data encoded in the last 10 bytes of the 31 bytes payload, as an example. The battery pack may also transmit an extended advertising transmission, for which when a corresponding request is received, will send an additional payload, such as 254 bytes, with coded utilization information. The definition of the payload values may be specified by the centralized data system.

### Whitelist

In some examples, a user may select that a battery only operates with a select set of tools, such as those belonging to a specific assignment of a worker or place. This may be specified through the centralized data system, for example, while in other cases this specification may be made at a localized level proximate to a collection of battery packs, say at a construction site. The battery pack(s) may receive this Whitelist of tools from the mobile app or gateway and store the list in memory. If in Whitelist mode, the battery may compare the attached tool's MAC address or communicated serial number to the reference list as it transitions from its inactive to active state. If the attached tool is not on the list, the battery may disable and may flash its SOC LEDs indicating a fault. In some examples, a tool may run initially while the Whitelist authentication takes place and then cease function if not authenticated. An override command may be provided to ignore the Whitelist that can be sent by the centralized data system app and gateway. In some examples, a similar Blacklist of unapproved tools for the battery to work with may be provided as additional functionality.

### Enable/Disable Functionality

In some examples, the battery pack of the present disclosures may be able to be enabled and disabled singly or in a group. For example, a mobile app or centralized data system gateway may send a signal to multiple battery packs that are selected based on some specified selection criteria, such as serial numbers affected by a recall or serial numbers known to be used at a particular construction site. This disabling may happen when the battery is in the inactive state or in the active state after the trigger has been released. In other cases, the Enable/disable command may come from a paired communication with the app or via a scan response command.

In some examples, the battery pack may be able to receive from the paired communication specific times on which to enable and disable the battery based on its real time clock (RTC).

### Example System Implementations

In some examples, the battery pack may rely on a single BLE/BMS microcontroller unit (MCU), external flash integrated circuit (IC), and an RTC. The MCU, flash, and RTC may also be integrated into a single IC, according to some embodiments. The following are some example implantation details of the battery pack:
The MCU may interface with both flash IC and RTC on a periodic basis. It may also interface with one or both of them related to events generated by the pack or tool. Comms interfaces can be selected by the developer;
The RTC is always powered once the battery is assembled to maintain accurate timing;
In one practical implementation, the flash IC needs to be powered only when a read/write operation is taking place, though this is not always required;
BMS portion of the MCU handles collection and storage of all battery pack data;
BLE portion of the MCU handles recalling and transferring the battery pack data to an external device.

In some examples, as previously discussed with reference to FIG. 10B, the battery pack includes two microcontrollers, one microcontroller (e.g., battery management controller 262) to collect and store all battery and tool datalogs (called the BMS MCU) and one controller (e.g., BLE controller 266) to transfer the data to the cloud (called the BLE MCU). Below are example specifications for this system:
BMS-to-BLE communication will be accomplished using Serial Peripheral Interface (SPI) if desired;
BMS collects and records general battery information using an array of counters stored in memory 264 (EEPROM or flash equivalent);
BMS collects, records, and timestamps all application specific information, both from the tool and the battery;
BMS stores all timestamped data separately in flash IC (memory 264 or another memory unit not shown);
BMS communicates with the memory 264 via SPI;
When BLE comes in range of a gateway, it reads blocks of data unless actively in a tool application (TH Pulse Int Pin);
BLE purges blocks of data upon successful transfer and upload receipt.
   Interactions with Centralized Data System

### Datalog Processing

In some examples, the centralized data system platform may be responsible for processing the transmitted battery pack datalogs for providing reporting and insights. In an example of these insights, a battery pack record may show that the battery or tool has been unutilized for a period for an assignment whereas another assignment has batteries and tools being overutilized, prompting a reallocation of those assets. In another example, a battery pack record may indicate that battery associated with a grinder is experiencing high levels of hot packing, prompting an upgrade of the user from a higher power solution.

### Connected Reconciliation

In addition to batteries of the present disclosure, a range of tools may have internal connectivity and their own datalogging. For example, some power tools may possess internal connectivity capability. The battery pack may be configured to accept a reconciliation between its data recording capabilities and that of an internal power tool, with coordination made by the centralized data system.

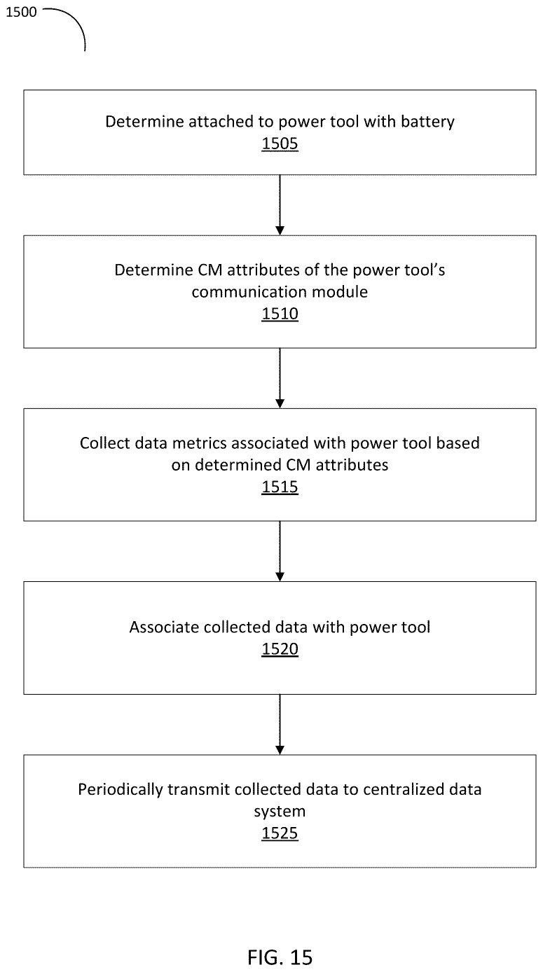

Referring to FIG. 15, flowchart 1500 provides an example methodology of a battery pack of the present disclosures for associating itself with a power tool and collecting various data metrics depending on a level of connectivity capable with the power tool, according to some aspects of the present disclosure. An example of the battery pack and power tool capable of performing this methodology is shown in FIG. 1, such as tools 10 and 20 and battery pack 60, along with the example structures shown in FIGS. 2-14.

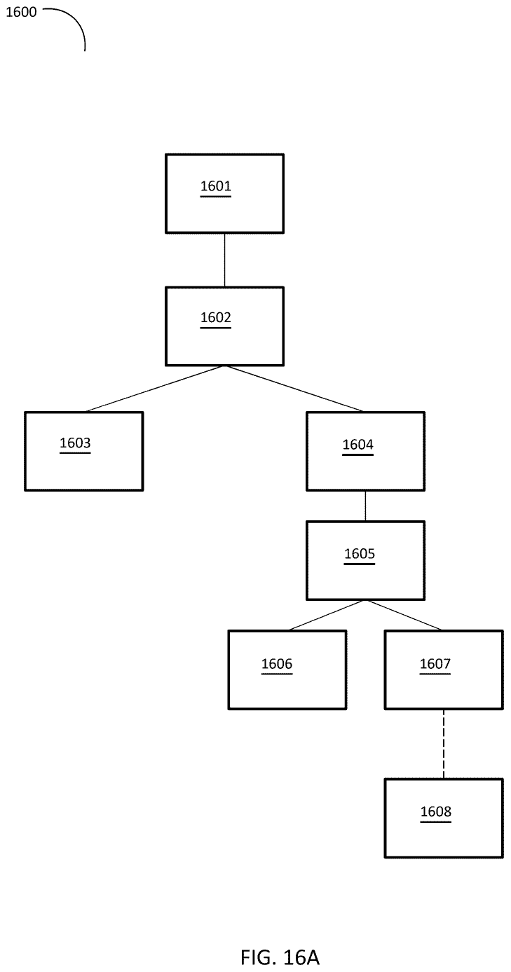

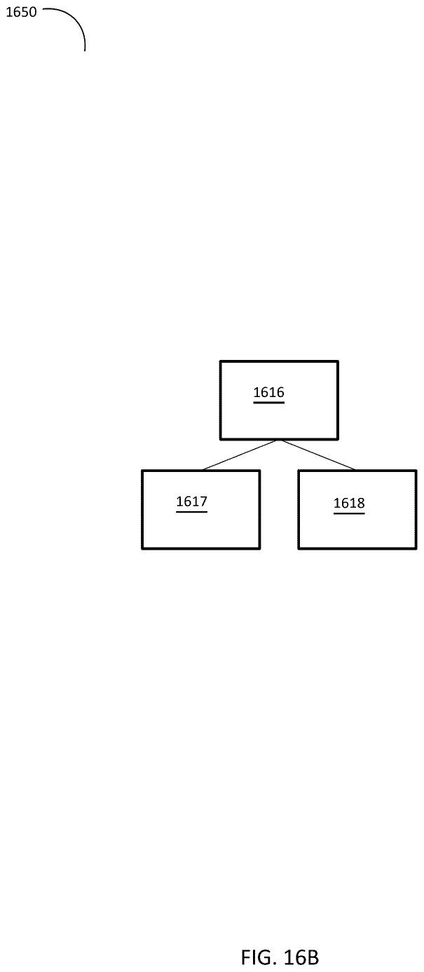

At 1505, the battery pack may be physically connected to the power tool but still needs to determine that it is communicatively attached to the power tool. The battery pack may not be communicatively attached to the power tool when the battery pack has established a connection with the communication module associated with the power tool. FIG. 16A depicts an exemplary expanded flowchart 1600 for operation 1505. In operation 1505, the battery may conduct this determination by first attempting to communicate directly to the power tool via a dedicated communication interface. At 1601, a command can be sent from the battery via its communication interface and can, at 1602, await a fixed period of time for a response. If a response is detected, at 1603, it can be assumed that the connected power tool is capable of data connectivity via the comm terminal of the battery pack and the battery pack will then know to request and accept tool data on subsequent trigger pulls. If no response is detected on the dedicated communication line, then, at 1604, the battery can assume the power tool attached does not have physical data connectivity and will then go to step two and switch to central mode and, at 1605, scan for any advertising devices. If a BLE advertisement is detected, at 1606, the battery will read the advertisement data from the communication module with the strongest wireless range estimation. As previously described, the BLE advertisement may be received from the BLEM module of a power tool, or as a beaconing signal from a tag or chip device mounted on a power tool. The battery pack determines, based on a unique ID included in the advertisement signal, whether the transmitting device is a power tool BLEM module or a tag or chip device. If the battery does not detect an advertisement signal, the battery pack may perform, at 1607, one or more secondary determinations to identify the power tool it is attached to. For example, the battery pack may receive a signal from the power tool indicative of a unique ID of the power tool. Alternatively, the battery pack may identify a category of the power tool (e.g., impact driver v. nailer v. saw) based on a profile of current draw from the battery pack. In an example, if the current draw includes high current peaks of short duration, the battery pack may detect that the power tool is a nailer. If nothing is detected, the battery pack can, for example at 1608, default to logging its own usage information in association with no specific power tool and transmitting it to a central device on a periodic basis.

Referring back to FIG. 15, at 1510, having determined that the battery pack is now linked to a particular power tool, the battery pack may then determine the CM attributes of the communication module associated with the power tool. Knowing the CM attributes may then determine the types and amounts of data metrics that can be collected from the power tool. For example, a first category of CM attributes may be that the power tool has no communication module (such as BLEM or tag or chip) at all. The battery pack may be able to collect only a first level of data metrics from the battery pack itself, such as information derived from the battery pack's electrical usage tied to using the power tool. In this case, this may be a basic level of data. As another example, a second category of CM attributes may be that the power tool has a communication module that includes a tag or chip installed or attached that will allow the battery pack to collect a second level of data metrics. As another example, a third category of CM attributes may be that the power tool includes an early generation BLE module that provides a partial amount of connectivity, allowing the battery pack to collect more data than if the power tool had only a tag or chip installed, but not the full data metrics. As another example, a fourth category of CM attributes may be that the power tool includes a BLEM with full functionality, allowing the battery pack to collect a comprehensive array of data metrics.

At 1515, the battery pack of the present disclosure may collect data metrics associated with the power tool based on the determined CM attributes. In some examples, the battery pack of the present disclosure may be capable of collecting four different levels of data metrics, depending on the CM attributes present with the communication module of the power tool. FIG. 16B depicts an exemplary expanded flowchart 1650 for operation 1515. For example, the battery pack can determine, at 1616, whether it is coupled to a power tool provided with a tag or chip. If so, at 1617, then the battery pack will be able to collect, for example, inventory management and tool tracking only. On the other hand, if the battery pack has determined that it is coupled to a power tool with a BLEM with full functionality, then the battery pack will be able to, at 1618, collect the following data, for example: tool location data, data for the ability to control the tool (enable/disable & customization), aggregate tool operational data (runtime, trigger pulls, shutdown), enhanced tool data (predictive analytics, warranty tracking, etc.), and real time clock for advanced safety analytics. Furthermore, if the battery pack is coupled to a power tool that communicates with the battery pack via a data comms terminal, the battery pack may be able to collect a timestamped datalog of tool events in addition to, or instead of, the aggregate tool operational data.

Referring back to FIG. 15, at 1520, along with collecting various types of data, the battery pack may also be configured to associate the battery pack operational and performance data with the particular power tool operational and performance data. This association may be performed in the battery pack and stored in a memory of the battery pack. In some cases, the identification of the power tool may be obtained from a unique identifier stored in the power tool or an accessory physically attached to the power tool. In some examples, the battery pack may retrieve a MAC address of the BLEM and may associate all data metric collections with the MAC address. In other cases, a unique serial number associated with each BLEM of each power tool may be used instead. In some examples, if the power tool lacks a BLEM or a tag or chip, the battery pack may collect its own operational and performance data and associate it with an unidentified tool. All data collected from the power tool or tag or chip device may be consolidated with the battery pack operational and performance data in association with the tool ID or MAC address associated with the power tool.

At 1525, the battery pack may be configured to transmit the consolidated data to a centralized data system. This may be performed by periodically transmitting a beacon containing cumulative data, or by an external device establishing a direct connection that allows for receipt acknowledgement from the centralized data system. In some cases, this connection may occur in response to a beacon periodically sent by the battery pack that determines whether the battery pack is within range of transmission to the centralized data system. In other cases, the battery pack may only offload data based on proximity to an external device or after having been removed from use in a power tool.

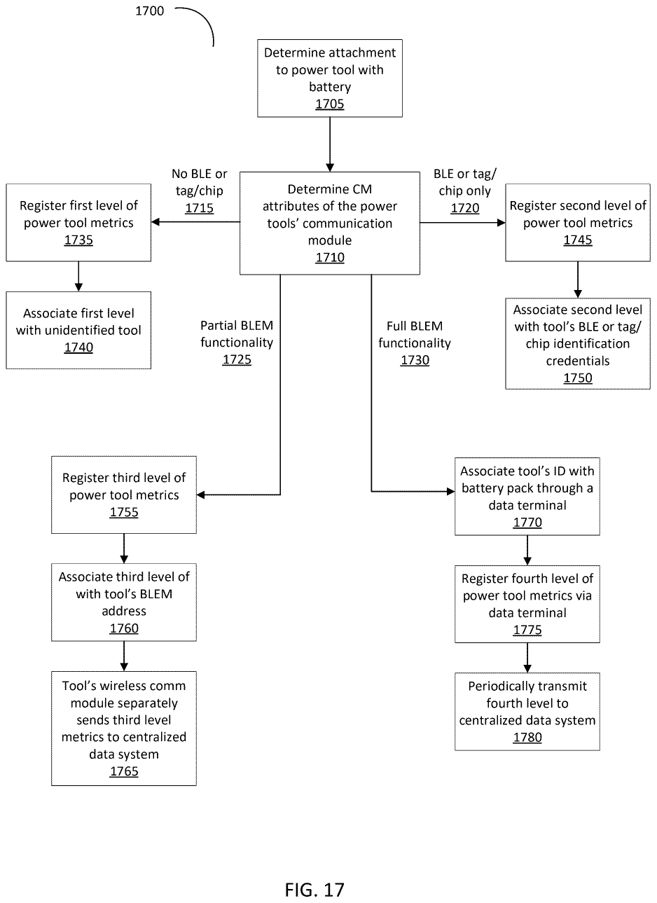

Referring to FIG. 17, flowchart 1700 provides a more detailed description of how a battery pack of the present disclosures successfully connects and collects data from various power tools that possess varying communication modules with different types of CM attributes.

At 1705, the battery pack may first determine that it is electrically attached to a power tool. The battery pack may rely on power draw to determine that it is being used and therefore is connected to a power tool. In some cases, the battery pack may additionally or alternatively determine that it is communicatively attached to the communication module of the power tool, if any. For example, the battery pack may rely on a wireless signal indicator that communicates with the communication module of the power tool, consistent with descriptions above.

At 1710, the battery pack may then determine the CM attributes of the communication module associated with the connected power tool. In some cases, the battery pack is configured to register at least four different levels of data metrics depending on the CM attributes detected. The battery pack may perform this check using an algorithm and controlled by a PCB that may rely on switching functionality.

At 1715, the battery pack may determine that the CM attributes are that the power tool is a conventional power tool with no Bluetooth Low Energy (BLE) functionality or a tag or chip present. This can occur when no BLE advertisement within proper distance (e.g., 6 inches) is detected via wireless range estimation. Some embodiments may store battery data alone. In some embodiments, can tag battery data to indicate no associated tool information was detected.

Alternatively, at 1720, the battery pack may determine that the CM attributes are that the power tool is a conventional power tool that is provided with BLE functionality or a tag or chip present. FIG. 18A depicts an exemplary expanded flowchart 1800 for operation 1720. For example, the battery pack can, at 1822, send advertisement signals including location data at a period interval, e.g., every two seconds. The battery pack, at 1824, can convert to act as a central device and scans for advertising signals and uses wireless range estimation (e.g., RSSI, ToF, sound channeling, or RTT, as previously described) to determine what tag/chip is closest to it. At 1826, the battery pack can read advertising data (USN/MAC address) from that tag/chip.

In an embodiment, wireless range estimation is only calculated at the time of insertion. In an embodiment, this determination may be confirmed at every trigger pull, or periodically, or trigger release.

Battery pack may provide an indication to the back-end that the chip/tag reading was inferred based on wireless range estimation, and not definitively determined.

In an embodiment, the battery pack can associate collected battery data with USN/MAC of the nearest peripheral (i.e., the tag/chip). In an embodiment, it packages the USN/MAC with the battery pack data. It can keep track of several (e.g., 10, 20, 30, etc.) different peripheral devices in this manner.

In another embodiment, a tag/chip can be equipped with a gyroscope and/or accelerometer. Positional data from gyro/accelerometer is packaged within the tag/chip and transmitted as a part of the advertising data (i.e., directly or using ESR protocol) which can be detected by the connected battery and associated to the battery data. Alternatively, the battery pack makes a BLE connection with the tag/chip to obtain the positional data.

Returning to FIG. 17, alternatively, at 1725, the battery pack may determine that the CM attributes are that the power tool possesses a BLEM with partial BLE functionality.

Alternatively, at 1730, the battery pack may determine that the CM attributes are that the power tool possesses a BLEM with full BLE functionality. In some embodiments, the power tool can include a BLEM module that is capable of sending full tool data directly to the gateway/mobile phone. Additionally, it may have a dedicated Data Comm terminal that connects to the Data Comms terminal of the battery pack. FIG. 18B depicts an exemplary expanded flowchart 1830 for operation 1730. As shown, the power tool may have the ability to differentiate between a connected battery pack and a non-connected or conventional battery pack. To do this, the power tool can detect, at 1831, if the battery pack has a Data Comm terminal. At 1832, the power tool can send a signal through the Data Comms terminal. If the battery responds, at 1833, it is detected as a connected battery pack. In some implementations, the signal may be sent when the battery pack is first coupled to the tool, and the battery is registered as a connected battery pack until it is disconnected, or the register is overwritten via a subsequent pack. Alternatively, the signal may be sent after each trigger pull. There are alternatives where this could be done on trigger release, timing thresholds, etc. In an alternative embodiment, the battery sends a signal to the tool via the Data Comms terminal indicating that it is ready to receive data. This signal may be sent upon connection to the tool or after every trigger pull.

If the tool does not have Data comms or if the battery is detected as non-connected, at 1834, the tool can send data to its own BLEM module. The power tool BLEM can, for example, stamp the data with tool ID information, timestamp the data, delete the data based on priority or filter, may store that data in memory, etc.

The BLEM module may hold up to multiple days/weeks of data in memory and the memory can be within the module processor or external to the module processor. The BLEM module may update cumulative counters that are kept in memory. If data is not transmitted wirelessly, it may delete certain types of data. Such deletion can occur periodically such as after the expiration of two weeks, two days, etc. This deletion could also occur relative to the memory storage remaining, such as when a certain percentage full.

The deletion could be commanded externally, and may include retaining/expunging only certain types of data such as retaining some number of last records stored such as retaining information that is deemed of higher priority or importance, such as safety events retaining or expunging expunge certain record of a certain type or that match a filter. This deletion of data may generate new types of data such as timestamped record that 100 records were deleted that spanned a specified period of time (to communicate that such a deletion occurred).

If battery is detected as connected, the tool uses the Data Comms terminal to transfer its data to the battery pack. In one implementation, at 1835, data can be transmitted only to the battery pack. The battery can receive a unique Tool ID upon connection to the tool or at every trigger press or release. A full suite of unique tool data is transmitted via the Data Comms terminal to the battery. Data that is transmitted may be for the lifetime of the tool, since the last data upload (e.g., since the last data upload to a battery pack, or since the last data upload to either a pack or a central device), or for a pre-determined amount of time or pre-set number of usages or trigger pulls. Data may be transferred at trigger press, the conclusion of every trigger release event, a period of time after a trigger release event, periodically during tool operation (between trigger press and release), or periodically independent of trigger press/release.

In another implementation, at 1836, data can be transmitted to the battery pack and to the tool BLEM where it will be continued to be stored in each location until it is offloaded wirelessly from each device respectively.

In a further implementation, at 1837, a first sub-section of the data can be transmitted to the battery pack and a second sub-section of the data can be sent to the tool BLEM. For example, tool operating data while using the specific battery pack can be transmitted to the battery pack, while other data is retained and transmitted to the tool BLEM. As another example, certain types of data (e.g., trigger pulls, hot module shutdowns, current overloads) are transmitted to the battery pack, while other types of data (e.g., gyro shutdown, mode selection, etc.) are retained and sent to the tool BLEM. In yet another example, the aggregate tool operational data (e.g., total number of trigger pulls, hot module shutdowns, current overloads, etc.) may be transmitted to one of the battery pack or the tool BLEM, while a timestamped log of events corresponding to the same operational data (e.g., timestamped log of trigger pull events, module shutdown events, current overload events, etc.) is transmitted to the other of the battery pack or the tool BLEM. Timing of data transmission bay be based on data type, with some more important types of data transmitted earlier and less important types transmitted later. Operation data for a specific data type could be sent to the battery pack, like from one trigger to another. Meanwhile, overall system level stats could be sent to the BLEM module.

If the battery pack is connected to a conventional tool with no BLE tag or chip, at 1735, the battery pack may register a first level of power tool data metrics. This may include a basic level of data that can be collected inferentially from the power tool, along with battery pack metrics that the battery pack is capable of recording on its own. This may include, for example, battery pack and current measurements, the battery pack location and/or GPS data, the battery pack IMU data, etc.

FIG. 18C depicts an exemplary expanded flowchart 1840 for operation 1735. This depicts a process for obtaining examples of data that can be inferred when the battery is connected, at 1841, to a conventional tool with no BLE Tag or Chip. These processes can include obtaining, at 1842, tool runtime; inferred from the time current starts flowing through the pack current shunt to the time the current stops flowing, at 1843, trigger pulls; counted as the number of times current stops/starts flowing through the battery current shunt, various battery pack shutdowns (over voltage, under voltage, hot pack, cold pack) determined by direct measurement of battery sensors or via internal AFE device, etc. However, since there are no identifying characteristics known to the battery pack as to which type of tool it is connected to, the battery cannot associate the data to any particular device.

At 1740, the battery pack may associate the first level of data metrics with an unidentified power tool, since its identity is unknown digitally.

If the battery pack is connected to a conventional tool with a BLE or tag or chip, at 1745, the battery pack may register a second level of power tool data metrics. This may include a basic level of data that can be collected inferentially from the power tool, along with data that can be transmitted using the BLE or tag or chip, along with battery pack metrics that the battery pack is capable of recording on its own. At 1750, the battery pack may associate the second level of data with the power tool's BLE or tag/chip identification credentials. In some cases, this identification may also be saved in the centralized data system, and the battery pack may draw that information or cross-check from the centralized data system.

As an example, if the battery pack detects a nearby DEWALT ToolConnect® Tag (DCE045) within close very close proximity (determined via wireless range estimation) that is advertising itself as a DCD792 Compact Drill, then the battery can “tag” or associate any data collected during operation to this particular product in the Site Manager inventory system as opposed to a generic tool.

If the battery pack is connected to a power tool with partial BLEM functionality, at 1655, the battery pack may register a third level of power tool data metrics. This may include a basic level of data that can be collected inferentially from the power tool, additional data that is provided by the BLEM with partial functionality, along with battery pack metrics that the battery pack is capable of recording on its own. In one embodiment, battery pack collects data from the BLEM module of the power tool the same way it collects data from tag/chip described above. In an embodiment, the BLEM sends location data (along with some other data, e.g., trigger pulls, trigger releases, etc.) as a part of its advertisement signals. This data is picked up by the battery pack as described above. Such implementations may be implemented using Extended Scan response (ESR).

FIG. 18D depicts an exemplary expanded flowchart 1850 for operation 1755. In an embodiment, at 1856, the power tool is identified as the closest peripheral using wireless range estimation. In an embodiment, wireless range estimation may be used to identify a candidate. The tool advertisement signal may additionally include additional data (e.g., data that indicates whether it is currently running, runtime, or other operating data). That data is used in conjunction with wireless range estimation to identify the tool. At 1857, the battery pack may provide indication to the back-end that the chip/tag reading was inferred based on wireless range estimation, and not definitively determined. At 1858, the power tool BLEM can send its data to the remote server independently of any data picked up by the battery pack. The battery pack can package tool data obtained from advertisement signals with its own battery data.

As another embodiment, the battery pack may establish a BLE link with the tool and download data from it wirelessly. This may be done via, for example, wireless range estimation such as RSSI or ToF. The power tool may transfer all data to the battery pack and delete it from storage. Alternatively, the power tool may transfer to the battery pack only the data that relates to tool operation using the battery pack (e.g., after trigger release). The power tool may still be configured to send its data to the remote server as well as the battery pack. The battery pack may also send battery data to the remote server.

At 1760, the battery pack may associate the third level of data with the power tool's BLEM MAC address. In some cases, at 1765 the BLEM may be capable of separately sending the third level metrics to the centralized data system.

If the battery pack is connected to a power tool with full BLEM functionality, at 1770, the battery pack may register a fourth level of power tool metrics. This may include a basic level of data that can be collected inferentially from the power tool, additional data that is provided by the BLEM with full data collection functionality, along with battery pack metrics that the battery pack is capable of recording on its own. At 1775, the battery pack may associate the fourth level of data with the power tool's serial number and PTI using a terminal provided by the power tool. In this case, the tool may provide data directly to the pack. In some cases, at 1780, the tool's wireless communication module may be capable of transmitting the fourth level metrics to the centralized data system directly.

Some examples of data that can be detected and logged when the battery is connected to a conventional tool with either partial or full BLEM functionality include the ability to associate data to a specific tool such as a DCD792 with MAC address 00:11:22:33:44 or serial number ABCDEFG. Specific data that can be collected include: details on any tool shutdowns triggered by the tool itself (as opposed to shutdowns detected by the battery alone) such as watch dog resets, motor stall shutdowns, overspeed/underspeed shutdowns. Also, additional tool specific information can be logged such as: motor speed, trigger positions, mode select options, LED information etc.

Referring to FIGS. 19A, 19B, and 19C, shown are example diagrams of message protocols that may be followed by one or more embodiments of the present disclosure. In FIG. 19A, illustration 1900 provides an example message protocol diagram between a peripheral device, such as a power tool, and a central device, such as a battery pack or a gateway that is connected to a backend server. This example diagram describes an example message exchange between a peripheral device and a central device and what kinds of data is transmitted. To start, a peripheral device may transmit an advertising indicator signal 1905. The signal may be a broadcast so that any central device may receive the signal. In other cases, the advertising indicator 1905 may be a periodic signal transmitted to a targeted central device, such as a battery pack that the power tool is connected to. In the other cases, the central device may be a gateway with wireless access to a backend server, and the periodic signal may broadcast an unencrypted signal out on a construction site to any gateway in the vicinity. The advertising indicator signal 1805 may include some operating data about the power tool. In some embodiments, the advertising signals may include only battery data (e.g., pack temp, time in discharge, runtime, etc.), tool data, or a portion of each. An example of the message format of the advertising signal is shown in Table 3.

TABLE 3
An Example Connectable Advertising Message Format in Power Tool
ADVERTISEMENT SIGNAL (TOOL)

| Portion | CONTENT |
|---|---|
| Protocol Header | DATA LENGTH |
| | DATA LOAD |
| | DATA TYPE |
| Advertisement | COMPANY ID |
| Data | UNIQUE IDENTIFIER (MAC ADDRESS/SERIAL NUMBER) |
| | WIRELESS BLE MODULE/CELL TEMPERATURE |
| | BLE STATUS INFORMATION |
| | PRODUCT TYPE IDENTIFICATION |
| | TOOL STATUS |
| | TOTAL TRIGGER PULLS |
| | TOTAL RUNTIME |
| | TOTAL TIME SPEND IN VARIABLE SPEED MODE |
| | TOTAL TIME SPEND IN LED ONLY MODE |
| | LAST SHUTDOWN STATUS 1 |
| | . . . |
| | LAST SHUTDOWN STATUS N |
| | TIME SPENT IN PACK TYPE |
| | TOTAL TIME SPENT IN MODE/OPERATING STATE |
| | CURRENT MODE/OPERATING STATE |
| | COIN CELL CHARGE STATUS |
| | SKU SPECIFIC DATA |

By way of example only, the data fields in Table 3 may represent certain types of data. The advertisement message format includes a protocol header that includes information relating to the advertisement message. For example, the “data length” field in the header may represent the total length of the connectable advertisement signal that may be consistent with BLE message standards. The “data type” field may indicate what type of data is being transmitted, such as a scannable advertisement signal, connectable advertisement signal, or extended scan response. The “data load” field, which is included in a connectable advertisement signal, indicates how much data (i.e., full timestamped datalog of the power tool operating data) is saved in the memory and is ready for transmission in a connectable state. As mentioned above, the “data load” value may be referenced by the gateway to determine whether to initiate a two-way connection to offload the data.

In some examples, the protocol header and/or the advertisement data may further include a list of services. The list of services is embedded in the BLE advertisement protocol, where each service can have an ID associated with them. The list of services is maintained by the Bluetooth Special Interest Group (SIG) and includes generic portions available to all users and assignable portions that the SIG can assign to specific users. Such users may include, e.g., a manufacturer of a product, a customer, on owner, etc. In some embodiments, parts of the list of services are thus utilized with pre-set values pre-assigned to a manufacturer, a customer/owner (i.e., customized to identify customers/owners of a worksite or a construction company), etc., based on one or more valued included in the list of services.

The advertisement message format further includes advertisement data relating to operation and/or performance of the power tool. The field of the exemplary advertisement data are described here by way of example.

The “company ID” field may identify a manufacturer of the power tool. The “unique identifier” field may be the unique identifier of the tool, either as a MAC address or a serial number.

The “wireless BLE module/cell temperature” field may represent broadly a category of fields that list a set of temperatures of the wireless communication module. This may include temperature at a most recent time the signal was generated, temperature values of each thermistor cell, and/or temperature based on the worst-case location in the tool. In some embodiments, the advertisement signal will provide more granular information that subdivides these fields separately.

The “BLE status information” field may represent broadly a category of fields that lists status information about the wireless communication module. For example, these fields may include status about the flash memory indicating how full the memory is, which may also include the data load status indicator. It may also include strength of signal information to a closest gateway. It may also include status indicators that can allow for error codes for any subcomponents to explain their status. The “product type identification” field may represent what type of tool this advertisement message comes from. There may be multiple categories of types of tools, each designated with some code or value.

The “tool status” field may provide codes or values of how the tool is functioning at present, the shutdown status of the previous operation (i.e., whether the shutdown was normal or due to a fault condition), if there are any error codes, etc. The “total trigger pulls” field may represent a monotonically increasing counter of a total number of trigger pulls, including counting any partial, full, or variable trigger pulls, assuming the tool is capable of such operations. The “total runtime” field may similarly represent a monotonically increasing counter of how long the tool has been performing active actions, in some time unit like seconds. For some tools, there may be a “total time spend in variable speed mode” for tools that allow for operation in variable speeds, say by responding to a degree of how much the trigger is pulled. Similarly, for some tools, there may be a “total time spend in LED only mode” for tools that allow for a trigger to turn on a work light only, say with just a minimal pull of the trigger. The LED light mode allows the tool to act as a flashlight.

The “last shutdown status 1” may indicate the last status of the tool during its last shutdown procedure. It may include just a code or value that has a specific meaning that can be referred to in the tool's manual, for example. There may be multiple fields of these shutdown statuses, on down to the “last shutdown status ‘N’” for the status of when the tool shutdown for the Nth to last time. This field is a list of the last N shutdown conditions that have occurred, and the list is updated anytime a new shutdown condition occurs. For example, “last shutdown status 1” may indicate a kickback condition, and “shutdown status 2” may indicate a locked rotor condition. When a new condition (e.g., over-temperature) occurs, the previous two shutdown conditions move respectively to shutdown statuses 2 and 3, and “shutdown status 1” is overwritten to indicate the newly detected shutdown condition.

The “time spent in pack type” field may provide a broad category of an array of fields, where each field lists the amount of time the tool is in different packs. For example, there may be a 1P pack, a 2P pack, and so on, so each pack type may be listed in this array and each field represents how much time the tool is in that particular pack type. Similarly, the “total time spent in mode/operating state” may represent a broad category of an array of fields about each mode or operating state that the tool could be used in. The “current mode/operating state” may represent a field for a single code or value to reveal what mode or state the tool is in at the time that advertising signal was generated.

The “coin cell charge status” signal may be a binary value indicating when the state of charge and/or the voltage level of the coin cell is below a threshold. In an example, the “coin cell charge status” may be a two-bit signal that can additionally indicate whether the coin cell voltage has been or has not been read. The SKU Specific Data may include data that is unique and particular to the particular tool SKU.

In addition, U.S. Pat. No. 11,095,193, which is incorporated herein by reference, provides examples of a power tool with a power module. The module temperature can be obtained via a thermistor mounted on the circuit board proximate the power switches and provides example implementation details about how various sensor data can be obtained in the power tool that could be therefore provided into these example scannable signals described in Tables 3 and 4.

A central device may receive and record the information in the signal 1905 but still may not send any response after just one of these signals. The peripheral device may continue to send the advertising signal 1905 on a periodic basis. In other cases, the peripheral device may send an updated advertising signal 1905 only when some data in the advertising indicator signal 1905 changes, such as an increase in the number of total trigger pulls. When the central device receives a second or subsequent advertising indicator signal 1905, the central device may then reply back with a scan request signal 1910. The central device may send this scan request signal 1910 based on determining that certain types of data need updating in its records. For example, the central device may request more information that it did not have before that would be contained in an extended scan response signal 1915.

The advertising signal 1905 of the power tool may include, in the header, an indication that it is “scannable.” The advertising signal 1905 may be scanned by the gateway (or another central device), which may be configured to scan either passively or actively. If the scan is passive, then the scannable indication in the advertising header is ignored. If the scan is active, the gateway pack sends a scan request 1910 in response to reception of the scannable advertisement back to the tool. After the peripheral device 1905 receives the scan request signal 1910 from the central device, the peripheral device may send a second message with an extended message format, sometimes referred to as an extended scan response (ESR). The peripheral device then sends the scan response in response to the scan request made by the central. The length of the scan response can be adjusted using the Extended Scan Response advertisement protocol to include operational information. In addition, in some embodiments, some portion of the ESR may be encrypted. An example of the message format of the ESR is shown in Table 4.

TABLE 4
Example Message Format of Extended Scan Response in Power Tool
EXTENDED SCAN RESPONSE (TOOL)

| Portion | CONTENT |
|---|---|
| Protocol Header | DATA LENGTH |
| | DATA TYPE |
| Advertisement | COMPANY ID |
| Data | UNIQUE IDENTIFIER (MAC ADDRESS/SERIAL NUMBER) |
| | WIRELESS BLE MODULE/CELL TEMPERATURE |
| | BLE STATUS INFORMATION |
| | PRODUCT TYPE IDENTIFICATION |
| | TOOL STATUS |
| | TOTAL TRIGGER PULLS |
| | TOTAL RUNTIME |
| | TOTAL TIME SPEND IN VARIABLE SPEED MODE |
| | TOTAL TIME SPEND IN LED ONLY MODE |
| | LAST SHUTDOWN STATUS 1 |
| | . . . |
| | LAST SHUTDOWN STATUS N |
| | TIME SPENT IN PACK TYPE |
| | TOTAL TIME SPENT IN MODE/OPERATING STATE |
| | CURRENT MODE/OPERATING STATE |
| | COIN CELL CHARGE STATUS |
| | SKU SPECIFIC DATA |
| Additional | APPLICATION IN LENGTH ZONE |
| Extended Scan | AUXILIARY MODULE SHUTDOWN REASON COUNT |
| Response Data | VARIABLE SPEED TIME |
| | MODULE TEMP GREEN TIME |
| | TIME PACK TEMP IN ZONE |
| | TIME MODULE TEMP IN ZONE |
| | TIME SPENT IN CURRENT ZONE |
| | PACK VOLTAGE |
| | TRIGGER PULLS (FWD) |
| | TRIGGER PULLS (REV) |
| | COIN CELL SOC/VOLTAGE |
| | SHUTDOWN REASON COUNT |

By way of example only, the data fields in Table 4 may represent other certain types of data that are provided by the power tool wireless communication device in response to receive of an Extended Scan Request. The fields in the header and advertisement data may be similar or identical to those described in Table 3. The fields in the additional Extended Scan Response data are supplementary to the header and advertisement data and are only included in the Extended Scan Response.

Referring to the additional data shown in Table 4, the “application in length zone” field may represent an array of fields that describes how long the tool has been operating in a particular application. The “auxiliary module shutdown reason count” may provide additional data from an auxiliary module, such as a gyro that attaches to the tool. There may be some reason that the auxiliary module has a shutdown, and this may be recorded in this field.

The “variable speed time” may represent the cumulative time that the tool was operating in a variable speed mode, rather than a max speed mode. Similarly, the “module temp green time,” “time pack temp in zone,” “time module temp in zone,” and “time spent in current zone” fields represent cumulative times of the tool spent in these different categories.

The “pack voltage” field may represent the value of the current voltage of the battery pack that the tool is connected to. The “trigger pulls (fwd)” field may represent one of a subdivision of types of trigger pull counts. Here, it may represent a total amount of trigger pulls in the forward direction, while “trigger pulls (rev)” may represent a total amount of trigger pulls for an action in the reverse direction. As a last example for the information in the extended scan response, the “shutdown reason count” may represent an array of the reasons for why the tool had been shut down, and the counts of each of those reasons.

In some embodiments, the central device may send the scan request 1910 automatically or as a matter of routine after receiving a predetermined number of advertising indicator signals 1905. In other cases, the central device may send the scan request 1910 only after analyzing data in the advertising indicator signal 1905 and determining a need to receive more data from the ESR. For example, because the advertising indicator signal 1905 includes a field for total number of trigger pulls, the central device may determine that the total number of trigger pulls has changed from one received signal 1905 to another. This may indicate that the power tool has performed new actions, and therefore the central device now may want to receive an update to previous information contained in the ESR. Similarly, as the advertising indicator 1905 includes other status information, such as total runtime, tool status, time spent in a certain mode, and last shutdown, the central device may send a scan request 1910 after determining that any one of these data fields has changed.

The battery pack may also act as the peripheral device in the case of the battery pack transmitting data to a gateway and ultimately to a backend server. The backend server or a gateway will act as the central device in this case. The battery pack and central device would similarly engage in the message exchange of illustration 1900. The types of data and message format may be different, however. For example, Table 5 shows an example message format of an advertising indicator signal 1905 sent from a battery pack.

TABLE 5
Example Message Format of Advertising Signal from Battery Pack
ADVERTISEMENT SIGNAL (BATTERY PACK)

| Portion | CONTENT |
|---|---|
| Protocol Header | DATA LENGTH |
| | DATA LOAD |
| | DATA TYPE |
| Advertisement | COMPANY ID |
| Data | UNIQUE IDENTIFIER (MAC ADDRESS/SERIAL NUMBER) |
| | WIRELESS BLE MODULE/CELL TEMPERATURE |
| | BLE STATUS INFORMATION |
| | PRODUCT TYPE IDENTIFICATION |
| | STACK VOLTAGE |
| | PACK STATUS INFORMATION |
| | HOTPACK COUNT |
| | COLDPACK COUNT |
| | FET FAULT COUNT |
| | HOT PACK CHARGER COUNT |
| | COLD PACK CHARGER COUNT |
| | PACK STATE OF CHARGE |
| | UNDER-VOLTAGE FAULT COUNT |
| | OVER-VOLTAGE FAULT COUNT |
| | OVER-CURRENT PROTECTION (OCP) FAULT COUNT |
| | TOTAL TIME IN TOOL |
| | SKU SPECIFIC DATA (PACK) |

By way of example only, the data fields in Table 5 may represent certain types of data. The advertisement message format includes a protocol header that includes information relating to the advertisement message, as previously described with reference to the tool advertisement signal. For example, the “data length” field in the header may represent the total length of the connectable advertisement signal that may be consistent with BLE message standards. The “data type” field may indicate what type of data is being transmitted, such as a scannable advertisement signal, connectable advertisement signal, or extended scan response. The “data load” field, which is included in a connectable advertisement signal, indicates how much data (i.e., full timestamped datalog of the battery operating data) is saved in the memory and is ready for transmission in a connectable state. As mentioned above, the “data load” value may be referenced by the gateway to determine whether to initiate a two-way connection to offload the data.

The advertisement message format further includes advertisement data relating to operation and/or performance of the battery pack. Fields such as the company ID, unique identifier, wireless BLE module/cell temperature, BLE status information, and product type identification, are similar to those described with reference to the tool advertisement signal. Battery-specific advertisement data are described here.

The “stack voltage” may represent a voltage of the battery pack at measured at a given number of battery cells. For example, in a battery pack including five cells in series, the stack voltage may represent the voltage of three of the cells. The “pack status information” field may provide a value or code of the status of the battery pack at the time the advertisement signal was generated. The “hotpack count” may represent the number of times the battery pack's temperature exceeded some predetermined threshold. The temperature measurement may be based on one or more temperature sensors located at particular places in the battery pack, such as at each cell or at the location that is typically the hottest region in the battery. This field may therefore be an array of counts, one field for each location that measures temperature. Similarly, the “coldpack count” may represent the number of times the battery pack's temperature fell below a different predetermined threshold, and it may be an array of values similar to what is described for the hotpack count.

The “FET fault count” may represent the number of faults of the FET in the battery pack. The “hot pack charger count” and “cold pack charger” count may represent the number of times the battery pack registered as too hot or too cold, respectively, when the battery pack was charging. These fields may be an array of values, similar to what is described above.

The “pack state of charge” may represent the current state of charge of the battery pack at the time of the communication. The “Under-Voltage fault count” may represent a counter of the number of undervoltage occurrences, while the “Over-Voltage fault count” may represent a counter of the number of overvoltage occurrences. The “Over-Current Protection fault count” may represent the number of over current protection events that have occurred. And “total time in tool” is the amount of time, say in seconds, that the battery pack has been in the current tool or in other cases may be the total time that battery pack has been in all tools it has connected to.

Table 6 shows an example message format of the extended scan response from the battery pack as a result of being sent a scan request from the central device.

TABLE 6
Example Message Format of Extended Scan Response from Battery Pack
EXTENDED SCAN RESPONSE (BATTERY PACK)

| Portion | CONTENT |
|---|---|
| Protocol Header | DATA LENGTH |
| | DATA LOAD |
| | DATA TYPE |
| Advertisement | COMPANY ID |
| Data | UNIQUE IDENTIFIER (MAC ADDRESS/SERIAL NUMBER) |
| | WIRELESS BLE MODULE/CELL TEMPERATURE |
| | BLE STATUS INFORMATION |
| | PRODUCT TYPE IDENTIFICATION |
| | STACK VOLTAGE |
| | PACK STATUS INFORMATION |
| | HOTPACK COUNT |
| | COLDPACK COUNT |
| | FET FAULT COUNT |
| | HOT PACK CHARGER COUNT |
| | COLD PACK CHARGER COUNT |
| | PACK STATE OF CHARGE |
| | UNDER-VOLTAGE FAULT COUNT |
| | OVER-VOLTAGE FAULT COUNT |
| | OVER-CURRENT PROTECTION (OCP) FAULT COUNT |
| | TOTAL TIME IN TOOL |
| | SKU SPECIFIC DATA (PACK) |
| Additional | APPLICATION IN LENGTH ZONE |
| Extended Scan | PACK STATE OF HEALTH |
| Response Data | CHARGE INSERTIONS |
| | CHARGE COMPLETIONS |
| | UNDER-VOLTAGE SHUTDOWN COUNT |
| | CELL 1 FAULT REASON COUNT |
| | . . . |
| | CELL N FAULT REASON COUNT |
| | MANUFACTURING INFORMATION/CONFIGURATION |
| | TIME MODULE CHARGE TEMP IN ZONE |
| | TIME MODULE DISCHARGE TEMP IN ZONE |
| | TIME FET CHARGE TEMP IN ZONE |
| | TIME FET DISCHARGE TEMP IN ZONE |
| | TIME CELLS CHARGE TEMP IN ZONE |
| | TIME CELLS DISCHARGE IN TEMPERATURE ZONE |
| | TOTAL MODULE TIME IN TEMPERATURE ZONE |
| | TOTAL FET TIME IN TEMPERATURE ZONE |
| | TOTAL CELL TIME IN TEMPERATURE ZONE |
| | TOTAL TIME REBALANCING CELLS |
| | CELL REBALANCE CYCLE COUNT |
| | MAX CELL DELTA/IMBALANCE |
| | TOTAL FAULT/SHUTDOWN REASON COUNT |
| | DISCHARGE CYCLES |
| | GEOLOCATION OF LAST EVENT TYPE |
| | STATE OF LIFE |
| | STATE OF POWER |
| | STATE OF POWER HEALTH |
| | TOTAL REMAINING CAPACITY |
| | CELL 1 PRESSURE |
| | . . . |
| | CELL N PRESSURE |
| | BULK PACK PRESSURE |
| | GAS PRESENCE INFORMATION |
| | PACK AC RESISTENCE (ACR) AT FREQUENCY N |

By way of example only, the data fields in Table 4 may represent other certain types of data that are provided by the battery pack wireless communication device in response to receive of an Extended Scan Request. The fields in the header and advertisement data may be similar or identical to those described in Table 5. The fields in the additional Extended Scan Response data are supplementary to the header and advertisement data and are only included in the Extended Scan Response.

Referring to the additional data shown in Table 6 many of the fields should be discernible and apparent to those with skill in the art at least based on the descriptions of the fields. However, of particular note, the “pack state of health” field may represent a programmable field that provides a code or value representing a state of health of the battery. For example, the battery may monitor its own current discharge profile and determine if the battery is discharging more rapidly than it should be compared to a preset profile of expected results. The battery may also determine if it is not charging as it should. If one or more of these events has occurred, a particular value or code can be entered into this field.

The “charge insertions” and “charge completions” may refer to a cumulative count of the number of times the battery pack has been inserted into a charger and the number of times the battery pack has been fully charge, respectively. The “under-voltage shutdown” count may refer to the number of times the battery pack has shut down supply of power to a power tool because of detection of an under-voltage condition.

The cell 1 through cell N fault reason count may include data related to fault conditions and/or count of fault conditions for each cell within the battery pack.

The “manufacturing information/configuration” field may represent some special information that the manufacturer wants to convey that can be looked up or decoded in a user's manual, for example. As an example, US Patents Publication No. 2020/0265283 and US Patent Publication No. 2020/0059170, which are incorporated herein by reference in their entireties, describe anti-theft and point-of-sale activation. A code in this field may indicate whether the device was or was not stolen or activated properly based on a valid purchase. Regarding the fields with various “zones,” these may represent amounts of time that the battery pack is within a specified range having to do with those listed criteria.

The next several data fields in Table 6 relate to temperature measurements, including the FET temperature, the module (e.g., control module) temperature, and/or battery cell temperature. U.S. Pat. No. 11,962,021, which is incorporated herein by reference in its entirety, describes an example of a battery pack including a temperature sensor. In an example, the temperature may be divided into predetermined temperature zones (e.g., 10 to 15 degrees C. as Zone 1, 15 to 20 degrees C. as Zone 2, etc.). The data fields may include the amount of time the FET temperature, the module temperature, and/or battery cell temperature, is within each zone. Further, the data fields may be further broken by the total time in each zone, time in each zone during battery charge, and time in each zone during battery discharge.

The “max cell delta/imbalance” field may represent a value of the imbalance of voltage between cells in the battery pack. U.S. Pat. No. 8,035,343, which is incorporated herein by reference in its entirety, describes an example of a method for balancing cells in a battery pack. The delta may be the largest difference of voltage amongst all cells in the battery pack. The “total time rebalancing cell” refers to the time it takes, during the charging of the battery, to rebalance the cells that were out of balance due to a previous discharge. Specifically, during the battery pack discharge, the voltages of the individual cells fall out of balance below a certain discharge threshold. This field refers to the time it takes for the charger to rebalance the cells. The “cell balance cycle count” refers to the count of start/stop cycles performed by the charger for cell balancing.

The “geolocation of last event type” field may represent a geolocation value of where the last event of a certain type had occurred. Some tools or battery packs may be equipped with or have auxiliary connection to a GPS and/or altimeter to provide such information. This field may be an array or may accompany a particular event field, so there may be multiple of these types of fields tied to each event status field. The “data available information” may represent status changes pertaining to the memory that provided the extended scan response, like the flash memory of the mobile communication module in the battery pack.

The “gas presence information” field may represent a value or code about a detected presence of outgassing or water vapor present in the battery pack. U.S. Pat. No. 9,819,132, which is incorporated herein by reference in its entirety, describes an example of a battery pack, or an adaptor coupled to a battery pack, including a gas or vapor sensor.

The “pack AC Resistance at frequency N” field may represent the alternating current resistance in the complex domain at a certain frequency pertaining to the battery pack. The “pack DC Resistance” similarly may represent the DC resistance of the battery pack. In addition, U.S. Pat. No. 11,936,228, which is incorporated herein by reference in its entirety, describes AC impedance and DC impedance in a battery pack and provides example implementation details about what kinds of information may be obtainable from a battery pack that persons of skill in the art could readily conceive could be provided in one or more of these Tables 3, 4, 5, or 6.

The additional data may further include state of life of the battery pack, which may be determined as the remaining estimated life of the battery pack; the state of power and/or power health of the battery pack; the total remaining capacity of the battery pack, which may be determined as a function of the state of charge of the battery pack and indicate how much capacity it has left for the given charge and/or for the life of the battery; and a measurement of pressure for each cell of the battery pack and for the battery pack as a whole.

In FIGS. 19B and 19C, illustrations 1930, 1935, and 1940 provide another example message protocol that may be used in some embodiments. This example message protocol may be implemented by both a power tool and a battery pack that separately collect their own data in their own BLEM module and need to transmit the data from the BLEM to a gateway or an app. In illustration 1930, the BLEM module of either a power tool or a battery pack may continuously advertise a beacon signal including its own identifier and related information. The advertising signal includes a connectable advertisement signal and a scannable advertisement signal, which in this example are broadcast alternatingly at set intervals (e.g., every 2 seconds). In each power tool, the advertisement signal may include a unique ID (i.e., MAC address of the tool BLEM), a first set of tool status/operation data including certain status information (e.g., tool status, coin cell voltage, last shutdown), and a first set of tool cumulative data (e.g., total number of trigger pulls, total runtime, etc.). The advertisement signal of the battery pack BLEM similarly may include a first set of battery status/operation data including certain status information relating to the battery or charger (e.g., pack status, pack voltage, cell temperature), and a first set of battery cumulative data (e.g., total hot-pack count, total cold-pack count, total number of faults, total time in tool, etc.). Examples of these advertising messages are shown in Tables 3 and 5, above. In some embodiments, the content of the data in the scannable advertisement signal is the same as the content of the data in the connectable advertisement signal. Alternatively, the connectable advertisement may include less content.

Referring to illustration 1935, the BLEM of either a power tool or a battery pack may utilize an Extended Scan Response to broadcast additional information, similar to what is described in FIG. 19A. An Extended Scan Response allows a BLEM module to broadcast additional information once a receipt confirmation of the initial adverting signal is received by a central (gateway) device. The receipt confirmation also indicates that the BLEM module knows that a central device is within range, without having to establish a two-way connection with the central device. In some embodiments, in response to receipt of a scannable advertisement signal, a gateway device sends an Extended Scan request to the BLEM, an example of which is shown in illustration 1935. The timing of receiving the Extended Scan request may be such that the peripheral device receives the request before sending the next connectable advertisement signal. In response, the BLEM sends an Extended Scan Response signal, which includes additional data. The Extended Scan Response signal may be injected between the advertisement signals and before sending the next Connectable Advertisement signal, as shown in illustration 1935.

For a power tool, the Extended Scan Response signal may include a second set of tool status/operation data and a second set of tool cumulative data, e.g., application time, auxiliary module shutdown count, variable speed time, module temperature, number of trigger pulls and releases, etc. For a battery pack, the BLEM Extended Scan Response signal similarly may include a second set of battery status/operation data and a second set of cumulative battery data, e.g., charge insertions, FET discharge temp, total fault count, remaining capacity, etc. Examples of these Extended Scan Response data may be found in Tables 4 and 6, above.

Referring to FIG. 19C, illustration 1940 shows an example response in the message protocol to the connectable advertisement signal, according to some embodiments. The BLEM module of either the power tool or the battery pack may establish a two-way connection with a central device, such as a gateway. Specifically, in response to a Connectable Advertisement Signal, the gateway (central) device initiates a request to connect. The BLEM and central may exchange handshaking and authentication information and establish a communication link. The connection request may differ from the extended scan request in that a two-way connection being made between the BLEM and the gateway may allow for a larger transmission of data. For example, the BLEM module may send the entire timestamped datalog to the gateway for transmission to a backend server. Whereas the advertising data includes mere cumulative counts of events (e.g., total fault count), the timestamped datalog that is transmitted after a connection request includes a full log of all events with the data and time since the last data transmission took place.

Once data transmission is complete, the gateway may end connection in one of two ways. In one example, if no data is transmitted within a predetermined amount of time, or in a second example if the BLEM communicates a signal indicating that it has no more data to send, the gateway terminates the communication link. On the tool side, the data log is reset, and the BLE resumes transmitting advertisement signals.

In some embodiments, the BLEM may continue to send the scannable advertisement signal while the connectable advertisement signal was responded to and a connection request was received by the gateway. The data transmission during the two-way connection may last longer than the period between sending subsequent scannable advertisement signals, and the data in an extended scan response message may contain different data presented in a different form compared to the datalogs that are being transmitted during the two-way connection. On the other hand, in other embodiments, the broadcast of the connectable advertisement and the scannable advertisement signals may be halted while the transmission of the datalogs is underway and until the two-way communication link is terminated.

Furthermore, in some embodiments of the battery pack, the datalog of the battery pack may include unique identifying information that will enable the battery pack to tie its usage data with a power tool that it is connected with. As described above, the tool and the battery pack handshake via the data communications terminal to establish a connection. If that connection is made, the tool also sends its unique ID (e.g., MAC address of the tool BLEM module) to the battery pack. The battery pack BLEM includes the unique ID of the tool (i.e., last tool used) within its extended scan response signal. Further, when the battery pack is constructing its own datalog to transmit via a communication link to a gateway as described above, it packages the tool unique ID with the pack datalog for the duration of time the battery pack was being used with the power tool. Thus, for example, a datalog of all the battery pack operational data between the time it was coupled to the tool until it was decoupled from the tool will be tagged with the unique ID of the power tool. Similarly, the tool receives the unique ID of the battery pack and the tool BLEM includes the unique ID of the battery pack (i.e., last battery pack used) within its extended scan response signal. Further, the tool BLEM packages the battery pack ID with the tool datalog for the duration of time the battery pack was being used with the power tool. Thus, for example, a datalog of all the power tool operational data between the time it was coupled to the battery pack until it was decoupled from the battery pack will be tagged with the unique ID of the battery pack. This allows for battery pack data to still be linked with a particular power tool, and for a power tool to have its data linked with a particular battery pack, even though both devices separately collect and transmit their own data to the gateway. In some embodiments, this identifying information tied at particular timestamps may be transmittable in the two-way communication link. In some embodiments, the BLE of both the power tool and the battery pack may write either a time stamp or the unique ID of the device it is connected to on a periodic basis, say once every 24 data frames.

In some embodiments, as an alternative to the advertising protocol, a BLE wireless connection may be established between a central and the tool BLEM or connected battery in peripheral mode. Credentials may be exchanged to allow the connection to transmit the data securely. Packets of data may then be wirelessly transmitted to the central. An acknowledgement message can occur which ensures data receipt. This connection may be available only at particular times or situations, and various configurations may be possible for when data is transferred to the central. For example, only when the battery pack is on the charger; only after the battery pack is decoupled from a tool; only when tool is not active (e.g., certain amount of time has passed since last trigger release); only when the tool/battery pack is within range of a certain type of central device (e.g., gateway module but not a mobile phone); only when the tool/battery pack within a certain distance of the central device (e.g., within 5 feet); or only when the tool/battery pack is within a certain distance of a central for a predetermined amount of time (e.g., battery pack is not moving around), etc.

Furthermore, in some embodiments, the type of data to upload can be selective. There may be various configurations of what/how data is transferred to a central. For example, only the packets of data since the last data upload may be uploaded. Alternatively, the packets of data for a pre-determined amount of time (e.g., last month) or pre-set number of usages (e.g., last 10 usages) may be uploaded. As another example, only pack related data may be uploaded. As another example, only tool related data may be uploaded. Alternatively, if the memory is not expunged when uploaded wirelessly, the entirety of the memory could be sent each time (causing duplicates which would need to be filtered out elsewhere).

In some embodiments, the advertising and extended scan response data may contain an indication that additional information is ready for transmission to prevent the need to connect again. The message format may contain an indicator that a change or an update is available, which may prompt the scan request message to be sent or may allow for multiple ESR messages to be sent before another scan request is sent.

In some embodiments, a combination of the advertising signal protocol and the two-way communication link may be used to transmit the totality of data from a peripheral to the central. Some data related to real time events may be sent on a real time basis using the advertising signal protocol, for example, while data logs or large data dumps may be sent using the two-way communication connection.

### Prioritization of Date Related to Safety and User Protection Events

In some embodiments, the power tools 10 and/or 20, and/or the battery pack 60, may be configured to set the content of the data and/or the frequency of the transmission of the data, in accordance with a detected condition. Such condition may be, for example, a safety or user protection event, such as a kickback event, an overcurrent event, a stalled rotor event, tool drop and/or damage, etc. Upon detection of any such event, the tool and/or the battery pack may modify the frequency of the transmission of the advertisement signals. For example, in illustration 1935, the connectable advertisement signals and the scannable advertisement signals may be transmitted alternatingly at a set frequency (e.g., every four seconds) under normal conditions. Upon detection of a safety or user protection event, the wireless communication controller may reduce the frequency of transmission to, e.g., every 2 seconds. In another example, the controller may alternatively interject a greater number of scannable advertisement signals than connectable advertisement signals, or vise versa. In an example, after detection of a safety or user protection event, the controller may additionally change the content of the data, e.g., by including more detailed information relating to the safety or user protection event in the advertisement data and/or the extended scan response data. For example, one or more of the fields in the advertisement data and/or extended scan response data may be designated to include a timing of the safety or user protection event, the severity of the event (e.g., the degree of kickback or amount of overcurrent), etc.

### Data Prioritization to Extend Secondary Power Source Life

In some embodiments, in power tool 10 and/or power tool 20, the wireless controller 242 may be configured to set the content of the data and/or the frequency of the transmission of the data based on whether the wireless controller 242 is powered by the secondary power source 260 (e.g., coin cell) or by a battery pack. By doing so, the wireless controller 242 may aim to extend the life of the secondary power source 260. In particular, in some power tools, the secondary power source 260 may not be easily serviceable or replaceable. Thus, prioritization of data with the aim of reducing the transmission load when powered by the secondary power source 260 may be desirable.

In an embodiment, the wireless controller 242 can detect, in communication with motor controller 230, whether the battery pack is presently coupled to a battery receptacle of the power tool and/or voltage is received from the battery pack. If the battery pack is present, the frequency of transmission of the data (e.g., the connectable advertisement and/or the scannable advertisement) may be set to a first value (e.g., every 2 seconds). If no battery pack is present and the wireless controller 242 is powered by the secondary power source 260, the frequency of transmission may be set to a second value that is greater than the first value (e.g., every 4 seconds).

In an embodiment, if there is no battery pack present, the wireless controller 242 may be configured not to transmit any connectable advertisement signals, so that it does not make itself available for offload of its datalog until it is powered via a battery pack. The wireless controller 242 may similarly replace the transmission of connectable advertisement signals with non-connectable advertisement signals, in which advertisement data is included but it is set to a non-connectable state. In yet another example, the wireless controller may set the Data Load value to zero, in order to indicate to the gateway devices that it does not have any datalog to offload.

In an embodiment, the amount of data that is offloaded may be set based on the wireless controller 242 is powered by the secondary power source 260. Specifically, if there is significant data stored in the memory 248 for offloading, the dataload is reduced only a threshold level is reached. For example, if data in the memory 248 is near the memory's maximum capacity, the data is offloaded until it reaches the threshold level, e.g., 70% of the maximum capacity. In this manner, the wireless controller 242 can continue to save information to the memory 248 without significantly impacting the state of charge of the secondary power source 260.

In an embodiment, the type of data that is transmitted may be set or limited based on whether the battery pack is present. For example, when there is no battery pack present, the data transmission may be limited to data related to safety and/or user protection events and location information.

In an embodiment, the extended scan response protocol may be disabled when the battery pack is not present. For example, the wireless controller 242 may stop transmission of scannable advertisement signals if a battery pack is not present.

In an embodiment, the techniques and control features described above can be adjusted based on the battery pack state-of-charge (SOC) instead of or in addition to detection of presence of the battery pack. In an example, the wireless controller 242 may reduce the frequency of transmission as a function of the battery pack SOC; prevent a connectable state or an extended can response when the battery pack SOC falls below a threshold; or adjust the amount or type of data that it offloads from the memory 248 as a function of the battery pack SOC. In a further embodiment, the wireless controller 242 may reduce the number or amount of write operations into the memory 248 (i.e., by receiving less data from the motor controller 230 and/or limiting the types of data received from the motor controller 230) based on the battery pack SOC. In an embodiment, when the battery SOC falls below a threshold, the wireless controller 242 may cut off its own supply of power from the battery pack, so the battery pack power is used exclusively to power the motor control unit 204.

In an embodiment, the same techniques described above can be applied to the SOC of the secondary power source 260. Specifically, the wireless controller 242 may reduce the frequency of transmission as a function of the coin cell SOC; prevent a connectable state or an extended scan response when the coin cell SOC falls below a threshold; and/or adjust the amount of data that it offloads from the memory 248 as a function of the coin cell SOC.

In another example, the battery pack may similarly be configured to set the content of the data that is transmitted, the frequency of the transmission of the data, the amount of data for offload, or the connectable transmission mode, based on its own SOC. This may include, for example, adjusting the frequency of transmission to a lower frequency once the SOC falls below a threshold, preventing a connectable state when the battery pack SOC falls below a threshold, or adjust the amount or type of data that it offloads from as a function of the battery pack SOC.

Similarly, if the battery pack includes a GPS 274, the transmission of data from the GPS device, or receipt of an updated location from the GPS, may be disabled if the SOC falls below a threshold. Similarly, if the battery pack has a cellular modem/gateway device 276, the battery management controller 262 may disable it based on the battery pack SOC. Collection and storage of data from the IMU 272 and other sensors may similarly be disabled or limited based on battery SOC. In an embodiment, a hysteresis thresholding may be applied to the battery SOC or the voltage level so the above functions are disabled when the SOC falls below a first threshold, but are not reenabled until the SOC exceeds a second threshold that is greater than the first threshold.

In an embodiment, the battery management controller 262 may adjust any of the techniques and control features above based on if it is coupled to a charger, if a proper level of cell balancing is reaches, of if the charge has reached a predetermined level.

### Cellular Example

In some embodiments, a battery pack is equipped with a cellular modem. All the data is transferred directly via the cellular modem to the cloud, bypassing the need to dump data into a central device within the worksite. The battery pack or tool BLE module may include a SIM card, which may allow for transmission of data directly to the internet via a cellular network. The battery pack or tool BLE module may act as a cellular gateway, whereby it gathers data from field devices and sends it over the cellular network. In addition, the cellular capabilities may provide location of the power tool or battery pack through triangulation of wireless range estimation or other ping messages. Furthermore, the cellular functionality herein may also provide timestamps in place of an RTC device.

### GPS Example

In some embodiments, the battery pack may also be equipped with a GPS module to track its location. The GPS coordinates may be transmitted from the battery pack along with other data associated with the time of transmission. The GPS coordinates may be correlated with other types of data, such as indicating the location at the time of an event. The GPS coordinates information may be collected periodically, at trigger pull/release, or periodically during tool operation, as some examples. GPS altitude or speed may be collected periodically, at trigger pull/release, or periodically during tool operation. The GPS may provide a timestamp in place of an RTC device. Furthermore, GPS data, such speed or altitude, may inform decision making logic on the pack or tool BLE module, such as adjusting for location or altitude.

### Backend Server Examples

Aspects of the present disclosure include a backend server, such as server 90, that is capable of receiving tool data related to multiple power tools and from different sources. Based on the descriptions above, various power tools with varying levels of data recording and transmitting capabilities, and multiple battery packs that can be interchanged with different power tools, may send their data ultimately to the backend server. Aside from there being multiple sources of where the data originates from, the data may be sent at different times, and the types of data transmitted to the server may be different. Some of the data transmitted may be the same data but just packaged differently, such as when some data is transmitted in real time but the same data is later transmitted as a full data log. The backend server of the present disclosure is therefore capable of analyzing the different data sources and synchronizing the data so that there are no duplicates. This will allow for more analysis to be completed by the server at a later time.

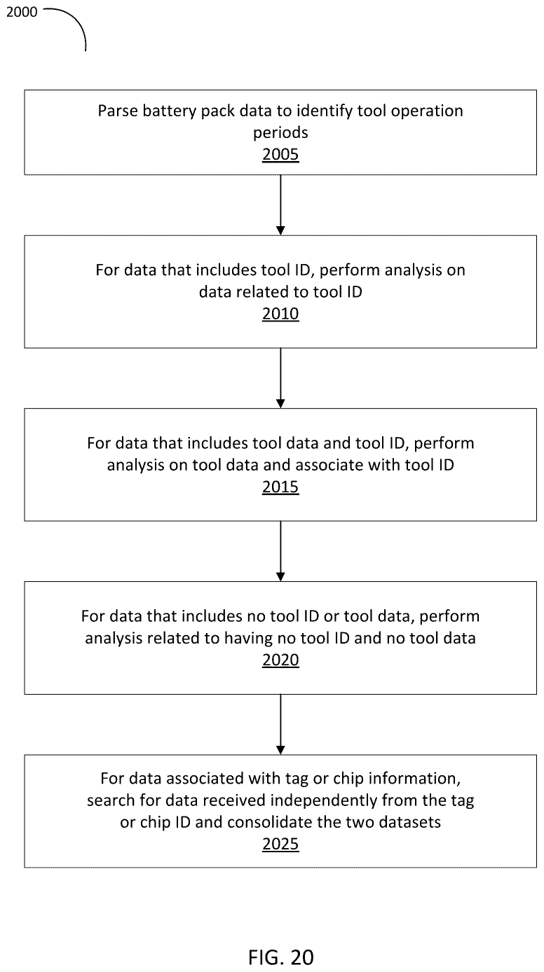

Referring to FIG. 20, flowchart 2000 provides an example process for how a backend server ingests the multiple streams of data. At 2005, the backend server first may parse battery pack data to identify tool operation periods. The tool operation periods may be based on start and end times in the data, trigger pulls, shutdown events, or other markers in the data to indicate when a tool operation has started and completed. Examples of the types of data available are described above, at least with respect to Tables 3-6.

At 2010, the server may determine if the battery data includes a corresponding tool ID for a given tool operation period. Then the server may perform various analysis on the data related to the tool ID. At 2015, the server may determine if the parsed data includes tool data in addition to the tool ID. The server may then perform various analysis on the tool data and associate that with the tool ID. At 2020, the server may determine that some of the parsed data includes no tool ID and no tool data. The server may then perform separate analysis for this data, at least involving attempting to identify what tool has generated such data. At 2025, the server may determine that some of the data is associated with a tag or chip. For correlating the data from the battery pack with the tag or chip data, the server may search for data receiving independently from tag or chip ID and then consolidate the two datasets.

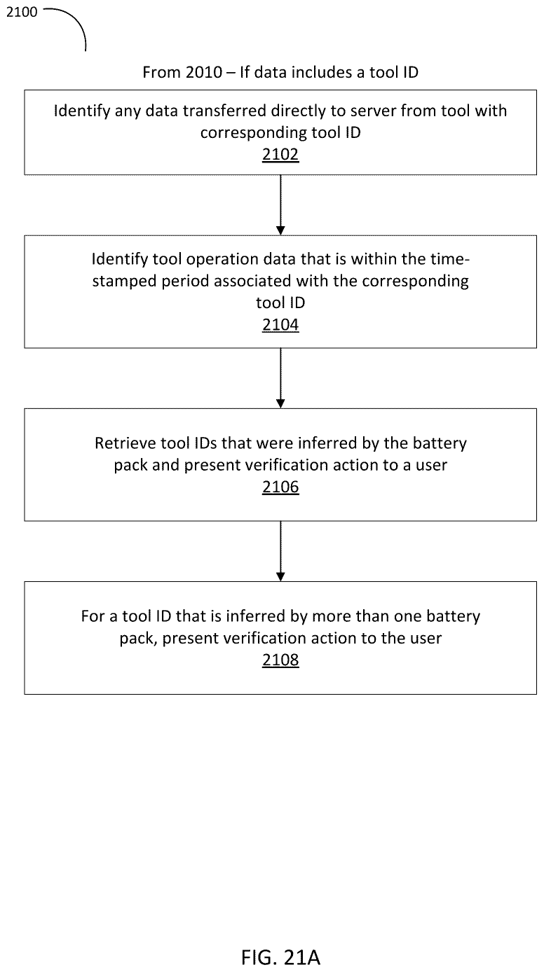

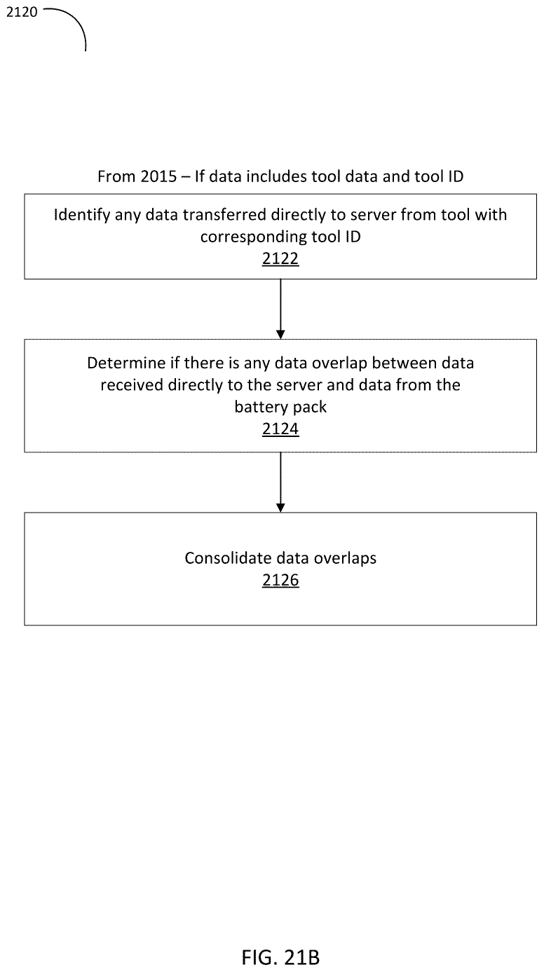

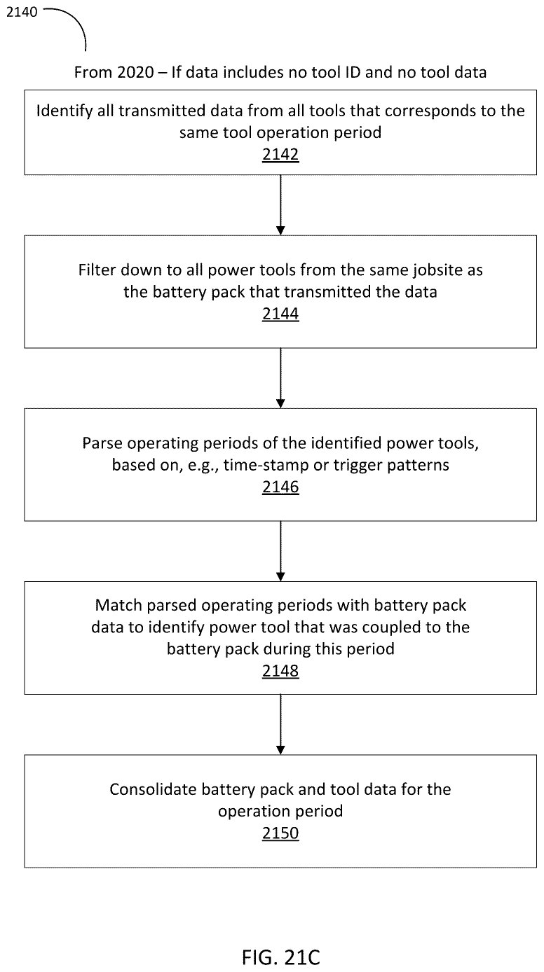

Referring to FIG. 21A, flowchart 2100 shows additional steps arising from the server process of FIG. 20 when the data includes a tool ID, which relates to 2010, according to some embodiments. At 2102, for the data that the server has identified includes a tool ID, the server may identify any data transferred directly to the server from the tool with the corresponding tool ID. At 2104, the server may then identify the tool operation data that is within the time-stamped period associated with the corresponding tool ID. For example, the server may search for trigger-pull/trigger-release patterns that match the tool operation period. At 2106, the server may then retrieve the tool IDs that were inferred by the battery pack and present a verification action to a user. For example, the user may be presented in a user interface a message and choice to confirm or verify that the tool and data linked to the tool based on the tool are correct. The server may present a copy of the information received for the user to then analyze. At 2108, for a tool ID that is inferred by more than one battery pack, meaning it appears that at least two packs have been used in the same tool, the server may present a similar verification to the user to confirm whether the linkage of the multiple battery packs to the power tool is correct.

Referring to FIG. 21B, flowchart 2120 shows additional steps arising from the server process of FIG. 20 when the data includes a tool ID and tool data, which relates to 2015, according to some embodiments. At 2122, for data that includes both tool data and tool ID, the server may identify any data transferred directly to the server from the tool with the corresponding tool ID. For example, the server may search for data based on time-stamping or trigger patterns. At 2124, the server may then determine if there is any data overlap between the data received directly to the server and data from the battery pack. At 2126, the server may then consolidate the overlapping data between data from the tool and data from the battery pack.

Referring to FIG. 21C, flowchart 2140 shows additional steps arising from the server process of FIG. 20 when the data includes no tool ID and no tool data, which relates to 2020, according to some embodiments. At 2142, when the data includes no tool ID and no tool data, the server may identify all transmitted data from all tools that corresponds to the same tool operation period. The server may attempt to identify or place where this data should be matched with. At 2144, the server may then filter that set of data to just those power tools from the same jobsite as the battery pack that transmitted the data. At 2146, the server may then parse operating periods of the identified power tool, based on, for example, time-stamp or trigger patterns. At 2148, the server may then match the parsed operating periods with battery pack data to identify a power tool that was coupled to the battery pack during this period. At 2150, the server may then consolidate the battery pack and tool data for the operation period, having made a determination of which power tool is associated with the battery pack that sent the data.

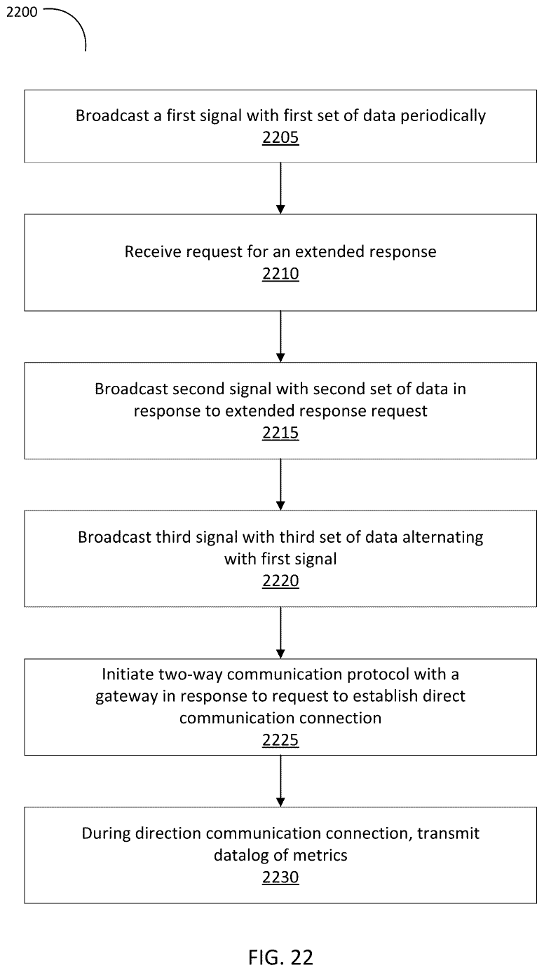

Referring to FIG. 22, flowchart 2200 shows an example methodology of a battery pack or a power tool interacting with a gateway according to one or more communication protocols, according to some embodiments. The example methodology described herein may be consistent with the descriptions of FIGS. 19A through 19C, for example. The battery pack or power tool that may implement this example methodology may have one or more sensors that generate health and status data to a microcontroller and memory in a wireless communication module, which then can broadcast the data in the manner described herein. In some cases, a battery pack may be configured to also receive data from the power tool, while in other cases, the power tool and battery pack separately broadcast their own data. For ease of description, a mobile construction site device is a term that may be used to refer to any electromechanical device typically used at a construction site that is mobile by being small enough to be carried and used by a person, such as a power tool or a battery pack according to any of the descriptions herein.

At 2205, the mobile construction site device may broadcast a first signal with a first set of data periodically. An example of the first signal may be the scannable advertisement signal consistent with the descriptions of FIGS. 19A-19C and related tables in the description, above. The scannable advertisement signal may include certain common data from the mobile construction site device.

At 2210, the mobile construction site device may receive a request for an extended scan response as a result of a device, such as a gateway, receiving the first signal. The gateway may have sent the response for a request of the mobile construction site device to send an extended scan response in order to receive more data related to the information it received from the initial first scannable advertisement. For example, some data present in the first signal may have indicated an error or something unusual, and the gateway therefore wanted to receive more information to learn more. At 2215, the mobile construction site device may broadcast a second signal with a second set of data in response to receiving the extended response request. The second signal may be consistent with the extended scan response signal described in FIGS. 19A-19C and the tables described above, for example. The mobile construction site device may not send this extended scan response unless it first receives the request for the extended scan response. The gateway may then be configured to receive this second signal and analyze the data as desired. The types of data that may be transmitted may also be consistent with any of the data described in the tables, above.

At 2220, the mobile construction site device may broadcast a third signal with a third set of data alternating with the sending of the first signal, according to some embodiments. An example of the third signal may be the connectable advertisement signal consistent with the descriptions in FIGS. 19A-19C. In some embodiments, if the request for an extended scan response is received by the mobile construction site device, then the sending of the third signal is suspended until the second signal, such as the extended scan response, is broadcast. The third signal with the third set of data is typically sent alternatingly with the first signal in a repeating pattern.

At 2225, the mobile construction site device may receive a signal from the gateway, in the form of a request to establish a direct communication connection with the gateway. This is in contrast with a broadcast signal, in that the broadcast signal may be received by any nearby device. Here, the gateway and mobile construction site device may initiate a two-way communication protocol that may be partially encrypted, according to some embodiments. The connectable advertisement signal and the two-way communication connection may be consistent with the descriptions of FIGS. 19A-19C, for example. At 2230, this connection may be used to transmit larger amounts of data to the gateway from the mobile construction site device, such as datalogs of sensor data and other health and status metrics or other streams of data. The types of data that may be transmitted may also be consistent with any of the data described in the tables, above. After the transmission of the stream of data is completed, the connection may be terminated after receiving a termination indication or after a predetermined amount of time has elapsed since the last transmission of any new data.

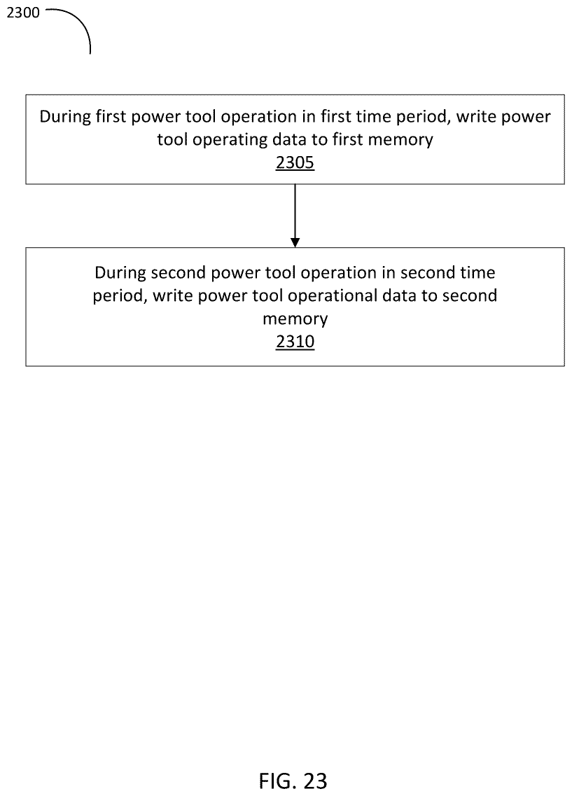

Referring to FIG. 23, flowchart 2300 shows an example methodology of a power tool implementing a multi-stage memory writing operation and power draw protocol, according to some embodiments. The methodology described herein pertains to when the power tool draws power from a first trigger pull until it performs a shutdown procedure. The flowchart 2300 may be consistent with the descriptions in FIG. 3, for example. At 2305, during a first power tool operation occurring in a first time period, the power tool may write power tool operating data to a first memory. The first power tool operation may be a power tool trigger pull to activate the tool mechanism of the power tool. The power tool's sensors may generate sensor data and transmit their data to a microcontroller having a memory, consistent with the descriptions in FIG. 3, for example. During the first power tool operation, the power tool may be powered by the battery pack, and the operation to write to the first memory may be powered by the battery pack. The first power tool operation may include the span of operational time of how long the trigger pull lasts, as well as multiple subsequent trigger pulls that may occur with only a minimal wait time between successive pulls.

At 2310, during a second power tool operation occurring in a second time period after and mutually exclusive to the first time period, the power tool may write the operational data to a second memory, according to some embodiments. The second power tool operation may be a shutdown operation, for example, that may occur after a predetermined amount of time has elapsed since the last trigger pull, or if an error event occurs that forces the second power tool operation. During this event, the power tool may perform a write to a second memory, which may be the memory in the wireless communication module as discussed in FIG. 3, for example. The write operation to the second memory may be a transfer of the sensor data and any other health and status data recorded during the first power tool, from the first memory to the second memory. The wireless communication controller may facilitate this second write operation, according to some embodiments. During this second power tool operation, a second power source, such as a coin cell battery, in the wireless communication module, may provide the power to perform the second write operation since the power tool is performing a shutdown operation and not using the battery pack. In this way, the steps to transmit data for broadcasting using the wireless communication module may use two memories and two power sources. This may reduce the power usage by the smaller second power source in the wireless communication module, and rely as much as possible on the power provided by the battery pack. Then, at a time when the wireless communication module is drawing power, either from the battery pack or the second power source, the operational data may be broadcasted according to the protocols described in FIG. 22 or FIGS. 19A-19C, for example.

In some embodiments, the flowchart 2300 is also applicable to a battery pack that is connected to and powering a power tool. An example of this battery pack is described in FIG. 10B. The battery pack may include a first memory coupled to a battery management controller. When the battery pack is connected to a power tool and powering the power tool, the battery pack may generate its own battery operational data that provides statuses on how the battery is performing or functioning when powering the power tool. The battery management controller may store this information in the first memory during the live operation of the power tool, say during one or more trigger pulls in succession. When the operation or series of operations is over, during a second power tool operation, such as during a shutdown procedure, the battery operational data may be written to a second memory by a wireless communication module. The wireless communication module may then use the second memory to prepare sending the data in broadcast signals to be transferred to a gateway.

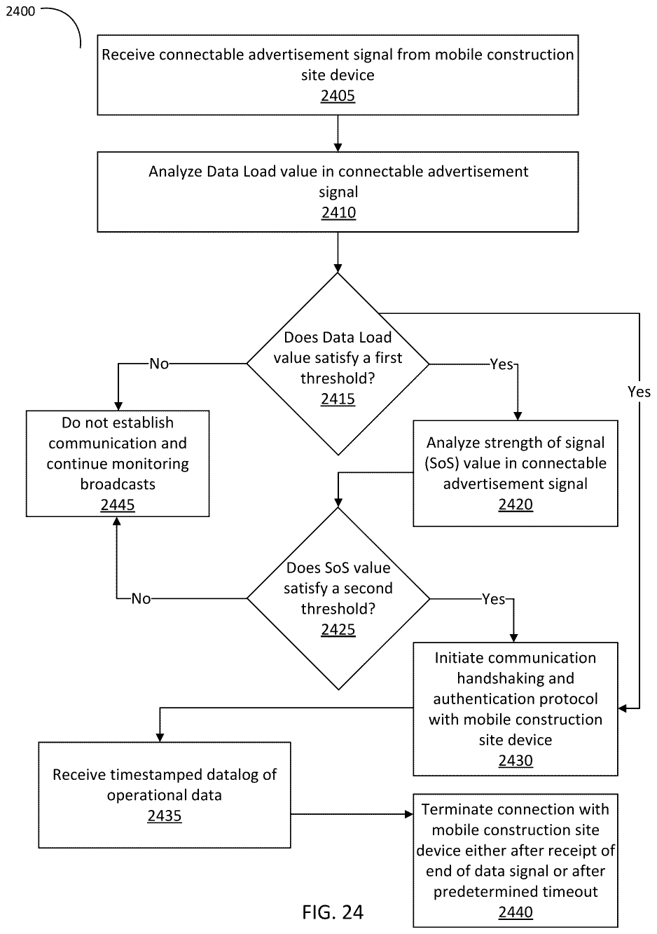

Referring to FIG. 24, flowchart 2400 shows an example methodology of a gateway for controlling the influx of data from multiple mobile construction site devices, according to some embodiments. The methodology of flowchart 2400 may be consistent with the descriptions above of how the gateway may operate, including as described in FIGS. 14 and 19A-19C. As mentioned above, the gateway may receive multiple broadcast messages from multiple mobile construction site devices in its vicinity. Each of these devices may be generating and storing their own operational data through the course of work at a construction site. The data in the mobile construction site devices will eventually accumulate to a point of filling up its memory, until it may be in danger of running out of memory if the data cannot be offloaded or removed. As mentioned above, a data load value or indicator may be transmitted in advertisement broadcast signals that provide an indication of how much data is stored in their memory. At 2405, the gateway may receive the scannable advertisement and/or connectable advertisement signals from the mobile construction site device, which contains this data load indicator and other data. At 2410, the gateway may analyze the broadcasted signals for this data load value in the connectable advertisement signal in order to decide whether to establish a connection with the mobile construction site device. At 2415, the gateway may determine whether the data load value satisfies a first threshold. If the data load value is greater than or equal to the first threshold value, the gateway may continue to establish connection either to 2420 or 2430. If the data load value is less than the first threshold value, then at 2445 the gateway may decide to not establish two-way communication with the mobile construction site device and will instead just continue monitoring what broadcast signals it receives.

In some embodiments, the analysis of whether to establish connection does not end with just the data load value, but continues at 2420. After the initial passing of the first threshold, the gateway may continue by analyzing a wireless range estimate value as previously described, i.e., based on a strength of signal (SoS), ToF, channel Sounding, and/or RTT, in the connectable advertisement signal. At 2425, the gateway may determine whether the wireless range estimate value satisfies a second threshold value. If the second threshold value is satisfied, then communication may be established at 2430. If not, the gateway will not establish two-way communication at 2445 and will continue to just monitor the broadcasts. In some embodiments, the second threshold value may vary depending on the value of the data load value. For example, if the data load value indicates that the device's memory is nearly full, then the second threshold value may be lower in order for the connection to be established. Alternatively, if the data load value indicates that the device's memory can store more data equal to an amount that may be estimated to be filled over a long period of time, for example, then the second threshold may be higher, indicating that connection should be established only when the device is in closer proximity to the gateway. By using the wireless range estimate value, the gateway may also prioritize downloading data from multiple devices that are in the range of the gateway, in the event there is less time or bandwidth available relative to the number of devices around to offload their data.

In some embodiments, the gateway may establish connection at 2430 directly after weighing the data load value in comparison to the first threshold, without performing any analysis of the wireless range estimate value. In any case, whether the gateway goes through 2425 or directly from 2415, at 2430, the gateway may initiate a communication handshaking and authentication protocol with the mobile construction site device it wants to connect to. For example, consistent with what is described above, if the data load value indicates that the memory is nearly full, then the gateway may respond to the mobile construction site's connectable advertisement signal by establishing the two-way communication connection to download its datalogs so the memory can be erased and reset. As another example, if the strength of signal indicator shows that the mobile construction site device has a strong connection with the gateway, then the gateway may want to download the data no matter what state the data load value is in, just to take advantage of the device's strong signal and/or close proximity to the gateway. As another example, a combination of the data load value and the strength of signal value may cause the gateway to initiate the two-way connection, based on a combination of how full the device's memory is and how strong the device's connection is to the gateway.

At 2435, the gateway may receive the timestamped datalog of operational data from the mobile construction site device. The device may then delete the logs so that its memory can be cleared. At 2440, the connection may be terminated by the gateway in one or more ways. For example, after receipt of an end of data signal or after a predetermined amount of time since receiving the last data, the gateway may then initiate a procedure to end the two-way communication connection.

### Data Encryption Examples

In some embodiments, the wireless communication module of either the battery or the power tool may include an encryption key that encrypts only particular subsets of information during one type of data transfer but not other types. For example, during the two-way connection to transfer the datalogs from a peripheral device to a central device such as the gateway, a secure, encrypted connection may be established, while at least a portion of the advertising signals and responsive connection requests may not be encrypted. At least some portion of the advertising signals may be unencrypted because the advertising portion should be public in order for a suitable device to connect to. On the other hand, it makes sense for the connection, once established, to be secure because the suitable central device has been identified with the peripheral device. In some embodiments, the encryption key may be in the header of an advertisement signal, while in other cases, the encryption key may be in the body of the advertisement signal.

To establish a secure connection, in some embodiments, each peripheral device may contain one or more of its own unique private keys. Only a subset of the broadcasted advertising data may be encrypted by the BLE (e.g., the wireless communicator controller 266 of the battery pack 60 and/or the wireless controller 242 of the power tool 10, 20) in the scannable and connectable advertising signals, using one of its private keys. Some identifying information about the device, such as a unique ID of the device, may be contained in the advertising signal, which will allow the central device such as the gateway to look up the decrypting keys associated with that peripheral device so that the data may be decrypted by the gateway. The gateway may obtain the decrypting key(s) by contacting the backend server, which may store the information.

As another example, in some embodiments, no unique keys may be associated with any particular device, but instead, each BLE may store a database of a set of private keys that may be used for partially encrypting the data. Each key in the database may be associated with an identifying value, and the backend server may hold the same or similar database on its end with matching identifying information for which key to look up for decrypting, based on the identifying value that the peripheral device provided to indicate which key it used to perform the encryption. For example, the backend server may store a lookup table linking each unique identifying value to a unique encryption key. Thus, when the gateway receives the advertisement signal, it may obtain the identifying value of which encryption key was used, and then may obtain the proper corresponding key from the backend server using the identifying value, to decrypt the information from the peripheral device.

In some embodiments, the BLE of each peripheral device may store only one key, but have its key identified by its identifying value. The backend server may contain the entire database of all keys and associated identifying values. As another variant, the BLE of each peripheral device may have more than one key with associated identifying values, and the gateway may obtain the proper key from the backend server using the same methods mentioned herein.

In some embodiments, in the extended scan response, only a portion of the data may be encrypted, while a remaining portion would be encrypted. In some embodiments, symmetric encryption may be used, while in other embodiments, asymmetric encryption may be used. These methods may allow for certain customers the ability to only encrypt their information to send to the gateway, but not the ability to decrypt information. This provides for an extra layer of security.

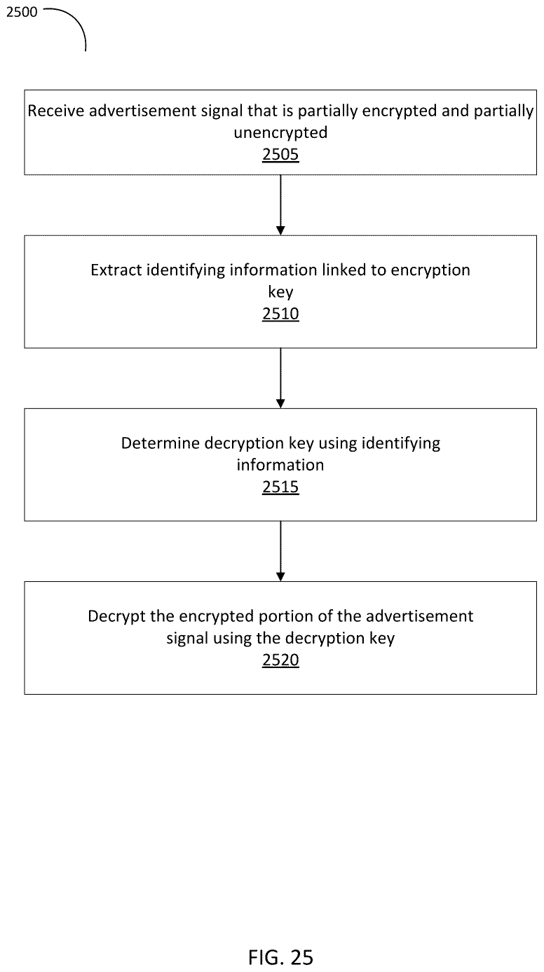

Referring to FIG. 25, flowchart 2500 shows an example methodology of an encryption procedure for encrypting part of the data sent by a mobile construction site device, according to some embodiments. The example methodology describes the general processes involving the various electronic devices, such as a mobile construction site device, a gateway and a backend server, but the methodology is written from the perspective of the gateway. In some embodiments, the data that is encrypted may include some health and status information, the data fields exclusive to the extended scan response, or the data that is transmitted after the two-way communication connection is established in response to a connectable advertisement signal, as just some examples. The encryption methodology described here may be consistent with the descriptions about encryption, above.

At 2505, a gateway may receiver from a mobile construction site device an advertisement signal, either a scannable advertisement or a connectable advertisement, that is partially encrypted and is partially unencrypted. Since these signals are broadcasted so that anybody is able to pick them up, the entirety of the message should not be fully encrypted, or else nobody may know how to read the message and provide a response. Some of the health and status data may be encrypted, while header information and information that can lead to the identification of the encryption key may be unencrypted.

At 2510, the gateway may receive the advertisement signal and may extract the identifying information that is linked to the encryption key. Example descriptions of types of information that may lead to the identification of the encryption key are found above. For example, a single pointer value to an index of an array of encryption keys may be present in an unencrypted data field, or a unique ID of the battery pack or tool may be identified, and a database accessible to the gateway may be able to tie that unique ID to its known encryption key. At 2515, through any of the various examples described above, the gateway may then determine the decryption that is the counterpart to the encryption key using the identifying information. For example, the gateway may transmit the information to a backend server that may look up the corresponding information of the decryption key using a look up table. The backend server may then transmit the correct information to the gateway. At 2520, the gateway may then decrypt the encrypted portion of the advertisement signal using the determined decryption key to decipher the encrypted data. In some embodiments, the decryption processes may be performed by a backend server instead of the gateway.

### Wireless Protocols

Throughout this disclosure, various embodiments are often described with reference to a Bluetooth® and/or a Bluetooth Low Energy (BLE) wireless protocol. It should be understood that these protocols are provided by way of non-limiting examples and the principles and features disclosed herein may similarly apply to other wireless communication method and protocols.

In some embodiments, the wireless devices described in this disclosure (including the wireless controllers 242 of the power tools 10 and 20, the wireless communication controller 266 of the battery pack 60, the gateway 80 and any of the wireless communication devices described in this disclosure, may use a LPWAN (Low-Power Wide Area Network) protocol. LPWAN is a mesh network protocol wireless communication that enables secure and reliable long-distance communication. In a large construction site environment, where the communication range of Bluetooth® or BLE modules may be limited due to range or interference by concrete walls and other obstructions, a LPWAN protocol may be highly desirable. LPWAN protocols have wide coverage and great penetration through obstructions, and it can operate in low power (e.g., from a coin cell battery) for a long duration of time. An example of LPWAN is Wi-SUN (Wireless Smart Ubiquitous Network), LoRaWAN (Long Range Wide Area Network), NB-IoT (Narrowband Internet of Things) protocol, LTE-Mesh, Sigfox, Wifi-Halow, etc. These protocols offer various ranges and coverages, data rates, power consumption, reachability, and payload sizes. LoRaWAN, for example, is suitable for a vast coverage range of approximately 5 km and operate at approximately 12.5 kbps. Other communication protocols such as LoRa, Z-Wave, Zigbee, WiFi, etc. may also alternatively and/or additionally be utilized.

### Onboarding

The system described in this disclosure offers the advantage that data from a wide range of power tools, battery packs, and other wireless-enabled construction devices (“product”), may be transmitted via advertisement and extended scan response, or offloaded in a data-log format, via gateway devices 80 to the backend server 90. In many instances, this may be done without the product user/operator taking any action to wirelessly connect the product to an accompanying mobile device. In fact, in some embodiments, the transmission of data is seamless and automatic, without user initiation or interference.

In some embodiments, a product may be onboarded by an enterprise user (e.g., a construction company). Specifically, the enterprise user may have a user account associated with it in the backend server 90. The product may come with a unique ID that can be associated with the user account. In an example, referring to FIG. 1, the product may include a QR code (e.g., printed on the housing of the power tool 10 or 20, or the battery pack 60). The enterprise user may utilize an app on the mobile device 70 to scan the QR code, go through an account authentication process, and add the product to an inventory associated with the user account. This allows the backend server 90 to associate a unique product ID associated with that product with the user account. Additionally, the backend server 90 may be configured to associate the product ID with the unique ID of the wireless controller of the product that is included in advertisement signals transmitted from the product. Thus, all the data received from the gateway that include the unique ID will be associated by the backend server 90 with the user account.

### User Interface and Management

Referring to FIG. 1, gateway devices 80 and/or mobile app 70 gather data in a variety of formats from various power tools and batteries and send that data via the Cloud to backend centralized server 90. Server 90 can process the data in a variety of ways. The data may be used by the power tool or battery pack manufacturer to detect defects or misuses of the products. The data may also be presented to users at various levels, including enterprise users (e.g., construction companies), site managers, shift supervisors, and tool users, in a graphics user interface (i.e., via a web browser or a mobile app) including graphics representative of the tool or battery operation. In some examples, only the data associated with a user account of an enterprise user is presented to the users authorized to access that user account.

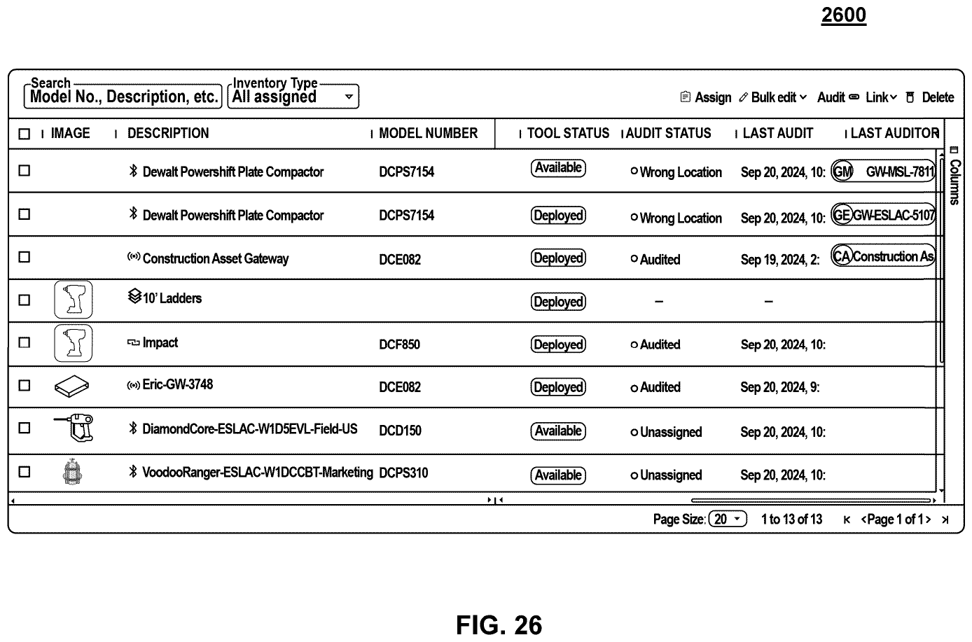

FIG. 26 depicts an example of a graphical user interface (GUI) 2600 provided to a user, such as a site manager or equipment supervisor, for tracking, monitoring, and managing the fleet of assets, according to some embodiments. In an example, the GUI provides a display of a fleet of assets managed by the user, which may include an image for each asset, a description of the asset, and the asset SKU and/or model number. The assets in this example, may include a power tool (e.g., any of power tools 10, 20 in FIG. 1) audit tag or chips coupled to an asset (e.g., audit tag or chip coupled to power tools 40, 50 in FIG. 1 or to unpowered assets such as ladders and handheld devices), gateway devices, etc. In addition, the display may include the tool status, indicating whether the tool has already been deployed to a location, assigned to a location, or available for assignment and/or deployment; an audit status, indicating whether the tool is in the correct location, in the wrong location, audited, or unassigned to any particular location; last audit date and time; and the name or ID of the last auditor.

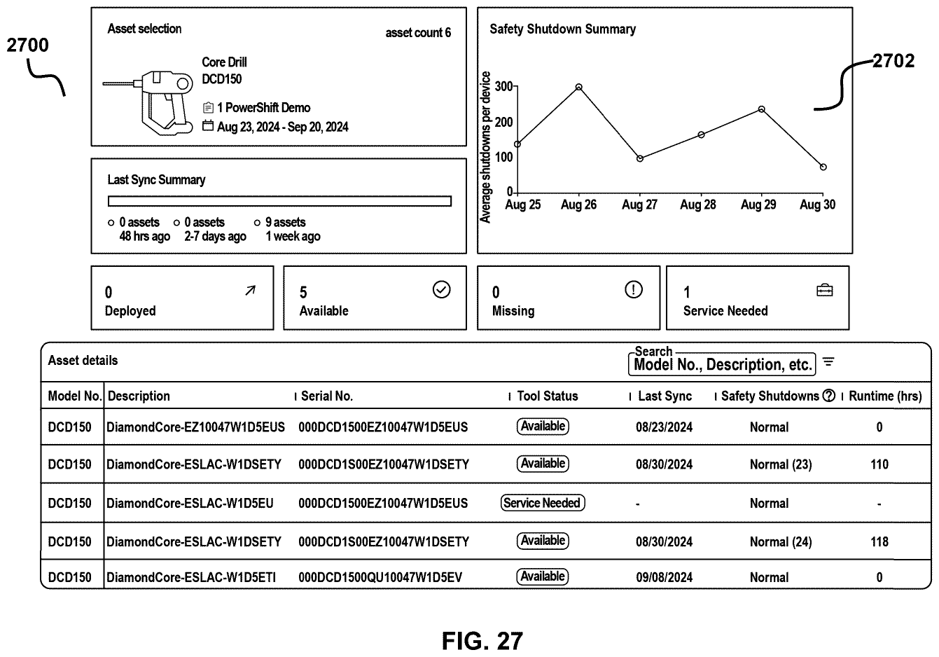

FIG. 27 depicts an example display provided on a GUI 2700 in response to the user's selection of an asset from the list of assets on the display of FIG. 26. In this display, information related to a particular selected asset (e.g., a core drill in this example), including the number of devices within that asset family and an inventory list of all said devices, is provided. The inventory list may include the serial number, status, last sync date, number of safety shutdown events, and total runtime of each device within the fleet of the selected asset. Further, the display may include statistical representations of how many of the devices are available for deployment to a site, already deployed, missing, and/or require service.

In an example, the display may also include a graphical plot 2702 of the device shutdowns. This plot may include the average number of shutdowns per device for the whole asset family, the total number of shutdowns for all the devices in the asset family, or the number of shutdowns for a selected device, on the y-axis. The plot may include a user-customizable date range on the x-axis. Using this plot, the user can evaluate and identify the tools that experience high levels of safety shutdown conditions.

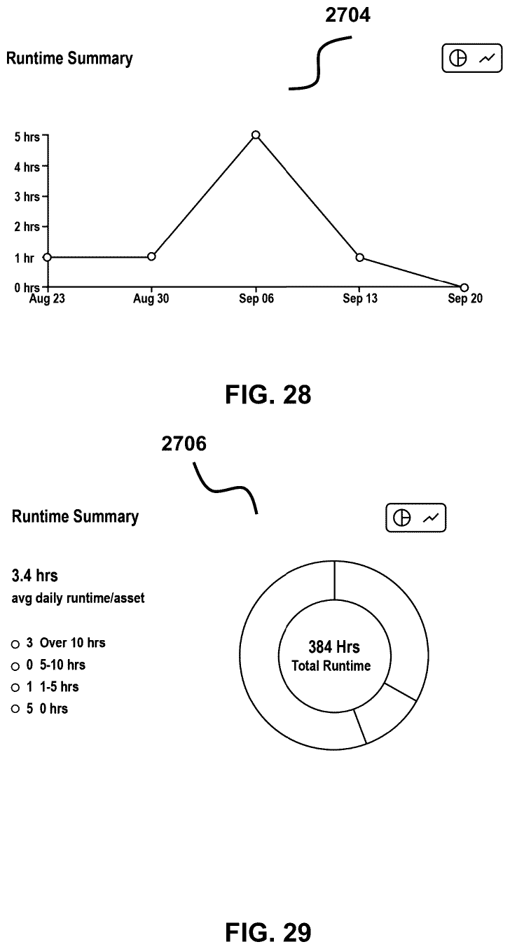

FIG. 28 depicts an exemplary graphical plot 2704 displayed on the GUI to illustrate the runtime summary of a device or a set of assets. In an example, this plot may be displayed in place of the graphical plot 2702 of FIG. 27. This plot may include the average daily runtime per device for the whole asset family, the cumulative daily runtime for all the devices in the asset family, or the daily runtime for a selected device, on the y-axis. The plot may include a user-customizable date range on the x-axis.

FIG. 29 depicts an exemplary graph 2706 provided on the GUI to illustrate the runtime classifications of the devices within an asset family. In an example, this graph may be displayed in place of the graphical plot 2702 of FIG. 27. In an example, the graph includes a graphical representation of the total runtime of the devices within the asset family, the average daily runtime per asset, and a categorization of the devices by average runtime.

Using the plot of FIG. 28 and/or the graph of FIG. 29, the user can evaluate runtime of individual devices or whole asset categories for use optimization and proper assignment. For example, this information may be used as indication that a particular tool family is not being utilized as needed on one side and should be assigned to another site. This information may also be indicative of worker's performance and workflow efficiency.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Various embodiments of the present systems and methods are summarized in the subsequent list of numbered clauses. In the following, further features, characteristics, and exemplary technical solutions of the present disclosure will be described in terms of clauses that may be optionally claimed in any combination. Applicant of this disclosure reserves the right to pursue any of the following embodiments, as recited below or in combination with any features of this disclosure previously described, in a divisional and/or continuation patent application

1. A backend server of a power tool system, comprising: a wireless communication interface configured to receive data from a plurality of data sources, the data sources comprising at least one rechargeable power storage module, at least one power tool, a gateway and a mobile application stored on a mobile device; a processor; and a memory coupled to the processor and configured to store the data received from the wireless communication interface; the processor configured to: parse the data received from the at least one rechargeable power storage module to identify tool operation periods; for first data that includes a tool ID, perform analysis on the first data related to the tool ID; for second data that includes tool data and the tool ID, perform analysis on the second data related to the tool data and the tool ID; for third data that includes no tool ID and no tool data, perform analysis related to having no tool ID and no tool data; and for fourth data associate with a tag or chip coupled to the at least one power tool, search for data received independently from the at least one power tool via the tag or the chip, and consolidate the fourth data with the independently received data.

2. The backend server of clause 1, wherein to perform the analysis on the first data related to the tool ID, the processor is further configured to: identify data transferred directly to the backend server from a power tool among the at least one power tools having the tool ID; identify tool operation data that is within a time-stamped period associated with the tool ID; retrieve tool IDs that are inferred by a first rechargeable power storage module among the at least one rechargeable power storage modules and cause display of a first verification action to a user for verifying whether the retrieved tool IDs inferred by the first rechargeable power storage module match the tool ID; and cause display of a second verification action to the user for verifying whether a tool ID associated with a second rechargeable power storage module among the at least one rechargeable power storage modules matches with a tool ID associated with a third rechargeable power storage module among the at least one rechargeable power storage module.

3. The backend server of any of the preceding clauses, wherein to perform the analysis on the second data related to the tool data and the tool ID, the processor is further configured to: identify data transferred directly to the backend server from a power tool among the at least one power tools that possesses the tool ID; determine any data overlaps between the second data and the data transferred directly to the backend server from the power tool; and consolidate the second data with the data transferred directly to the backend server from the power tool.

4. The backend server of any of the preceding clauses, wherein to perform the analysis related to having no tool ID and no tool data, the processor is further configured to: identify data transmitted from a plurality of power tools among the at least one power tool that corresponds to a common tool operation period as the third data; and filter out the power tools among the plurality of plurality of power tools to include only power tools from a common jobsite as a rechargeable power storage module among the at least one rechargeable power storage modules that transmitted the third data.

5. The backend server of any of the preceding clauses, wherein the processor is further configured to: parse operating periods of the filtered power tools based on a predetermined criterion; match the parsed operating periods with data from a plurality of rechargeable power storage modules at the jobsite to identify a power tool associated with the third data; and consolidate the third data with data from the matched rechargeable power storage modules.

6. A power tool system comprising: a power tool; a communication module communicably coupled to the power tool; a rechargeable power storage module configured to provide power to the power tool, the power storage module comprising: a first communication interface configured to access power tool data from the communication module, the power tool data having a plurality of data types relating to the power tool; and a processor communicatively coupled with the communication interface, the processor configured to: determine whether the communication interface is communicatively attached to the communication module of the power tool; detect one or more communication module attributes (CM attributes) associated with the communication module of the power tool; register, when a first category of CM attributes is detected, a first level of data metrics from the power tool; register, when a second category of CM attributes is detected, a second level of data metrics from the power tool; register, when a third category of CM attributes is detected, a third level of data metrics from the power tool; and register, when a fourth category of CM attributes is detected, a fourth level of data metrics from the power tool.

7. The power tool system of clause 6, wherein the processor is further configured to: associate the first level of data metrics from the power tool with an unidentified tool when the first level of data metrics are registered by the processor; associate the second level of data metrics from the power tool with a Bluetooth Low Energy (BLE) or tag/chip identification credential associated with the power tool, when the second level of data metrics are registered by the processor; associate the third level of data metrics from the power tool with a Bluetooth Low Energy Module (BLEM) address associated with the power tool, when the third level of data metrics are registered by the processor; and associate the fourth level of data metrics from the power tool with the BLEM address associated with the power tool, when the fourth level of data metrics are registered by the processor.

8. The power tool system of any of the preceding clauses, wherein the rechargeable power storage module further comprises a second communication interface to access power tool data from a battery pack that contains a wireless communications module that is communicably coupled to the battery pack, the battery pack data having a plurality of data types relating to the battery pack.

9. The power tool system of any of the preceding clauses, wherein the processor is further configured to:

transition from an observer mode to a peripheral mode; the observer mode configured to detect an associated tag or chip on the power tool; and the peripheral mode configured to cause the processor to communicatively couple to a remote server for transmitting data when the rechargeable power storage module is not connected to the power tool.

10. The power tool system of any of the preceding clauses, wherein to determine that the rechargeable power storage module is connected to the power tool, the processor is further configured to evaluate a strongest signal strength value associated with the power tool.

11. The power tool system of any of the preceding clauses, wherein the processor is further configured to send advertisement signals including location data at a periodic interval.

12. The power tool system of any of the preceding clauses, wherein the processor is further configured to convert to a central device and scan for advertising signals and uses wireless range estimation to determine what tag/chip is closest.

13. The power tool system of any of the preceding clauses, wherein the processor is further configured to read advertising data (USN/MAC address) from the tag/chip.

14. The power tool system of any of the preceding clauses, wherein the processor is further configured to differentiate between a connected battery pack and a non-connected battery pack by: detecting if the battery pack has a Data Comm terminal; and sending, by the power tool, a signal through the Data Comms terminal.

15. The power tool system of any of the preceding clauses, wherein the processor is further configured to cause the tool to send data to a BLEM of the power tool when the rechargeable power storage module is determined to be a non-connected rechargeable power storage module.

16. The power tool system of any of the preceding clauses, wherein the processor is further configured to, upon receipt of a response from the rechargeable power storage module, designate the rechargeable power storage module as a connected rechargeable power storage module.

17. The power tool system of any of the preceding clauses, wherein the processor is further configured to receive a unique Tool ID upon connection to the tool or at every trigger press or release.

18. The power tool system of any of the preceding clauses, wherein the processor is further configured to transmit data to the rechargeable power storage module and to a Bluetooth Low Energy Module (BLEM).

19. The power tool system of any of the preceding clauses, wherein the processor is further configured to transmit a first sub-section of the data to the rechargeable power storage module and a second sub-section of the data to a Bluetooth Low Energy Module (BLEM).

20. The power tool system of any of the preceding clauses, wherein the processor is further configured to determine that the rechargeable power storage module is connected to a power tool with no BLE Tag or Chip.

21. The power tool system of any of the preceding clauses, wherein the processor is further configured to obtain a tool runtime based on a time current starts flowing through a battery pack current shunt to the time the current stops flowing.

22. The power tool system of any of the preceding clauses, wherein the processor is further configured to count trigger pulls based on a number of times current stops or starts flowing through a battery current shunt.

23. The power tool system of any of the preceding clauses, wherein the processor is further configured to: generate an identification indicating that the power tool is a closest peripheral utilizing wireless range estimation; provide an indication to a back-end server that the identification was inferred based on wireless range estimation, and not definitively determined; and send the identification to the back-end server independently of any data picked up by the rechargeable power storage module or package tool data obtained from advertisement signals with the identification.

24. A method of a battery pack for associating itself with a power tool, the power tool comprising a communication module, the method comprising: determining that the battery pack is attached to the power tool; determining a level of communication module attributes (CM attributes) of the power tool's communication module; collecting data metrics associated with the power tool based on the determined CM attributes; associating the collected data with the power tool; and periodically transmitting the collected data to a centralized data system.

25. The method of clause 24, further comprising: sending a command from the battery via a communication interface of the battery and await a fixed period of time for a response; and switching to a central mode based on no response detected on a dedicated communication line, the central mode comprising scanning for advertising devices.

26. The method of any of the preceding clauses, further comprising, upon detection of an advertisement, reading, by the battery, advertisement data from the communication module with a strongest wireless range estimate.

27. The method of any of the preceding clauses, further comprising, when the battery does not detect either an internal or external communication device on the power tool, performing, by the battery pack, a secondary determination to identify the power tool it is attached to.

28. The method of any of the preceding clauses, further comprising, upon the secondary determination not detecting a tool, defaulting, by the battery pack, to collecting battery pack usage information and transmitting the battery pack usage information to a central device on a periodic basis.

29. The method of any of the preceding clauses, further comprising determining, by the battery pack, whether it is coupled to a power tool refurbished with a tag or chip or to a BLEM with full functionality.

30. The method of any of the preceding clauses, further comprising determining, by the battery pack if it is coupled to a refurbished tag or chip, then collecting inventory management and tool tracking data.

31. The method of any of the preceding clauses, wherein if the battery pack is determined to be coupled to a power tool with a BLEM with full functionality, collecting inventory management, tool tracking, data for an ability to control the tool, tool diagnostics, enhanced tool data, and real time clock data.

32. A power tool comprising: a housing; a motor; a trigger; a microcontroller; a wireless communication module coupled to the microcontroller; and an attachment mechanism configured to couple a battery pack to the power tool; wherein the wireless communication module is configured to: broadcast a first signal including first set of data periodically; and in response to receiving a request for an extended response, broadcast a second signal including a second set of data that is greater in size than the first set of data.

33. The power tool of clause 32, further comprising at least one temperature sensor configured to generate and transmit temperature data of the battery pack to the microcontroller; and wherein the first set of data comprises at least one of: an identification of the battery pack that it is coupled to; the temperature data of the battery pack; status data of the wireless communication module; a cumulative number of trigger pulls from the trigger; a total runtime; a time spent in a variable-speed mode; a status of a last shutdown of the power tool; a current mode of operation of the power tool; and a time spent in the current mode of operation.

34. The power tool of any of the preceding clauses, further comprising at least one temperature sensor configured to generate and transmit temperature data of the microcontroller; and wherein the second set of data comprises at least one of the temperature data of the microcontroller; a variable-speed time indicating an amount of time the power tool is in a variable speed mode; pack voltage of the battery pack; a cumulative number of trigger pulls in a forward direction; and a cumulative number of trigger pulls in reverse direction.

35. The power tool of any of the preceding clauses, wherein the wireless communication module is further configured to: broadcast a third signal including third set of data periodically, the third signal alternatingly broadcast periodically with the first signal; and in response to receiving a request to establish a direct communication connection, transmit a fourth signal to initiate a two-way communication protocol with a gateway.

36. The power tool of any of the preceding clauses, wherein the wireless communication module is further configured to transmit a datalog of metrics recorded by the microcontroller of the power tool after the direct communication with the gateway is established and clear a memory containing the datalog after it has been transmitted.

37. A battery pack comprising: at least one capacitive cell configured to provide power to a power tool; a battery management controller; a wireless communication module coupled to the battery management controller; and an attachment mechanism configured to couple the battery pack to a power tool; wherein the mobile communication module is configured to: broadcast a first signal including first set of data periodically; and in response to receiving a request for an extended response, broadcast a second signal including a second set of data that is greater in size than the first set of data.

38. The battery pack of any of the preceding clauses, further comprising at least one temperature sensor configured to generate and transmit temperature data of the battery pack to the battery management controller; and wherein the first set of data comprises at least one of: the temperature data of the battery pack; an identification of the power tool the battery pack is coupled to; status data of the wireless communication module; a data load indicator representing an amount of data stored in the battery pack; status data of the battery pack; a cumulative count of hot-pack events indicating one or more over-temperature conditions; a cumulative count of cold-pack events indicating one or more under-temperature conditions; a cumulative count of hot-pack charge events indicating one or more over-temperature events during charging; a cumulative count of cold-pack charge events indicating one or more under-temperature events during charging; a cumulative count of charge insertions; a cumulative count of under-voltage events; a cumulative count of over-voltage events; a cumulative count of over-voltage protection events indicating one or more shutdown events that required over-voltage protection; and a total time the battery pack tool is connected to the power tool.

39. The battery pack of any of the preceding clauses, further comprising at least one temperature sensor configured to generate and transmit temperature data of a FET to the battery management controller; and wherein the second set of data comprises at least one of: a cumulative count of charge insertions; a cumulative count of charge competitions; a cumulative count of under-voltage shutdown events; a fault reason association with each cell; a FET temperature and discharge information; a FET temperature; a cell imbalance information; a cumulative count of discharge cycles; a time spent in charge current; a time spent in discharge current; a data load indicator representing an amount of data stored in the battery pack; a state of life; a state of power; a state of health of the battery pack; a total coloumb count; a cell pressure; and a battery pack pressure.

40. The battery pack of any of the preceding clauses, wherein the wireless communication module is further configured to: broadcast a third signal including third set of data periodically, the third signal alternatingly broadcast periodically with the first signal; and in response to receiving a request to establish a direct communication connection, transmit a fourth signal to initiate a two-way communication protocol with a gateway.

41. The battery pack of any of the preceding clauses, wherein the wireless communication module is further configured to transmit a datalog of metrics recorded by the battery management controller of the battery pack after the direct communication with the gateway is established and clear a memory containing the datalog after it has been transmitted.

42. A mobile construction site device comprising: a microcontroller; a wireless communication module coupled to the microcontroller; and an attachment mechanism configured to couple the mobile construction site device to another mobile construction site device; wherein the mobile communication module is configured to: alternatingly broadcast a first advertisement signal indicating the mobile construction site device's scannable state and a second advertisement signal indicating the mobile construction site device's connectable state; in response to a scan request following the first advertisement signal, broadcast an extended scan signal comprising a set of cumulative data related to the mobile construction site device's operation or status; and in response to a connection request following the second advertisement signal, establish a communication link with an external device and transmit timestamped datalog of the operation or status.

43. The mobile construction site device of any of the preceding clauses, wherein the extended scan signal is broadcast without interrupting the broadcast of the first and second advertisement signals.

44. The mobile construction site device of any of the preceding clauses, wherein when the communication link is established, the broadcast of the first and second advertisement signals are interrupted until the communication link is terminated.

45. A power tool comprising: a motor controller; a first memory coupled to the motor controller; and a wireless communication module coupled to the motor controller and comprising: a wireless communication controller; and a second memory coupled to the wireless communication controller; wherein, during a first power tool operation occurring within a first time period, the motor controller is configured to write power tool operating data into the first memory; and wherein, during a second power tool operation occurring within a second time period mutually exclusive to the first time period, the wireless communication controller is configured to write the power tool operational data into the second memory after the conclusion of the first power tool operation.

46. The power tool of clause 45, wherein the first power tool operation comprises operating the power tool between a first trigger pull and a shutdown operation of the power tool.

47. The power tool of any of the preceding clauses, wherein the second power tool operation comprises conducting a shutdown operation of the power tool.

48. The power tool of any of the preceding clauses, wherein, during the first time period, the wireless communication controller is powered by a battery pack and is further configured to write the power tool operational data to the second memory.

49. The power tool of any of the preceding clauses, wherein the wireless communication module further comprises a secondary battery and, during the second time period, the wireless communication controller is powered by the secondary battery to write the power tool operational data into the second memory.

50. A battery pack comprising: a battery management controller; a first memory coupled to the battery management controller; a wireless communication controller coupled to the battery management controller; a second memory coupled to the wireless communication controller and the battery management controller; and an interface to couple the battery pack to a power tool; wherein, during a first power tool operation of the power tool occurring within a first time period, the battery management controller is configured to write battery pack operating data into the first memory; and wherein, during a second power tool operation of the power tool occurring within a second time period mutually exclusive to the first time period, the wireless communication controller is configured to write the power tool operational data into the second memory after the conclusion of the first power tool operation.

51. The battery pack of clause 50, wherein the first power tool operation comprises operating the power tool between a first trigger pull and a shutdown operation of the power tool.

52. The battery pack of any of the preceding clauses, wherein the second power tool operation comprises conducting a shutdown operation of the power tool.

53. A battery pack comprising: at least one capacitive cell; a positive terminal and a negative terminal both coupled to the at least one capacitive cell; a data communication terminal configured to be coupled to a power tool; and a wireless communication controller coupled to the data communication terminal and configured to transmit data wirelessly to an external device; wherein: a tool ID of the power tool is received through the data communication terminal; and the wireless communication controller is further configured to wirelessly transmit the tool ID and battery pack operational data associated with the power tool operation.

54. A power tool comprising: a housing; a motor; a trigger; a microcontroller; a wireless communication module coupled to the microcontroller; and an attachment mechanism configured to couple a battery pack to the power tool; wherein the microcontroller is configured to receive a battery pack ID of the battery pack when the battery pack is coupled to the power tool; and wherein the wireless communication module is configured to wirelessly transmit the battery pack ID along with power tool operational data to an external device.

55. A gateway comprising: at least one processor; at least one memory; and a wireless transceiver coupled to the at least one processor; the wireless transceiver configured to receive a connectable advertisement signal from an apparatus comprising at least one of a power tool, a battery pack, a battery charger, or a communication device coupled to a construction tool; and the at least one processor operable to: compare a data load value in the connectable advertisement signal to a threshold, the data load value representing an amount of data stored in the apparatus; and initiate a communication handshaking and authentication protocol with the apparatus if the data load value is greater than the threshold, to receive a timestamped datalog of operational data about the apparatus.

56. The gateway of clause 55, wherein the processor is further operable to identify a plurality of connectable advertisement signals that meet at least one criterion related to a manufacturer or an owner of the apparatus, and prioritize establishing a wireless connection with the apparatus based on a value of the data load value or a strength of signal value of the apparatus.

57. The gateway of any of the preceding clauses, wherein the processor is further operable to terminate a connection with the apparatus after receipt of a signal indicating that there is no more data available to be transmitted to the gateway, or after a predetermined time after receiving a receipt of a last signal containing data in the timestamped datalog.

58. A system comprising: a wireless communication module of an apparatus comprising at least one of a power tool, a battery pack, a battery charger, or a communication device coupled to a construction tool, the system comprising: a microcontroller; a memory coupled to the microcontroller; a wireless communication controller coupled to the microcontroller; the memory storing an encryption key; the wireless communication controller configured to wirelessly transmit an advertisement signal that contains operational data of the apparatus that is partially encrypted using the encryption key and partially unencrypted, the operational data that is partially unencrypted comprising a unique ID of the apparatus; and a remote server comprising: at least one processor; at least one memory; and a data communication module configured to receive the operational data from the apparatus; the at least one processor operable to: identify the unique ID in the operational data; determine the encryption key based on the identified unique ID; and decrypt the portion of the operational data that is encrypted using a decryption key associated with the determined encryption key.

59. The system of clause 58, wherein: the memory of the wireless communication module further stores a table of encryption keys and an associated value for each of the encryption keys, and the microcontroller is configured to embed one of the associated values of one of the encryption keys into the operational data; and the processor of the remote server is further operable to decrypt the operational data using the encryption key associated with the value.

60. The system of any of the preceding clauses, wherein the encryption key is included in a header of the advertisement signal and the encrypted data is included in a body of the advertisement signal.

61. A battery pack comprising: a battery cell; and a terminal block including a positive terminal and a negative terminal both coupled to the battery cell a data communication terminal configured to be coupled to a charger; a battery management controller coupled to the terminal block; and a wireless communication controller coupled, discretely or integrally, to the battery management controller and configured to transmit data wirelessly to an external device; wherein the battery management controller is configured to receive a unique ID of the charger and charger operational data related to at least one of performance or condition of the charger through the data communication terminal, and the wireless communication controller is configured to wirelessly transmit the unique ID and charger operational data to the external device.

62. The battery pack of clause 61, wherein the battery pack is configured to package battery pack operational data related to at least one of performance or condition of the battery pack with the charger operational data for a duration of a charging operation of the battery pack, and transmit the package to the external device.

63. A battery pack comprising: a battery cell; and a terminal block including a positive terminal and a negative terminal both coupled to the battery cell; and a wireless communication controller coupled, discretely or integrally, to the battery management controller configured to transmit data wirelessly to an external device; wherein the battery management controller is configured to: scan for at least one nearby wireless device, estimate a distance to at least one nearby wireless device based on a wireless range estimation technique, and determine whether the at least one nearby wireless device is associated with a power tool that the battery pack is coupled to based on the wireless range estimation technique.

64. The battery pack of clause 63, wherein the wireless range estimation technique comprises at least one of sound channeling, time of flight, strength of signal, or round time.

65. The battery pack of any of the preceding clauses, wherein the battery pack identifies a wireless device of the at least nearby wireless devices is associated with the power tool that the battery pack is coupled to, and packages operational data related to the battery pack with a unique ID of the wireless device.

66. The battery pack of any of the preceding clauses, wherein the battery pack further includes an inertial measurement unit, and wherein the wireless communication controller is configured determine whether the at least one nearby wireless device is associated with a power tool that the battery pack is coupled to based on the wireless range estimation technique and motion data from the inertial measurement unit.

67. A power tool comprising: a housing; a motor; a trigger; a motor controller; a wireless communication module coupled to the motor controller configured to wirelessly transmit tool operational data provided by the motor control module to an external device; a memory coupled to at least one of the wireless communication module or the motor controller; and a battery receptacle configured to couple a battery pack to the power tool; wherein the motor controller is configured to determine a condition associated with a tool faulty shutdown event or a user protection event, and a wireless communication module is configured to prioritize transmission of data related to the condition over other data provided by the motor control module.

68. The power tool of any of the preceding clauses, wherein the battery receptacle includes a data communication terminal provided between the power tool and the battery pack, wherein the data related to the condition over other data is transmitted wirelessly to the external device and the other data is transmitted via the data communication terminal to the battery pack.

69. A battery pack comprising: a battery cell; and a terminal block including a positive terminal and a negative terminal both coupled to the battery cell; and a wireless communication controller coupled, discretely or integrally, to the battery management controller configured to transmit data wirelessly to an external device; wherein the wireless communication controller is configured to receive power tool operating data from a power tool coupled to the terminal block, analyze the power tool operating data to identify data related to a condition associated with a tool faulty shutdown event or a user protection event, and prioritize wireless transmission of the data related to the condition over other power tool operating data.

70. A power tool comprising: a housing; a motor; a trigger; a motor controller; a wireless communication module coupled to the motor controller configured to wirelessly transmit tool operational data provided by the motor control module to an external device; a secondary power supply coupled to the wireless communication module; and a battery receptacle configured to couple a battery pack to the power tool; wherein the wireless communication module is configured to determine a voltage indicator signal that designates whether a state of charge or a voltage level of the secondary power supply is below a threshold level, and in response to receiving a request for an extended response, broadcast a second signal including the state of charge or the voltage level of the secondary power supply.

71. A power tool comprising: a housing; a motor; a trigger; a motor controller; a wireless communication module coupled to the motor controller configured to wirelessly transmit tool operational data provided by the motor control module to an external device; a secondary power supply coupled to the wireless communication module; and a battery receptacle configured to couple a battery pack to the power tool; wherein the wireless communication module is configured to transmit set of data related to an operation of the power tool and adjust a criterion related to content, type, or frequency of transmission of the set of data based on at least one of a voltage or a state of charge of at least one of the secondary battery pack or the battery pack.

72. The power tool of clause 71, wherein the criterion relates to a frequency of transmission of an advertisement signal including the set of data, and wherein the wireless communication module is configured to reduce the frequency when the voltage or the state of charge falls below a threshold or as a function of the voltage of the state of charge being reduced.

73. The power tool of any of the preceding clauses, wherein the criterion relates to content or size of the set of data transmitted via a communication link, wherein the content or the size is reduced when the voltage or the state of charge falls below a threshold or as a function of the voltage of the state of charge being reduced.

74. The power tool of any of the preceding clauses, wherein the content is limited to data related to safety or user protection events when the voltage or the state of charge falls below the threshold.

75. The power tool of any of the preceding clauses, wherein an availability for a two-way connection with a central device is inhibited when the voltage or the state of charge falls below a threshold or as a function of the voltage of the state of charge being reduced.

76. The power tool of any of the preceding clauses, wherein the wireless communication module is configured to disable transmission of a connectable advertisement signal, or disable a connectable state, when the voltage or the state of charge falls below the threshold.

77. The power tool of any of the preceding clauses, wherein an extended scan response is inhibited when the voltage or the state of charge falls below a threshold or as a function of the voltage of the state of charge being reduced.

78. A system comprising: an apparatus including at least one of a power tool or a power tool battery pack including a housing, a wireless communication device located within the housing, and an identification label located on the housing; at least one gateway configured to periodically receive data from the wireless communication device without initiation by an operator of the apparatus; and a remote server that receives the data from the gateway; wherein the identification label is scannable via an external mobile device to associate the apparatus with a user account stored in the server, and wherein the server is configured to associate the data with the user account.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather, the method blocks may be performed in any order that is practicable including simultaneous performance of at least some method blocks. Furthermore, each of the methods may be performed by one or more of the system components illustrated in the figures.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power tool comprising:
a housing;
a motor;
a trigger;
a motor controller;
a wireless communication module coupled to the motor controller configured to wirelessly transmit tool operational data provided by the motor controller to an external device;
a memory coupled to at least one of the wireless communication module or the motor controller; and
a battery receptacle configured to couple a battery pack to the power tool;
wherein the motor controller is configured to analyze the tool operational data to identify data related to a condition associated with one or more selected category, and the wireless communication module is configured to prioritize transmission of data related to the condition over other data provided by the motor controller.

2. The power tool of claim 1, wherein the one or more selected category comprises at least one of shutdown events, fault events, or user protection events.

3. The power tool of claim 2, wherein the condition comprises at least one of kickback events, shutdown events related to tool movement as detected by a gyroscope, or electrical protection events.

4. The power tool of claim 1, wherein the wireless communication module is configured to transmit a signal including a set of data provided by the motor controller, and transmit data related to the condition before other data in the set of data.

5. The power tool of claim 3, wherein the wireless communication module is configured to transmit the data related to the condition directly to the external device.

6. The power tool of claim 5, wherein the battery receptacle includes a data communication terminal provided between the power tool and the battery pack, wherein the data in the set of data related to the condition is transmitted wirelessly to the external device and the other data in the set of data is transmitted via the data communication terminal to the battery pack.

7. The power tool of claim 5, wherein the battery receptacle includes a data communication terminal provided between the power tool and the battery pack, wherein the data in the set of data related to the condition is transmitted wirelessly to the external device and the data in the set of data related to the condition is also transmitted via the data communication terminal to the battery pack.

8. A battery pack comprising:
a battery cell;
a terminal block including a positive terminal and a negative terminal both coupled to the battery cell;
a battery management controller; and
a wireless communication controller coupled to the battery management controller and configured to transmit data wirelessly to an external device;
wherein the wireless communication controller is configured to:
receive power tool operating data from a power tool coupled to the terminal block;
analyze the power tool operating data to identify data related to a condition associated with one or more selected category, and prioritize wireless transmission of the data related to the condition over other power tool operating data received from the power tool.

9. The battery pack of claim 8, wherein the one or more selected category comprises at least one of shutdown events, fault events, or user protection events.

10. The battery pack of claim 8, wherein the condition comprises at least one of kickback events, thermal protection events, or electrical protection events.

11. The battery pack of claim 8, further comprising a memory configured with an offload queue, wherein the battery management controller is configured to transfer data related to the condition to the offload queue before other data received from the power tool.

12. The battery pack of claim 11, wherein the wireless communication controller is configured to transmit data related to the one or more selected category to the external device during operation of the power tool or within a set time after completion of power tool operation.

13. The battery pack of claim 12, wherein the wireless communication controller is configured to transmit data received from the power tool not related to the condition to the external device during an idle mode of the battery pack.

14. A system comprising:
a gateway including a wireless transceiver; and
a construction site device comprising a wireless communication module, a controller, and a memory, wherein the construction site device is configured to:
analyze operating data associated with the construction site device to identify data related to a condition associated with one or more selected category, and prioritize wireless transmission of the data related to the condition over other operating data associated with the construction site device.

15. The system of claim 14, wherein the one or more selected category comprises at least one of shutdown events, fault events, or user protection events.

16. The system of claim 14, wherein the wireless communication module is configured to transmit a signal including a set of data provided by the controller, and transmit data related to the condition before other data in the set of data.

17. The system of claim 14, wherein the wireless communication module is configured to transmit the data related to the condition directly to the gateway.

18. The system of claim 14, wherein the construction site device is further configured to analyze operating data associated with another construction site device to identify data related to the condition associated with the one or more selected category.
